(19) United States
(12) Patent Application Publication
(10) Pub. No.: US 2016/0247098 A1
(43) Pub. Date: Aug. 25, 2016

(54) System, Method, and Computer Software Code for Planning and Executing a Travel Itinerary

(71) Applicant: James Bongiorno, Huntington, NY (US)

(72) Inventor: James Bongiorno, Huntington, NY (US)

(21) Appl. No.: 13/691,821

(22) Filed: Dec. 2, 2012

(51) Int. Cl. G06Q 50/14

(52) U.S. Cl. CPC G06Q 10/025

(57) ABSTRACT

A computer program product for planning of, and executing a travel itinerary—while traveling to and while at the destination—is stored on tangible computer readable storage medium as computer readable program code. The code causes a P.C./Smartphone to: permit making online reservations (airline, hotel, rental car, event tickets . . . ), and to provide access via a planning screen to a database of destination-specific information, to permit selection from among a plurality of templates to begin planning a personalized scheme for exploring the destination. Selected templates, representing categories of interest, are weighted to adjust relative number of sites/specialty tours extracted therefrom for placement into available tour time periods determined from entry of: arrival/departure cities, number of days, daily touring start-times/end-times, and a tour intensity level, to personally maximize touring in those periods. An algorithm permits adjustments to site selection/sequencing in the itinerary for in-country weather detours, and re-weighting/re-selection of templates of interest.

### CROSS-REFERENCES TO RELATED APPLICATIONS

This application is a continuation-in-part of U.S. patent application Ser. No. 13/646,714, filed on Oct. 7, 2012, which is a continuation of U.S. application Ser. No. 12/910,790, filed on Oct. 23, 2010, which claims priority on U.S. Provisional Application Ser. No. 61/397,104, filed on Jun. 7, 2010.

### COPYRIGHT NOTICE

A portion of the disclosure of this patent document contains photographic images which are subject to copyright protection, and are so noted in the Figures. Use herein of those images has been licensed by the copyright owner, Q. T Luong of Terragalleria.com, who has no objection to the facsimile reproduction by anyone of the patent document or the patent disclosure, as it appears in the Patent and Trademark Office patent file or records, but otherwise reserves all copyright rights whatsoever.

Any photographic images used herein that are not attributed, are in the public domain. All other attributed photographic images are subject to Creative Commons Attribution Licensing (http://creativecommons.org/licenses/by-sa/2.5/deed.en; http://creativecommons.org/licenses/by-sa/3.0/deed.en), which permits sharing and remixing of the author's work, provided it is attributed in a way that does not reflect endorsement.

### FIELD OF THE INVENTION

This invention relates to methods and systems of planning and executing a vacation or travel itinerary, and more particularly to software and a portable electronic unit, which may be dedicated to such planning and travel assistance at the destination.

### BACKGROUND OF THE INVENTION

Many people work the majority of a year in anticipation of well-earned time off, which may comprise a single week, or, for certain European nationals, multiple weeks of paid summer vacation-time. Very often a person's vacation involves traveling to another city or state to visit family, which frequently leaves the responsibility for selecting and organizing the sightseeing activities to the host, with such activity having a tendency to be under-planned and the available time under-utilized, because many people do not themselves take advantage of the offerings of the place where they reside. Some people may travel abroad fairly regularly and with it usually being for work-related purposes, while for others, such an out-of-country journey may ordinarily constitute a long-awaited luxury vacation.

Either trip demands appropriate preparation and organization to take advantage of the limited time available, and to optimize the large expenses that may be incurred for simply being there for that time—large expenses which may be in the form of airfares, hotels, ground transportation costs, and meals at restaurants. Also, even for the well designed trip, there may be lost time requiring spur of the moment changes because of poor weather during the trip, an unexpected closure, or some other event that was unforeseen during the planning stages-planning which had likely occurred many months before the travel dates.

Moreover, for the organized traveler, planning often consists of reading portions of at least one travel guide book that comprises hundreds of pages, some of which may need to be ear-marked for later reference at key points of the travel to assist in finding one's way, and to enrich the travel experience. Some ear-marked pages may have addresses for sites and events, while other pages may have maps. So preparing the itinerary may involve making a list on a sheet of paper of the sites to be visited and the dates of such daily trips, as well as trying to cross reference the portions of the trip to pages in the travel book. It is also likely that when stopping at a book store, that the traveler may purchase more than just one particular travel guide book. It may be desirable to purchase one for the entire country to be visited, such as for a trip to Italy, as well as one specifically addressing in greater detail a major city to be visited therein, such as the culturally and historically rich city of Rome.

In addition, it may be useful for the traveler to purchase and bring along a language guide, particularly when visiting a destination that is not very accommodating to tourists, and where it would be helpful to be able to say a few words in the native language of those people encountered during the trip. Furthermore, even if an English version of a GPS device for the country to be visited was readily available for purchase to assist with movement therein, it would represent yet one more article that needed to be carried about during the day's travels, on top of a camera to photograph the sights and experiences, possibly a cell phone, and all of the travel guides and other books mentioned previously.

There currently is no means of efficiently accomplishing all of this travel-related planning and of it being effectively accessible by, and of assistance to, the traveler, once arriving at the destination. For example, U.S. Pat. No. 7,599,847 to Block is for an “Automated Internet Based Interactive Travel Planning and Management System.” But as self-described by Block, it is only directed toward providing “a method and system that permits travelers to register as members for receiving access to the main website of the system and that interactively provides the member with access to numerous other websites for facilitating whatever travel arrangements the member wishes to make.” Although it may include a profile of a user's carrier seating preferences, travel class preferences, parking preferences, dining preferences, rental preferences, etc, it is nonetheless not directed at trip planning to a specific destination country, nor towards aiding the traveler once arriving therein.

Although U.S. Pat. No. 5,549,332 to Judson is for a “Travel Planner,” and does allow for planning a trip to more than one type of point of interest to create an itinerary, it very simply combines a transparency that is overlaid onto a map to thereby permit the user to write on the transparency to define a particular route. It does not contain any more ability to plan or assist beyond the information contained in the map.

A modest step forward to addressing the problem is shown by U.S. Pat. No. 6,023,241 to Clapper, for a “Digital Multimedia Navigation Player/Recorder.” The Clapper device is for “a recorder with a global positioning system receiver” that “may record video frames and/or audio data in association with global positioning system coordinates” so that the user may determine the location of associated photographs taken digitally and may recreate excursions using a multimedia approach. Clapper also discloses that by sizing the device to be portable, the user may take the device on trips and “receive information about various points which are associated on a digital map including both audio and video.” But Clapper does not disclose any structured planning capability, and furthermore is dependent upon GPS coordinate locations, and depends upon downloading of such information using the internet from an “excursion server.”

The invention disclosed herein combines all of the functionality of the books and electronic gadgets which may need to be utilized in planning and richly experiencing a vacation abroad, into one elegant and practical planning/touring device, with powerful features to enhance everyone's vacation experience. The itinerary planning may be accomplished utilizing planning templates, which may simulate having an experienced travel guide offering in-person advice throughout such planning. The guidance may also be completely without the availability of GPS data or internet access.

### OBJECTS OF THE INVENTION

It is an object of the invention to provide a means of compiling a travel itinerary in a retrievable electronic form, according to various customizable itinerary templates.

It is another object of the invention to provide a means of compiling a travel itinerary for various different kinds of travelers.

It is a further object of the invention to provide a means of planning a travel itinerary from a list of options that are arranged in templates, with the further assistance of sub-template options.

It is another object of the invention to provide a means of planning a travel itinerary by viewing photographs of various travel sites, to assist in choosing from among those sites.

It is also an object of the invention to provide a means of altering a planned itinerary after completion of the planning, but before beginning the trip.

It is another object of the invention to provide a means for receiving options to deviate from a planned itinerary while en route to or during a leg of the actual trip.

It is also an object of the invention to provide a means of receiving options to add to a planned itinerary after completion of the itinerary and during a particular leg of the trip.

It is another object of the invention to provide a convenient electronic means for translating words and phrases into the language used at a destination.

It is also an object of the invention to provide a means of receiving audio tours for the sites being visited in accordance with the planned electronic itinerary.

It is another object of the invention to provide a means of supplying public transportation information for the destination, in relation to the legs of the travel itinerary.

It is also an object of the invention to provide a convenient means of obtaining phone listings from a directory, for businesses and individuals at the destination.

It is another object of the invention to provide a means of exclusively linking the electronic itinerary planning of one individual on a device to another person's device.

It is also an object of the invention to provide a means of quickly ascertaining the other person's location at the destination using the device, in relation to the itinerary.

It is another object of the invention to provide a means of having quick and convenient reference to electronic copies of maps for a destination, in relation to the travel itinerary.

It is also an object of the invention to provide a means of quickly finding information relating to various aspects of the destination.

It is another object of the invention to provide a means of entering requests and information to interact with the itinerary planning capability.

### BRIEF SUMMARY OF THE INVENTION

The invention disclosed herein is a multi-faceted device incorporating all of the essential items and features necessary for a business traveler, a single person, or family to travel to, or vacation in, another country, as though they had a personal concierge to assist them with each aspect of their travel planning, as well as guiding and directing them throughout the actual travel. The guidance does not require, but may with the aid, when necessary, of a GPS receiver. The invention features flexibility in changing the planning before leaving for the trip, and even accommodates making spur of the moment changes or additions to the planned itinerary, while at the destination. The invention comprises specially conceived and designed software to access specific databases of travel related materials to prepare a detailed travel itinerary that is custom built by the user according to their own concept of what they believe would result in an extraordinary travel experience.

The databases may include a complete listing of travel related information for a particular destination, and may further include a library of photographs for each of the sites and events that may be visited or attended. The software program may preferably be tailored to work on a dedicated electronic unit or article that is specially designed for such planning, but may also be used on a standard personal computer, a PDA, an Apple iPad, an advanced phone permitting programmable applications, and other such electronic devices. A portable computing unit is preferred as it may accompany the user on the trip, and therein provide additional functions to enhance the travel experience. The portable unit will allow the user to refer to the planned itinerary at each leg of the journey. It provides en route detours to other sites, for when the user has decided to leave a site early or simply wishes to do additional touring during one particular day. The software includes destination-specific maps which may cooperate with the itinerary to be displayed anytime—either during the planning stages or during the vacation itself. The software may automatically display map regions of the sites chosen for the itinerary to assist the traveler while navigating in a city or region of a foreign country.

The database may also comprise language translational capabilities for the nation to be visited, and information about the nation, including yellow page and white page phone listings. The device may also comprise communication capabilities which permit it to be linked to another travel planner unit to allow transmissions therebetween of planning information, of current locations for each traveler, and even voice communication. It may also include a digital camera.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a view of an article illustrating a preferred embodiment of the present invention that is tailored for planning for, and touring of, a foreign country (Italy), and being displayed is the initial start screen that prompts the user to select from one of the available functions, or to view a virtual slide show or video tour.

FIG. 2 is a view of an article of FIG. 1, and displayed on the screen is the initial planning templates available under the “PLAN ITINERARY BUTTON,” and with bold underscoring indicating intent to choose the “Pre-planned Taste of Italy Tour Templates—2 Day, 3 Day, . . . . ”

FIG. 3 is a view of an article of FIG. 2, and displayed on the screen is the options available under the “Pre-planned Taste of Italy Tour Templates—2 Day, 3 Day, . . . ” template, and with bold underscoring indicating intent to specify the parameters of a 7 Day, 3 City tour beginning at Venice and ending in Rome, with a medium touring schedule of sites in each of the user selected cities and in the city selected by the template.

FIG. 4 is a view of the article of FIG. 3, and displayed on the screen is the itinerary returned by the processor for the parameters specified in the template, where the user's parameters were a 7-day, 3-city tour beginning at Venice and ending in Rome, with a medium site touring schedule.

FIG. 4A is a view of the article of FIG. 4, and displayed on the screen is a series of alternate itineraries returned by the processor for the 7-day, 3-city tour beginning at Venice and ending in Rome.

FIG. 4B is a view of the article of FIG. 4A, and displayed on the screen is the user selected alternate itinerary #1, which is for a 7-day, 3-city tour beginning in Venice and ending in Rome, with a medium site touring schedule and an intermediate stop in the city of Bologna.

FIG. 5 is a view of the article of FIG. 3, and displayed on the screen is the itinerary returned by the processor for parameters specified in the “Best Tour of Italy” template, being for a 7-day, 4-city tour beginning at Venice and ending in Rome, with a medium touring schedule for sites in each of the user selected cities and for the two cities selected by the template.

FIG. 5A is a view of the article of FIG. 5, and displayed on the screen is the start of the Tour Details for the 7-day, 4-city tour beginning at Venice and ending in Rome, with a medium touring schedule for sites in each of the user selected cities and in the two cities selected by the template—Florence and Pisa.

FIG. 6 is a view of the article of FIG. 2, but with bold underscoring indicating intent to use the “Select Regions/Cities/Sites from Photo Library Templates,” and being shown side-by-side is the article with the resulting Photo Library being displayed on the screen.

FIG. 6A is a view of an article of FIG. 6, but being displayed on the screen is some of the templates available under the “PLAN ITINERARY BUTTON,” and with bold underscoring indicating intent to use the “Select Cities from City Templates—Rome, Venice, Florence . . . ” tour planning template, and use of the third sub-template—“c) View Cities by Popularity”.

FIG. 7 is a view of the article of FIG. 6A, and displayed on the screen is the list of tourist cities being displayed by popularity, and with highlighting of Rome and intent to select the “add to itinerary” option.

FIG. 8 is a view of the article of FIG. 7, and displayed on the screen is the current state of planning for the first itinerary, and planning options available in the itinerary planning sequence, and with bold underscoring indicating intent to select the “Select Another City” option by pressing the “enter” button.

FIG. 9 is a view of the article of FIG. 8, and displayed on screen is the list of city choices, once a first city choice has been made, with distances to the previously selected city, and with bold underscoring indicating intent to select the “Add to Itinerary” choice for the city of Venice.

FIG. 10 is a view of the article of FIG. 9, and displayed on the screen is further city choices revealed by scrolling down under the “More City Choices” option, and with bold underscoring indicating intent to select the “Add to Itinerary” choice for the city of Genoa.

FIG. 11 is a view of the article of FIG. 10, and displayed on screen is the updated planning for the first itinerary and the planning options available in the itinerary planning sequence, and with bold underscoring indicating intent to select the “Return to Planning Templates” choice.

FIG. 12 is a view of the article of FIG. 11, and displayed on the screen is the initial templates available under the Plan Itinerary button, and with bold underscoring indicating intent to use the “Select Regions from Region Templates—Northern Italy, . . . ” choice.

FIG. 13 is a view of the article of FIG. 12, and displayed on the screen is the regional choice options for the different sections of Italy that may be explored, and with bold underscoring indicating intent to select the “Explore Northern Italy” choice.

FIG. 14 is a view of the article of FIG. 13, and displayed on screen is the regions and major cities that may be explored and added to the itinerary from the Northern section of Italy, and with bold underscoring indicating intent to select the “View Photos of Northern Regions” choice.

FIG. 15 is a view of the article of FIG. 14, and displayed on the screen is a portion of the photo library representing the Northern regions of Italy, and with bold underscoring indicating intent to select the “Explore Liguria Region” option.

FIG. 16 is a view of the article of FIG. 15, and displayed on the screen are the cities for the Liguria region of Northern Italy, and with bold underscoring indicating intent to select the “Add to Itinerary” choice for the city of Manarola.

FIG. 17 is a view of the article of FIG. 16, and displayed on the screen is the updated planning for the first itinerary, and with bold underscoring indicating intent to select the “Site Options” choice for the first itinerary leg—Rome.

FIG. 18 is a view of the article of FIG. 17, and displayed on the screen is a partial list of tourist sites for the selected city—Rome, and related functional options available, and with bold underscoring indicating intent to select the “View Colosseum Photo” choice.

FIG. 19 is a view of the article of FIG. 18, and displayed on the screen is a library photo of the selected Rome tourist site—the Colosseum, and related functional options available, and with bold underscoring indicating intent to select the “View Colosseum Map Location” choice.

FIG. 20 is a view of the article of FIG. 19, and displayed on the screen is the site map for the selected site—the Colosseum, and related functional options available, and with bold underscoring indicating intent to select the “View Site Description” choice.

FIG. 21 is a view of the article of FIG. 20, and displayed on the screen is the site description for the selected site—the Colosseum, and related functional options available, and with bold underscoring indicating intent to select the “Add to ROME Site Itinerary” choice.

FIG. 22 is a view of the article of FIG. 21, and displayed on the screen is the partial list of tourist site choices for the selected city—Rome, once several cities have been added to the itinerary, as well as related functional options available to the user.

FIG. 23 is a view of the article of FIG. 22, and displayed on screen is updated planning including the sites selected for the Rome itinerary leg, and with bold underscoring indicating intent to select the “Find Venice Special Events” choice for the Venice leg.

FIG. 24 is a view of the article of FIG. 23, and displayed on the screen is the listing of special events and related information, which may be added to the Venice itinerary leg.

FIG. 25 is a view of the article of FIG. 24, and displayed on the screen is the options for altering a saved itinerary under the “ALTER ITINERARY” button, and with bold underscoring indicating intent to select the “Move Venice Leg in Itinerary” choice.

FIG. 26 is a view of the article of FIG. 25, and displayed on screen is the current planning for the first itinerary with the options for revising the location of the Venice leg, and with bold underscoring indicating intent to select the “Move Venice Leg Later in Itinerary” choice.

FIG. 27 is a view of the article of FIG. 26, and displayed on the screen is the revised order for the first itinerary, and with bold underscoring indicating intent to select the “Find Transportation to Rome” choice.

FIG. 28 is a view of the article of FIG. 27, and displayed on the screen is the airline transportation options to fly to the first itinerary leg, and with bold underscoring indicating intent to select the “WiFi Connect: On-line Reservation” choice.

FIG. 29 is a view of the article of FIG. 28, and displayed on screen is the airline reservation obtained online to fly to the first itinerary leg and to depart from the final itinerary leg, and with bold underscoring indicating intent to select the “Find Hotels in Rome” choice.

FIG. 30 is a view of the article of FIG. 29, and displayed on the screen is the alternative methods of finding accommodations for the Rome itinerary leg, and with bold underscoring indicating intent to select the “Select Navona Area” choice for finding a hotel.

FIG. 31 is a view of the article of FIG. 30, and displayed on the screen is the list of accommodations for the Navona area of Rome, and with bold underscoring indicating intent to select the “View Hotel Map Location” choice for the Imperium Suite Navona accommodation.

FIG. 32 is a view of the article of FIG. 31, and displayed on screen is the map area for the Navona area of Rome showing the location for the Imperium Suite Navona, and with bold underscoring indicating intent to select the “Choose Imperium Suite Navona” choice.

FIG. 33 is a view of the article of FIG. 32, and displayed on the screen is the information for the Imperium Suite Navona, and with bold underscoring indicating intent to select the “WiFi Connect: On-line Reservation” choice.

FIG. 34 is a view of the article of FIG. 33, and displayed on screen is current planning for the first itinerary, including the Rome itinerary leg hotel reservation, and with bold underscoring indicating intent to select the “Find Transportation: Venice to Milan Airport” choice.

FIG. 35 is a view of the article of FIG. 34, and displayed on the screen is the transportation options from Venice to the Milan airport, and with bold underscoring indicating intent to select the “Explore Train Transportation: Venice to Milan Airport” choice.

FIG. 36 is a view of the article of FIG. 35, and displayed on screen is a map of the national railway system in the Venice/Milan region, and with bold underscoring indicating intent to select the “WiFi Connect: On-line Schedule Check: www.trentalia.com” choice.

FIG. 37 is a view of the article of FIG. 36, and displayed on the screen is options available under the Plan Itinerary button after at least one itinerary has been saved, and with bold underscoring indicating intent to select the “Select Planning Template” choice for the “Copy and Modify Existing Itinerary” option.

FIG. 38 is a view of the article of FIG. 37, and displayed on the screen is the list of itineraries to choose as a template for creating a new itinerary, and with bold underscoring indicating intent to select the “Copy Itinerary” choice.

FIG. 39 is a view of the article of FIG. 38, and displayed on the screen is the second itinerary, which is currently a clone of the first itinerary, and with bold underscoring indicating intent to select the “Delete City/Region” choice.

FIG. 40 is a view of the article of FIG. 39, and displayed on the screen is the second itinerary, where the Liguria and Venice legs have been deleted, and with bold underscoring indicating intent to select the “Add Side Trip From City/Region” choice.

FIG. 41 is a view of the article of FIG. 40, and displayed on the screen is the partial list of side trips from Rome along with a respective mileage therefrom and photo, and with bold underscoring indicating intent to select the “Add Side Trip” choice.

FIG. 42 is a view of the article of FIG. 41, and displayed on the screen is the second itinerary with the Pompeii side trip added as a day 2 excursion, and with bold underscoring indicating intent to select the “Save Itinerary” choice.

FIG. 43 is a view of the article of FIG. 42, and displayed on the screen is the list of saved itineraries available for execution by a traveler under the “USE ITINERARY” button.

FIG. 44 is a view of the article of FIG. 43, and displayed onscreen is the saved itinerary #1, along with user choices for guidance and assistance from the itinerary, and with bold underscoring indicating intent to select the “Walking Directions to Colosseum” choice.

FIG. 45 is a view of the article of FIG. 44, and displayed on the screen is a country-wide map of Italy, available under the “ITALY MAPS” button.

FIG. 46 is a view of the article of FIG. 45, and displayed on the screen is a partial list of options available under the “FIND” button, and with bold underscoring indicating intent to select the “Select FIND Option” choice for finding city information about the keyed in city of Venice.

FIG. 47 is a view of the article of FIG. 46, and displayed on the screen is general information about the city of Venice, and with bold underscoring indicating intent to select the “Return to FIND Options” choice.

FIG. 48 is a view of the article of FIG. 47, and displayed on the screen is additional options under the FIND button for finding drug stores, and with bold underscoring indicating intent to select the “Select FIND Option” choice.

FIG. 49 is a view of the article of FIG. 48, and displayed on the screen is the nearest drug store, based on the traveler's GPS position, and other pertinent information, and with bold underscoring indicating intent to select the “Get GPS Directions to Store” choice.

FIG. 50 is a view of the article of FIG. 49, and displayed on the screen are options under the “LANGUAGE TRANLATE PHRASE” button, including a fill-in-the-blank area for entering the phrase, and with bold underscoring indicating intent to select the “Translate Phrase” choice.

FIG. 51 is a view of the article of FIG. 50, and displayed onscreen is the Italian translation, with a pronunciation aid, for the English phrase entered, and with bold underscoring indicating intent to select the “View List” choice for the List of Common Italian Phrases.

FIG. 52 is a view of the article of FIG. 51, and displayed on the screen is a partial list of the Common Italian Phrases.

FIG. 53 is a view of the article of FIG. 52, and displayed on the screen are options under the “REQUEST AUDIO TOUR,” and with bold underscoring indicating intent to select the indicated option of an “Audio Tour of Itinerary Leg.”

FIG. 54 is a view of the article of FIG. 53, and displayed on the screen is audio tour options available for the saved itineraries, and with bold underscoring indicating intent to select the “Start Audio Tour” choice for the Colosseum General Audio Tour.

FIG. 55 is a view of the article of FIG. 54, and displayed on the screen is the text of the audio tour which may be broadcast through the headphone jack or speakers or wirelessly using Bluetooth technology, and with audio tour options.

FIG. 56 is a view of the article of FIG. 55, and displayed on the screen is options available under the “PHONE DIRECTORY” choice, and with bold underscoring indicating intent to select the “Search for Da Vinci's Phone #” option.

FIG. 57 is a view of the article of FIG. 56, and displayed on the screen is options available under the “Transportation Routes/Schedules” button, and with bold underscoring indicating intent to select the “View Transportation Details” option for the Rome Metro railroad.

FIG. 58 is a view of the article of FIG. 57, and displayed on the screen is the Metro Rome railroad map and options to explore the map interactively, and with bold underscoring indicating intent to select the “Return to Transportation Options” choice.

FIG. 59 is a view of the article of FIG. 58, and displayed on the screen is the transportation options, and with bold underscoring indicating intent to select the “View Transportation Details” choice for transportation from the current location at the Colosseum.

FIG. 60 is a view of the article of FIG. 59, and displayed on the screen is the map area of the Rome Metro railroad focused on the stops to get from the current location to the next itinerary leg.

FIG. 61 is a view of the article of FIG. 60, and displayed on the screen is the options available under the “EN ROUTE DETOURS” button, and with bold underscoring indicating intent to select “Explore Colosseo Detour Option.”

FIG. 62 is a view of the article of FIG. 61, and displayed on the screen is the options for a detour to find eateries, shopping centers, or other tourist sites, and with bold underscoring indicating intent to select the “Get Directions/Transportation” choice to Piazza Fontana Di Trevi.

FIG. 63 is a view of the article of FIG. 62, and displayed on the screen is the map area of the Rome Metro railroad focused on the stops to get from the current location to the next selected en route detour.

FIG. 64 is a view of the article of FIG. 63, and displayed onscreen is the options under the LINK/TRANSMIT ITINERARY” button for linking of the planner to another planner, and with bold underscoring indicating intent to select the “Link Planner with Unit #98765” choice.

FIG. 65 is a view of the article of FIG. 64, and displayed onscreen are options under the “LINK/TRANSMIT ITINERARY” button for transmitting an itinerary to another planner, and with bold underscoring indicating intent to select “Enter to Transmit to Gina (98765).”

FIG. 66 is a view of the article of FIG. 65, and displayed onscreen is selection of the Itinerary #1 with an en route detour for transmission, and with bold underscoring indicating intent to select “Enter to Transmit Itin. #1 to Gina.”

FIG. 67 is a view of the article of FIG. 66, and displayed onscreen is the options under the “GPS LOCATE FAMILY MEMBER” button, and with bold underscoring indicating intent to select the “Enter to Locate Gina” choice.

FIG. 68 is a view of the article of FIG. 67, and displayed onscreen is an area map displaying the location of Gina's position relative to the user's position.

FIG. 69 is a view of an article illustrating a second embodiment of the invention of FIG. 1, but without the language functionality and planner linking capability.

FIG. 70 is a rear view of the article of FIG. 69, showing the camera lens, and one possible configuration of a battery access panel.

FIG. 71 is a view of an article illustrating a third embodiment of the invention of FIG. 1, but with touch-screen buttons instead of mechanical buttons.

FIG. 72 is a schematic view of an exemplary computer system running the software of the current invention.

FIG. 73 is a view of the article of FIG. 28, and displayed onscreen is simply another way to access the airline/lodging reservation options.

FIG. 74 is a view of the article of FIG. 73, but showing an hourly calendar planner with the airline reservation information displayed on appropriate outbound and inbound departure days and time-slots.

FIG. 75 is a view of the article of FIG. 2, but displayed onscreen is simply another way to organize the templates therein, according to manual planning options and assisted tour planning options.

FIG. 76 is a view of the article of FIG. 3, and shows additional options displayed on the screen for choosing the duration of daily touring, by indicating a start time and end time for each day, and by being able to customize hours for touring each day using an hourly calendar planner.

FIG. 77 is a view of the hourly calendar planner with airline reservation information of the display screen for the article of FIG. 74, but also showing the option for customizing hours for touring each day.

FIG. 78 is a view of the hourly calendar planner with airline reservation information of the display screen for the article of FIG. 77, but showing the weekly lunch-time hours and early morning hours as having been excluded from the available blocks of touring time per day.

FIG. 79 is a view of the hourly calendar planner of the display screen for the article of FIG. 78, but additionally showing several evening hours as having been excluded from the available blocks of touring time per day.

FIG. 80 is a view of the article of FIG. 2 and FIG. 37, but displayed onscreen is simply another way to organize the tour templates therein.

FIG. 81 is a view of the article of FIG. 80, but illustrating the user choosing the option to “Select Sub-Templates to Create Itinerary.”

FIG. 82 is a view of the article of FIG. 81, but illustrating a partial listing of the Sub-Templates available, along with options for viewing those sub-template and for their use in the itinerary currently being developed, and also showing the user having selected the “Most Popular Sites” sub-template.

FIG. 83 is a view of the partial sub-template listing within the display screen of the article of FIG. 82, but further illustrating the user having selected the option to browse the “Top 50+Most Popular Sites” in that sub-template.

FIG. 84 is a view of the partial sub-template listing within the display screen of the article of FIG. 83, but also showing a partial listing of the “Top 50+Most Popular Sites,” and showing the user having selected the “Top 12” most popular sites as being guaranteed for placement within the itinerary, as well as the user having chosen specialty tours for two of those sites.

FIG. 85 is a view of the partial sub-template listing within the display screen of the article of FIG. 84, but also showing the user having selected the “Rome Walking Tours” and the “Churches & Temples” sub-templates, and having assigned a weight factor for each of them, and with the user exploring the sites listed within the “Ancient Temples” sub-template.

FIG. 85A is the view of FIG. 85, but showing only the display screen of the device.

FIG. 86 is a view of the partial sub-template listing within the display screen of the article of FIG. 85, but also showing the user having selected the “Museums & Galleries” sub-template, the “Piazza's” sub-template, the “Ancient Rome” sub-template, the “Fountains and Monuments” sub-template, and the “Rome Side-Trips” sub-template, and having assigned a corresponding weight factors, as well as having selected “Pompeii” from the “Rome Side-Trips” sub-template.

FIG. 87 is a view of the partial sub-template listing within the display screen of the article of FIG. 86, but also showing the user having selected the “Markets & Shops” sub-template, and the “Cafes and Coffee” sub-template, and having assigned corresponding weight factors, to complete the selection of desired sub-templates for use in creating the itinerary.

FIG. 88 is a view of the article of FIG. 87 after the user has confirmed the selected sub-templates by hitting the enter button, where the user is then given options to specify the user's customary touring speed (amount of time that should be allotted to sites to be allocated from the sub-templates), or is given the option to accept a default touring speed, based on weight factors.

FIG. 89 is a view of the hourly calendar planner of the display screen for the article of FIG. 79, but after the software of the present invention has performed the work of sorting through all of the potential sites of interest to the user and has allocated sites into the available time blocks according to the user's preferences, based on the weight factors, etc., and according to a hierarchy of rules to improve the user's ability to better execute the competed itinerary at the destination.

FIG. 90 is a view of the hourly calendar planner of the display screen for the article of FIG. 89, but also showing certain options available to the user for further customization of the resulting itinerary.

FIG. 91 is a view of the hourly calendar planner of the display screen for the article of FIG. 90, but also showing the user selecting blocks of time that will need to be customized in accordance with a weather detour.

FIG. 92 is a view of the saved itinerary of the article of FIG. 91, after the user finished selecting blocks of time that needed to be customized in accordance with a weather detour, and after the software again performed the work that would have been required by the user, to re-design the itinerary for the expectation of bad weather during those blocks of time.

FIG. 93 is a view of the saved itinerary of the article of FIG. 92, as it is being utilized by the traveler at the destination, to see possible guidance options while at the Spanish Steps on Saturday evening of the travel week.

FIG. 93A is the view of FIG. 93, but showing only the display screen of the device.

FIG. 94A is a view of the traveler's smart phone with the software of the present invention having been downloaded and available thereon as an application (APP).

FIG. 94B is a view of the smart phone of FIG. 94A, with the traveler using the “ROME #1” itinerary that was developed on a home desk-top P.C., and being at the beginning of the touring day on Sunday, October 21^{st}.

FIG. 94C is a view of the smart phone of FIG. 94B, with the traveler using the “ROME #1” itinerary, and being at the end of the touring day on Sunday, October 21^{st}, and requesting touring options for the current site—the Temple of Portunus and the Temple of Hercules.

FIG. 94D is a view of the smart phone of FIG. 94C, with the traveler using the “ROME #1” itinerary, and utilizing the daily map option that corresponds to the day's itinerary.

TABLE 1 is a sequence of sites and other sub-template information/categories for the “Most Popular Sites” sub-template.

TABLE 2 is a sequence of sites and other sub-template information/categories for the “Churches & Temples” sub-template.

### DETAILED DESCRIPTION OF THE INVENTION

The functionality of the travel planner/guide disclosed herein, is perhaps best discussed in relation to the figures, each of which demonstrates a sample of what is achievable by the software of the current invention in the way of planning assistance and travel guide assistance. Many minor modifications and changes are obvious in view of its adaptability, and some of which are discussed herein as well. Also, although the software may preferably be tailored to work on a dedicated electronic unit having computing capabilities specially designed for such planning, it may nonetheless be adapted for use on a standard personal computer, a laptop, a netbook, an Apple iPad, a phone accommodating programmable applications such as the iPhone, a PDA, and other mobile computing devices. The software may be designed and programmed primarily in an object oriented programming language such as Java or C++, or in a “pure” object-oriented programming language such as Smalltalk, or any other suitable language.

In one embodiment, it may be possible to load and run the software of the current invention on a desk-top PC to do the planning, where a larger monitor may permit better viewing of the photo library herein and other features by multiple persons. Thereafter, the software may also be loaded onto a mobile device, and with the customized itineraries developed on the desktop computer being transferred to the mobile device and usable thereon during travel at the destination, along with the specialized features designed to assist a user during execution of the travel itinerary. To properly enable and claim the software that would be run on such a mobile or desktop computer unit, the unit's principle components and related terminology require a brief discussion. A discussion of such a computing unit, done in terms of an exemplary computing system, may be found at the end of the specification.

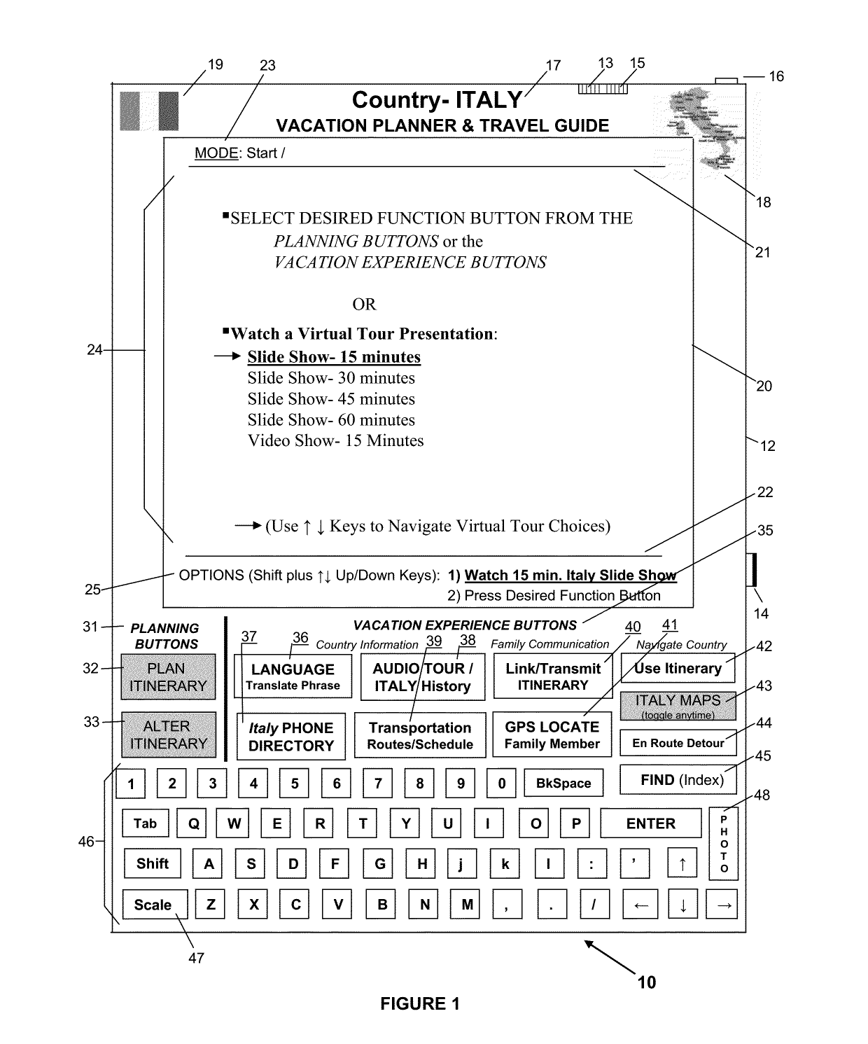

FIG. 1 contains one embodiment of the current invention, which is tailored to permit planning for, and travel assistance within, the country of Italy. It should be pointed out that the software may be tailored exclusively for visiting a destination, which may be a single nation, a single major city of one nation—such as for a ROME travel guide or a New York City travel guide, or for regions of a continent or multiple nations—such as an Asian Travel Planner or a Middle East Travel Planner. In certain instances, particularly in Europe, the software may preferably include certain cross-national planning capability, as many great sites of interest may be just across a border from the “destination,” such as for the city of Ventimiglia in the Italian Riviera, which is a short drive from the Principality of Monaco, and the French Riviera.

The software may also be tailored to accommodate planning for, and guided visits to, “destinations” in the form of particular geographical subdivisions, such as for a newcomer's trip to the New England States of the United States, or the Southern states, or the Midwest. The planning capability may be adaptable for the largest to the smallest possible geographical subdivision or possible combinations. The subdivision need not even be the traditionally recognized hierarchy, such as: a hemisphere, a sphere, a continent, a region of a continent, a nation, a country, a region of a country, a province, a state, a county, a city, a town, a township, a village, a monarchy, a kingdom, a principality, a republic, a district, an island, a quarter, a region, a section, a sector, a colony, a territory, a commonwealth, an empire, a dominion, an enclave, an outland, a union, a body, a sovereignty, a federation, a tract, a square, a precinct, a neighborhood, a parcel, or a patch. The subdivision, which may also be referred to as a category, may therefore also include subdivisions such as the hiking trails of the U.S. or other country, or campgrounds; or be directed to National Parks or State Parks. So merely to be exemplary of one of the possible configurations of the current invention, a travel planner/guide featuring planning and guiding capabilities for a visit to the nation of Italy, is utilized throughout the drawing figures and specification.

The travel planner/guide 10 of FIG. 1 may preferably include a graphical display screen 20 that may be supported by a housing 15. Today, liquid crystal display (LCD) screens offer high resolution for images, and, depending on its size and configuration, very economical power requirements. Any suitable display screen that is currently available, or which may become available as technology improves, may be utilized for the device of the current invention, including DLP and LCoS projectors. When the power is off, the screen would of course be blank, and when initially powered on, the screen 20 of the planner 10 may appear as in FIG. 1.

As seen in FIG. 1, the user may be directed to select the desired function from the Planning Buttons or the Vacation Experience Buttons, or the new user who is just beginning to plan the vacation may choose to first gain more exposure to their destination of choice, by first viewing a virtual tour. The virtual tour may be a narrated slide show tour that takes advantage of the extensive library of photographic images contained therein, as will be discussed later, or it could be a video tour. The slide show may be appropriately comprised of tours of different lengths to accommodate travelers who may be more or less disposed towards the virtual experience. The virtual tours may also serve as a reference for those viewers, which may be watched on successive occasions, to help tailor their own personal itinerary. The virtual tour viewer may also immediately decide to add certain sites shown during the slide show to their soon-to-be or their current itinerary; therefore, there may also be a button feature that permits addition of the site currently being displayed in a slide to an itinerary.

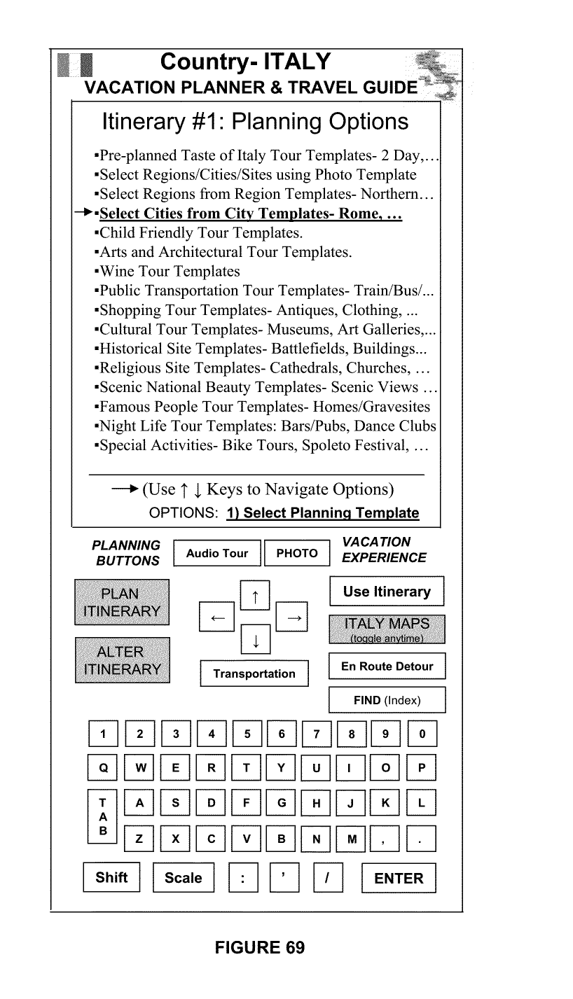

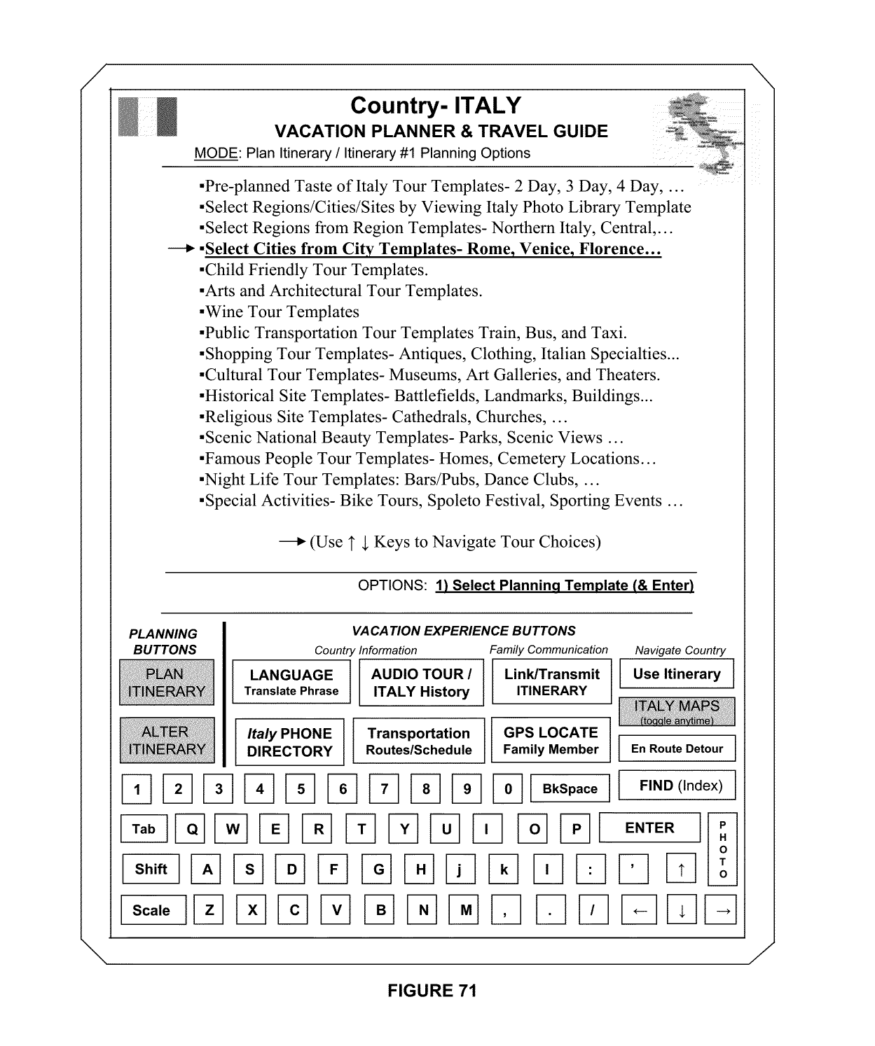

On the housing 15, above the screen 20, may be raised text 17, a map 18, and a national flag 19, all of which may indicate the geographic subdivision for which the travel planner/guide is designed to accommodate. In the case of FIGS. 1-71, the travel planner/guide device is particularly configured for a visit to the nation of Italy, and thus the famous boot-shaped outline of the nation of Italy appears in the right corner, and the green/white/red Italian flag appears in the left corner. Also, as seen in FIG. 69, which shall be discussed further in later paragraphs, a larger, more readily viewable map may be featured on the back side of the housing to provide guidance to the user even when the guider/planner is not in use (powered on). These housing features may simply serve as a quick reference for the user, as other map features are incorporated within the software and will be discussed hereinafter.

The screen 20 may preferably be caused by the software to be segmented by an upper graphical dividing line 21 and a lower graphical dividing line 22. Above the upper dividing line 21 may be a “Mode” line 23 which describes the function, and stage of a particular function at which a user may be working on his/her planning, to allow the user to put the device down and return at a later time to quickly assess the current point of planning. The utility of the mode line 23 will become apparent by viewing successive figures and the functionality described therein.

Located between the upper dividing line 21 and lower dividing line 22, may be a central information region 24, where information from a database of travel information relating to a destination may be displayed, and from which the user may make a selection for the trip itinerary from a number of templates. Navigating between the templates, in order to make a selection, may be enabled with any number of different possible key entries, or even by making a selection using a mouse, trackball, or other peripheral device to move a cursor. However, in one embodiment, it may be that no peripheral device is utilized, and that, to be exemplary, the arrow up (↑) and arrow down keys (↓) may cause the choices to be highlighted for subsequent acceptance. The tab key may also function in the same manner. Hereinafter, any of those references may be presumed to be useable in permitting movement of a cursor up or down to highlight alternative choices. The use herein of the term “highlighting,” may mean the addition of a colored background for a choice or option being chosen, or it may instead be a combination of bolding and underlining of the textual template or option, or it may be coloring, bolding and underlining. As seen throughout the figures, the software may provide a cursor in the form of a bold arrow to identify the currently selected template/sub-template, in addition to highlighting.

When a list may be so long that it does not fit completely on the screen 20, continued use of the arrow down key (↓) may cause the list to scroll or page down to the next set of choices. When it pages rather than scrolls down to a next list of choices, it may preferably be with the last choice on the previous list that was displayed becoming the first choice at the top of the successive list, to serve as a visual reminder. Conversely, continued use of the arrow up key (↑) may permit the user to scroll or page backward or upwards through the list of choices.

Below lower dividing line 22 may be a list of options and directions 25, which, when selected, may cause the device to do one of the following: to accept a highlighted selection from the choices being displayed from the informational database; or supplement the displayed information; or perhaps to return the user to a different stage of the planning Other possible options will be discussed in the context of the Figures illustrating particular templates—templates that may be enhanced with additional options.

The directions of the options/directions 25 portion of the display may also remind the user to hold down the shift key in combination with the arrow up/down keys to highlight a desired template. Thereafter, the user may communicate the template and preferred option (both being highlighted) to the software, by hitting the enter key.

There may preferably be a number of special function buttons and keys, as mentioned above, to enable the user to more easily navigate through the software. The function buttons, which will each be discussed in some detail hereinafter, may generally be divided into planning buttons (FIG. 1), and be so denoted using a textual reference 31, and vacation experience buttons, having a similar textual reference 35. The planning buttons may comprise a “Plan Itinerary” button 32, and an “Alter Itinerary” button 33. The vacation experience buttons may comprise function buttons with the following general functionality: providing country-specific information; permitting certain communication with traveling companions who may similarly be guided by the software of the current invention, though doing so independently using their own device; and providing information to navigate the country. The country-specific information may be accessible through a “Language” button 36, an “Italy Phone Directory” button 37, an “Audio Tour/Italy History” button 38, and a “Transportation” button 39. The communication between traveling companions, denoted in the Figures as “Family Communication,” may be accessible through a “Link/Transmit Itinerary” button 40, and a “GPS Locate Family Member” button 41. There may be three function buttons for navigating the country, including a “Use Itinerary” button 42, an “Italy Maps” button 43, and an “En Route Detour” button 44. In addition, a “Find” function button 45 may act as an index to be used to selectively access a wide range of information contained within the database, which may overlap to a certain degree with some of the other functions that also providing database information.

The keys mentioned previously may be those alpha-numeric keys 46 that may ordinarily be found on a standard computer keyboard, and which may preferably be similarly arranged for ease of recognition. These keys/buttons may additionally include a scale button 47 and photo button 48, which will be discussed later.

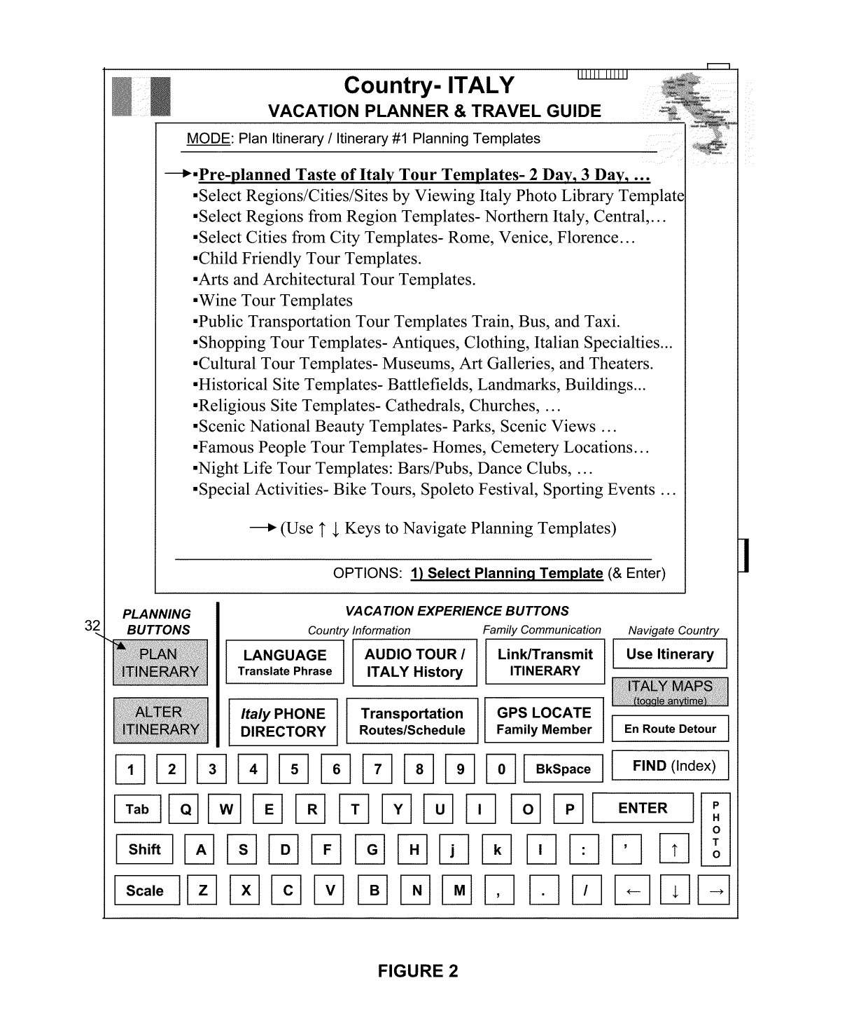

FIG. 2 illustrates a user starting to plan a first itinerary, which begins by pushing the plan itinerary button 32, which produces a change in the display screen as shown. The mode line 21 now shows the stage of operation as being the “Plan Itinerary” mode. The central information region 24 displays a list of options, each of which may comprise a specialized template from which the itinerary planning may proceed. The templates may group or organize touring options according to certain methods of planning, certain viewing possibilities, and possibly according to certain categories of vacation attributes or parameters. The itinerary from such planning templates may be further customizable during initial planning, as well as at later points in the planning process.

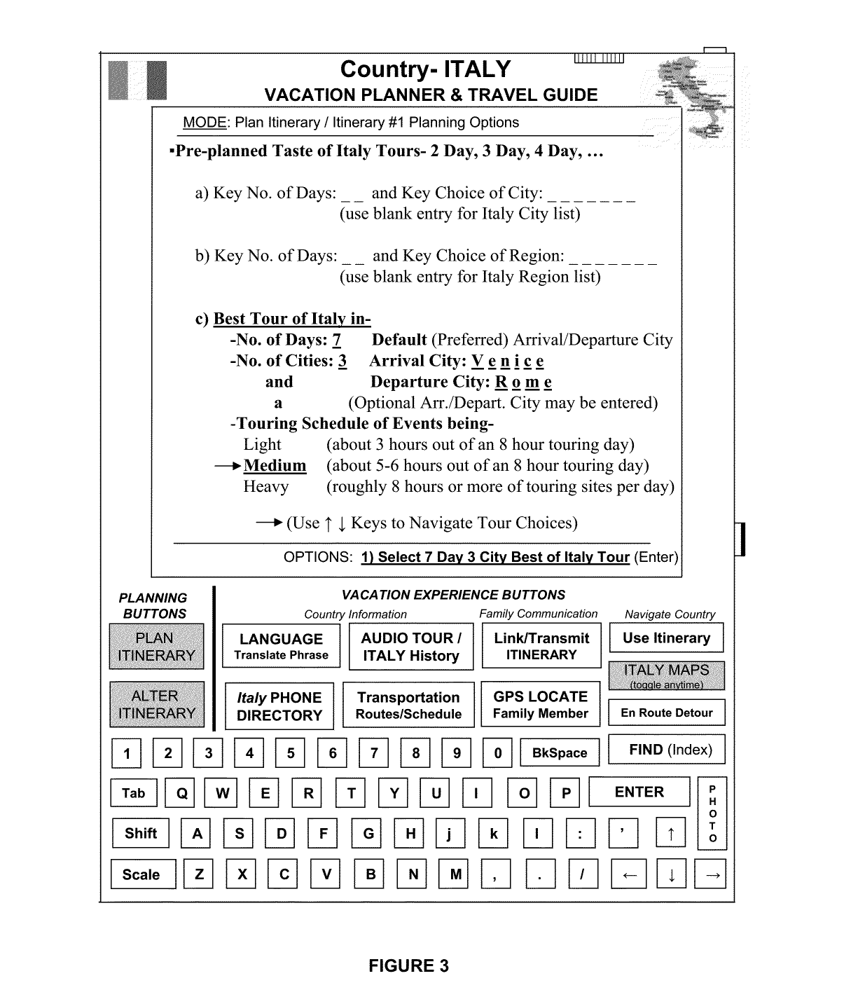

As a first example, FIG. 2 shows the “Pre-planned Taste of Italy Tour Templates—2 Day, 3 Day, . . . ” being highlighted and selected as the first planning template. Multiple templates may be used to plan a single vacation itinerary, and one method of doing so will be explained later. Hitting enter to accept that template causes the display of FIG. 3, which provides three possible related planning template, or sub-templates. In the first sub-template, “a) Key No. of Days: ______ and Key Choice of City: ______”, the user may specify trip duration to be a specific length of time matching the traveler's available time in country—2 days, 3 days, . . . , 7 days, etc, and the choice of a city that the traveler would like to explore. The next sub-template, “b) Key No. of Days: ______ and Key Choice of Region: ______” permits the user to plan an itinerary for a visit to a particular region within Italy.

Many users may prefer sub-template (c), in which the user may specify the number of days in country, the number of cities, and a touring schedule ranging from light to medium to heavy. A light schedule may be one where the template selects the most desirable sites to be visited, but limits touring in a single day to roughly 3 hours, leaving the traveler a generous amount of time to linger at sites found to be more interesting. The medium schedule may encompass 5-6 hours of site viewing, while the heavy schedule may comprises 8 or more hours of site visits. The travelers may further customize the heavily-scheduled itinerary to plan for touring of sites for 12-16 hours a day, provided the sites are accessible to visitors.

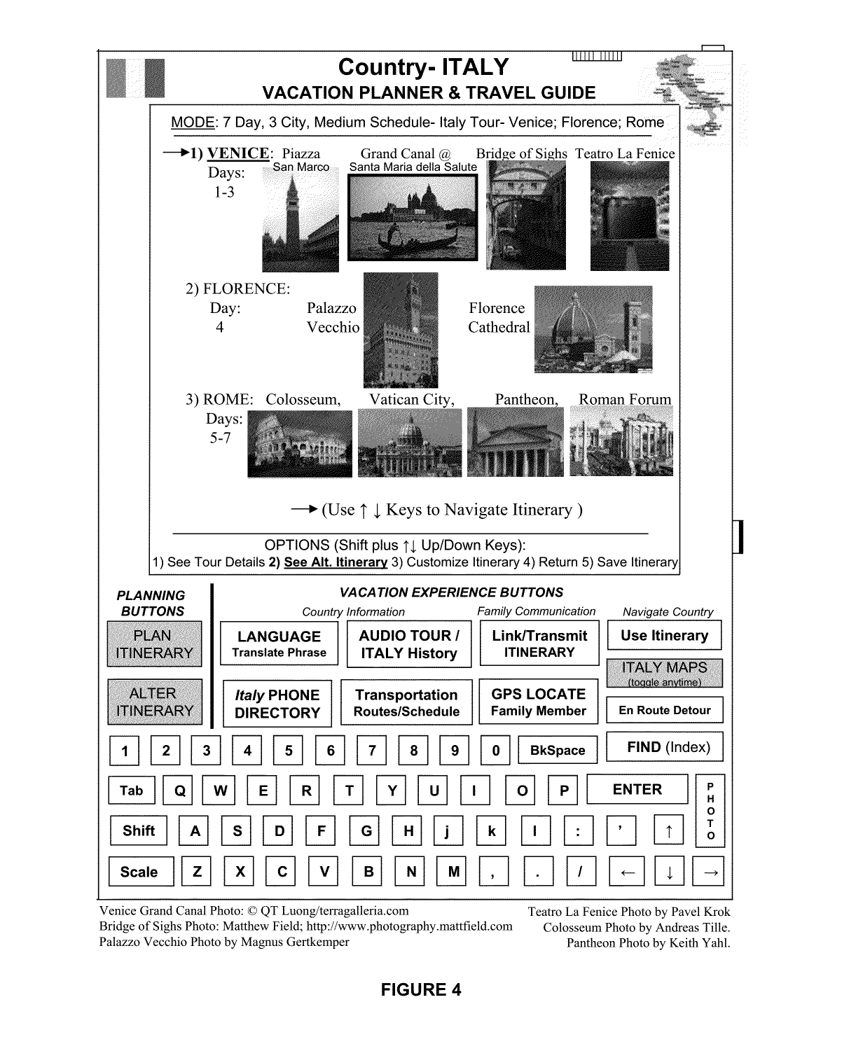

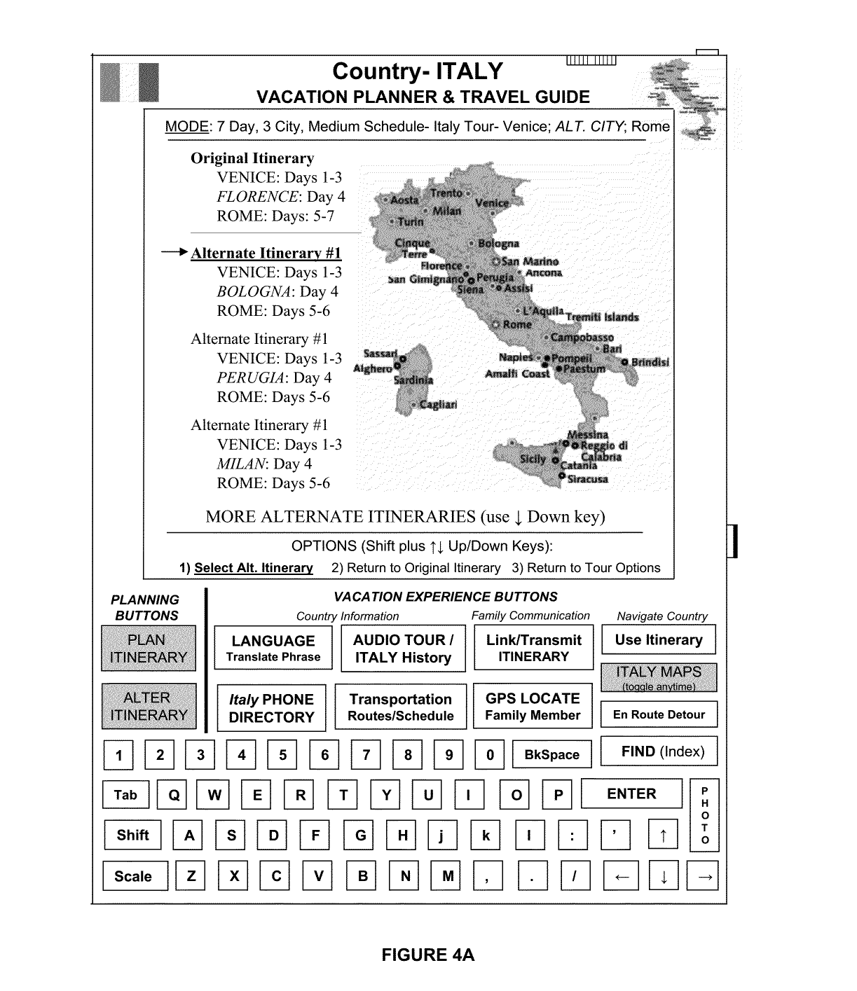

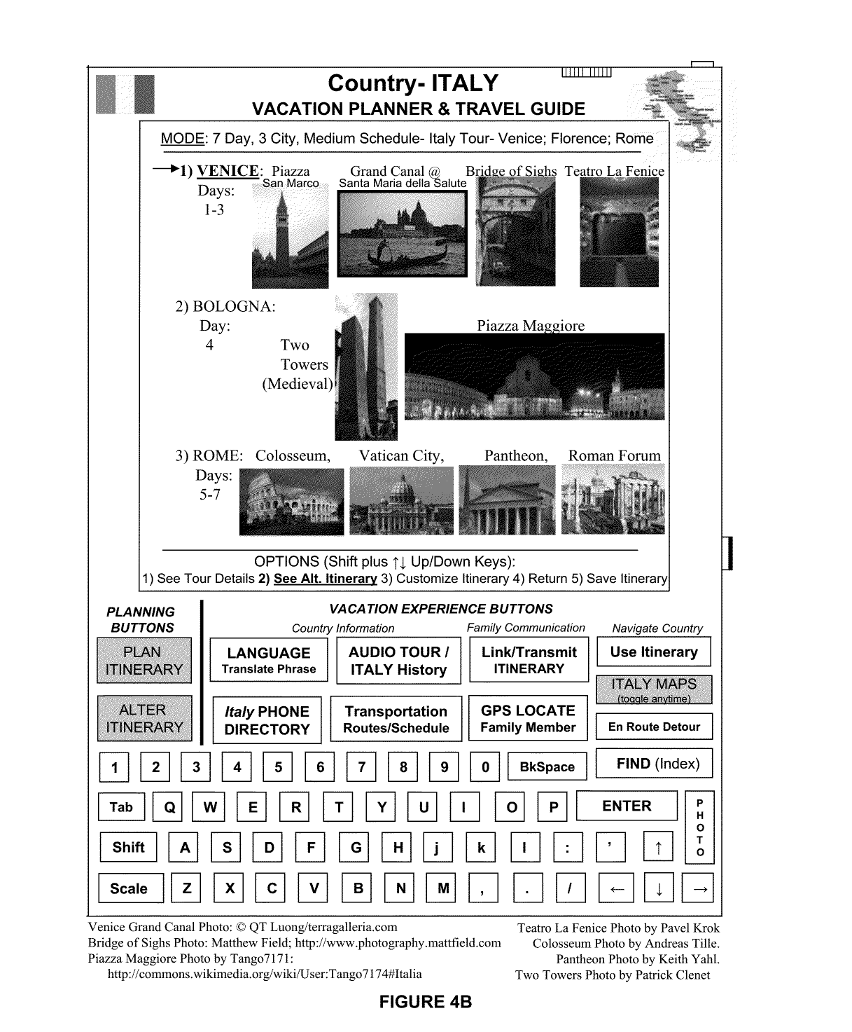

The device returns an itinerary that has been optimized according to the allotted time for the traveler to see as many of the most significant highlights as possible, in the given touring time. The programming associated with the template will also specify a default (or ideal) arrival and departure city for the trip to the country, both of which may be modified, as a returning vacationer may wish to focus on different parts of a country. A first-time visitor may choose the standard Venice to Rome itinerary, but may, for example, wish to do a Sicily to Rome itinerary on a subsequent trip to see different parts of the country. The programming for the template will also select the most favorable intermediate city or cities for the trip, and, for a 7-day, 3-city tour, may return the itinerary shown in FIG. 4. The itinerary may preferably display photographs of the recommended sites to be seen in the cities returned in the itinerary. As seen in FIG. 4, the program may default to an itinerary with Florence as the third city to be visited, with it being intermediate to the arrival and departing cities, and it may be most likely to be of the greatest interest to most visitors. One of the options in FIG. 4 (“See Alt. Itinerary”) permits the traveler to consider other itineraries, and selecting that option may cause the display of FIG. 4A, which comprises a list of itineraries having alternate cities for the intermediate stop, along with a map for reference by the traveler to be able to gauge the travel distances. Highlighting and selecting the first alternate itinerary, a Venice-Bologna-Rome itinerary, may produce the screen of FIG. 4B, which is the same as FIG. 4, except for showing Bologna as the intermediate stop, along with the prospective site visits to the medieval Two Towers of Bologna and the Piazza Maggiore.

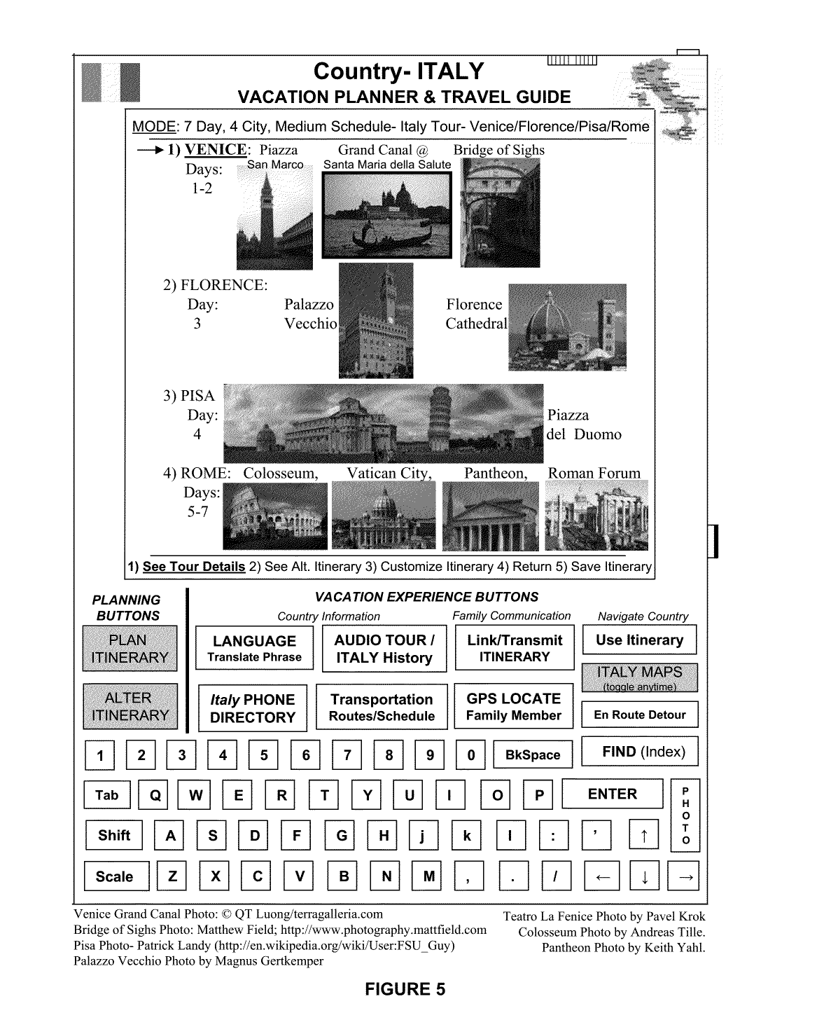

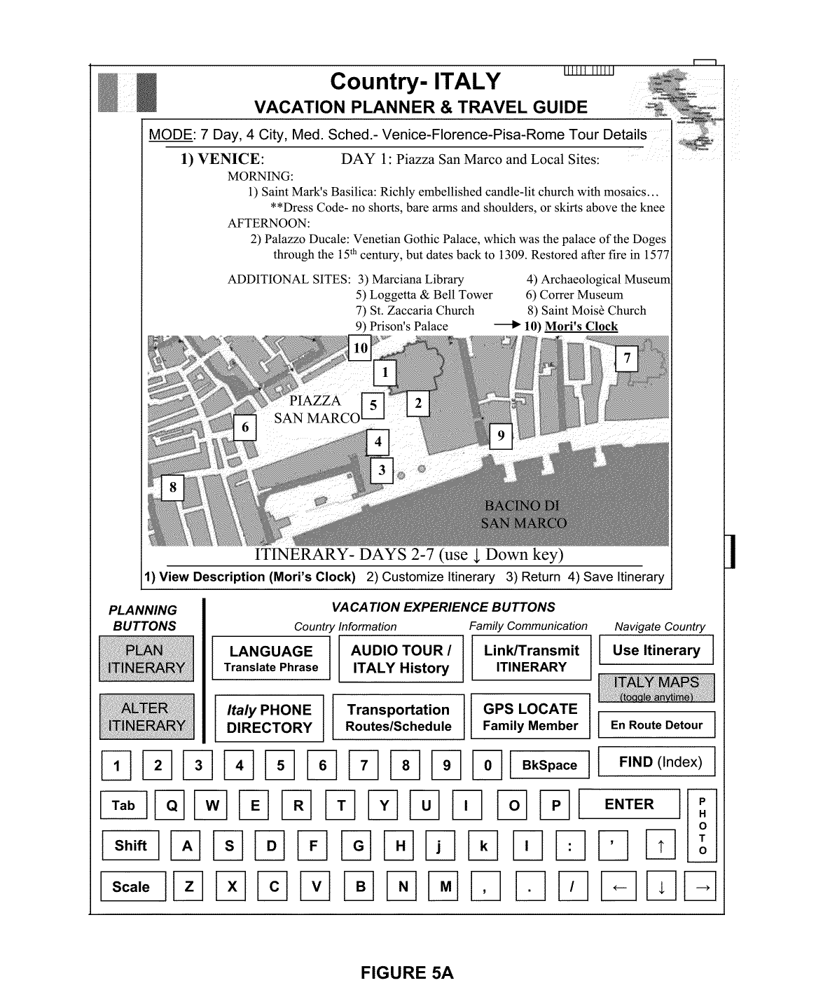

If the user returned to the entry screen of FIG. 3—used for inputting parameters into the template—and chooses instead to visit a total of four cities, the programming may return the itinerary of FIG. 5, which may also include the city of Pisa in addition to Florence, but may also eliminate certain sites from Venice, as Venice may now only include two days of the seven days in-country. Highlighting and selecting the option to “See Tour Details” may produce the screen of FIG. 5A. Highlighting one of the sites and selecting the “View Description” option may provide the user with detailed information about the site.

Use of the FIG. 3 sub-templates may require the user to defer, to a certain degree, to another person's rank ordering of the priority of places and sites that should be visited, but the user opting for this planning template is relying upon the advice of a knowledgeable planner, and of course will nonetheless still be able to tailor or customize that pre-planned itinerary, by selecting alternate cities, and by using the Customize Itinerary option, or the Alter Itinerary button 33, which is discussed later. The “customize itinerary” option may be used to replace cities returned by the programming with other cities the user later deems more desirable. The customize option may also supply a detailed list of sites and events available in each city, to aid the user in making choices. This customization will be discussed in later paragraphs, in relation customization of an itinerary produced using another planning template.

A template is a pattern that is used to help shape things accurately, and herein, the templates are used to help a user to more easily shape the vacation to specifically be as he or she desires, by starting out with a means to narrowly choose from all of the possible travel options, by using the advise of experts, even though it is still possible to customize any itinerary. The templates remove the burden of searching through books and brochures from the shoulders of the potential traveler, in order to devise a sensible itinerary, through synergistic use of the templates, algorithms and databases of the software.

It should be pointed out that a site could be just a place, such as an open field, which may be of major historical significance, with an example being an open field where a major U.S. civil war battle occurred, or the beaches of Normandy, France where the D-Day forces landed. In addition, certain sites may comprise a place with a structure sitting upon that location, such as where there may have been a fort built upon that battlefield. Lastly, a site may be a place where an event occurs, such as a civil war reenactment within an open field, or it could be an event that occurs in a structure that had been built upon that place, such as a civil war reenactment in that fort, or even just a play in a theater. So a site may refer to a place, a structure, or an event, or some combination of those three. Hereinafter, use of the word “site” may be construed to represent all three possibilities and any possible combinations therebetween.

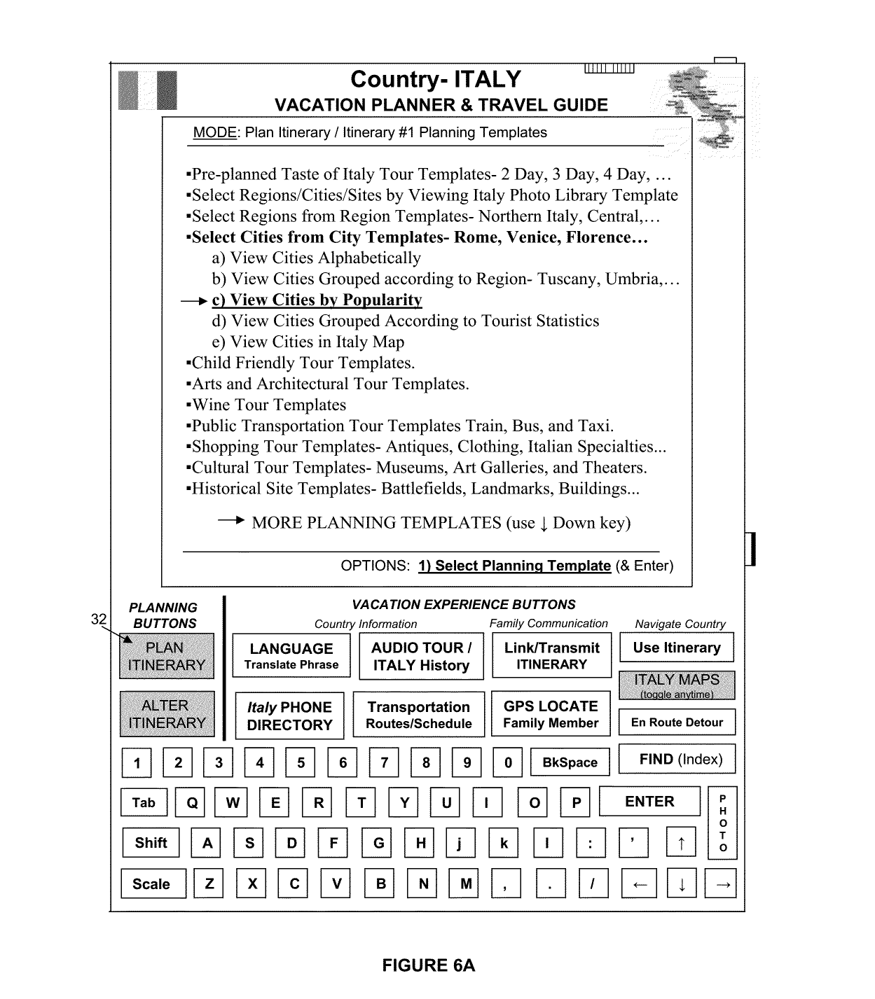

Some travelers may prefer to browse a library of photographic images, and create an itinerary by selecting sites at the destination country according to their interest in those images, as illustrated in FIG. 6. These photos may be sorted into viewing templates, where the photos may be viewed in groups according to an alphabetical city listing, an alphabetical region listing, by popularity of the cities, regions, or sites therein, as well as by other possible viewing templates. Some other viewing sub-templates may further subdivide the library, such as by certain traveler statistics—i.e., by most popular sites for European travelers, or by most popular sites for American travelers, etc.

Alternatively, a user may seek to personally plan the entire itinerary by selecting several regions of Italy to visit, based on their prior personal knowledge, such as wanting to specifically explore the regions of Tuscany, Umbria, and The Marches, because of many pop culture references to that particular part of Italy. The user may also similarly desire to visit only certain specific cities in the nation, and may plan an itinerary based on that construct. There are countless different templates that may be loaded into the software, but a non-exhaustive list may also include templates which cater to planning for: child-friendly tour sites and accommodations; tours which focus particularly on art or architectural centered tour options, which may be desirable in places like Paris, France; wine tour templates for the wine enthusiast/connoisseur; tours accomplished solely through the use of public transportation, perhaps for the college student traveling across Europe; shopping tour templates; cultural tours which focus solely on the museums or the theatres; historical site templates; religious site templates; scenic natural beauty tour templates; tour templates focused on famous people whether from a historical point of view, such as the founders of the United States—where they lived/died—or from the pop culture point of view, such as Jim Morison's grave, or a Beatles tour of England); tours focused on the nightlife of a city of nation; or tours based on special activities, such as the three week-long Spoleto Festival—the Festival dei Due Mondi—which is held annually in Spoleto, Italy. For each of the possible planning templates, an algorithm progressively provides instructions for graphical displays, on the screen, of choices and options to aid the user in customizing the template, and records progress made in planning the itinerary in a non-volatile memory, which may later be changed and/or erased. It should be noted that an algorithm is generally a set of rules (procedure or formula) for solving a problem in a finite number of steps, and in mathematics and computer science, an algorithm usually means a procedure that solves a recurrent problem, though some may refer to a computer program itself or portion thereof as an elaborate algorithm.

As previously stated, each of those templates may be further divided into sub-templates, some of which will be discussed in detail in later paragraphs, to be illustrative of how all of the sub-templates may operate. However, some of the possible sub-templates are mentioned here. For example, the photo library may be subdivided into sub-templates such as: viewing the library alphabetically by city, or alphabetically by Region, or by viewing the library according to site popularity. The regions template may have sub-templates of: Northern, Central, and Southern regions, or Easterly and Westerly regions. The city template may be subdivided into sub-templates comprising: cities listed alphabetically, cities grouped according to region (Tuscany, Umbria, . . . ), cities listed by tourist popularity, or according to certain statistics, or by map locations. Child friendly sites template may be further subdivided into sites and accommodations welcoming and appropriate for: babies, toddlers, young teenagers, or young adults. The architectural tour template may be broken down into sub-templates such as: architectural styles, or by architecture attributed to specific historical periods. The vineyards template may be subdivided into sub-templates of: white wines and red wines, or by grape varietals, or by wine regions of the country, which for Italy corresponds to its 20 geographic regions—Aosta, Calabria, Liguria, Lombardy, Veneto, Tuscany, Sicily . . . (and for the U.S. —Napa/Sonoma Valley . . . , and for France—Alsace/Armagnac/Beaujolais/Bergerac/Bordeaux/Burgundy/Champagne, . . . ). The public transportation routes template may have sub-templates comprising train tours, bus tours, boat tours, charter tours, and highway tours. The shopping template may be broken down into fashion by designer (Armani, Biagiotti Laura, Bulgari, Capasa Ennio, Capucci Roberto, Cavalli, Dell'Acqua, Alessandro, Dolce e Gabbana, Donatella Versace, . . . ), or by antique types, jewelry, or specialties of the region/nation. The museum template may be broken down into sub-templates of history museums, archeology museums, automobile museums, maritime museums, art museums, heritage museums, railway museums, science museums, aircraft/aerospace museums . . . . The art gallery template may be broken down into sub-templates of oil paintings, sculptures, watercolors, photography, . . . . The theater template may be broken down into sub-templates of: musicals, drama, dance . . . , or by geographic category such as, for New York city, Broadway shows, off-Broadway shows . . . . The historical sites template may be comprised of sub-templates of: war battlefields/memorials, political buildings, birthplaces and homes of famous people (e.g., Christopher Columbus in Genoa), gravesites of famous people, locations of famous civic movements (the Renaissance Movement in Florence) . . . . The religious site template may comprise sub-templates of: churches, temples, cathedrals, chapels, basilica, monasteries, convents . . . . The scenic views template may be made up of sub-templates permitting planning according to ocean views, mountain views, or forest scenic views, or may be subdivided into hiking views or driving scenic views . . . . The night life template may be subdivided according to famous pubs/bars, dance clubs (disco, ballroom . . . ), karaoke clubs, or popular establishments for particular tastes . . . . It should be apparent that some of these sub-templates may overlap, and that this list, like the list of templates, is also non-exhaustive.

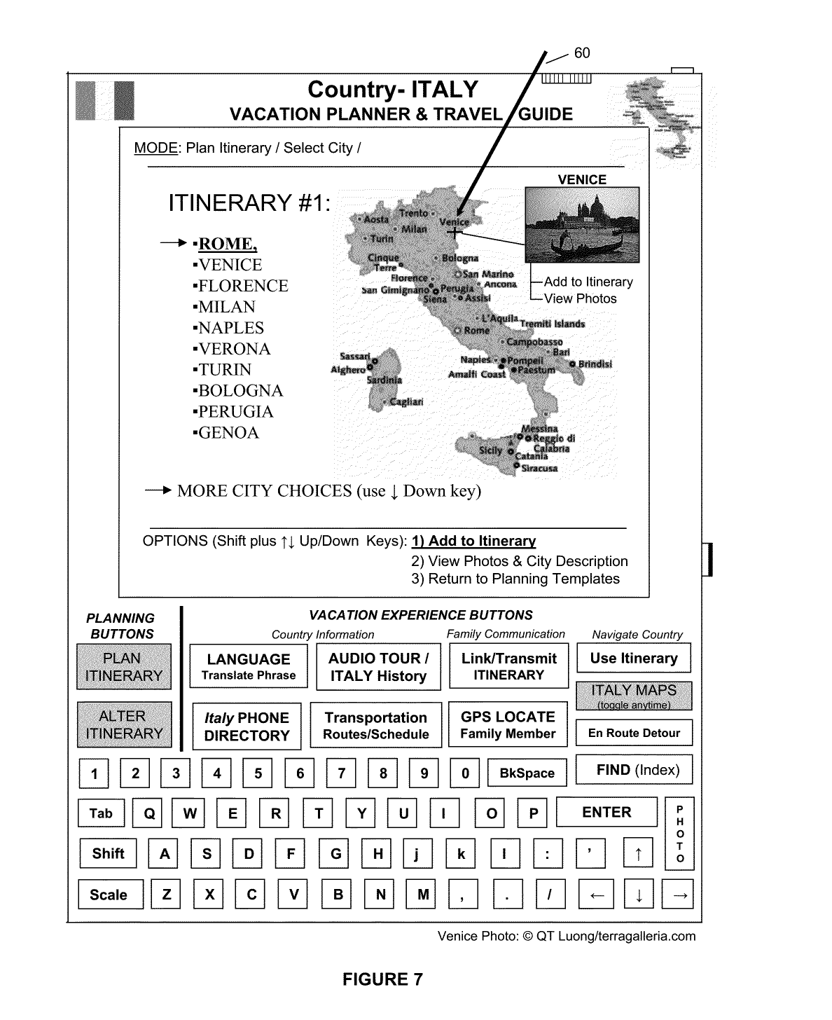

To be further illustrative of how the software may operate, planning, using one or two of the above templates, is discussed in detail and illustrated in the figures. In FIG. 6A, the user has highlighted “Select Cities from City Templates—Rome, Venice, Florence . . . ” using the arrow down key, which reveals several sub-template choices. The sub-templates may include viewing the cities in an alphabetical listing, viewing cities as they are grouped according to the region they are in, viewing cities in a list according to their popularity among visitors, or possibly by viewing cities according to tourist statistics, or by appearance in an Italy map. Hitting the enter button may cause the screen to appear as in FIG. 7. The device in FIG. 7 displays a list of cities in Italy according to their popularity, each of which may be selected to be in the traveler's itinerary. The list of cities may be quite lengthy, as it may include every city in the nation, both large and small cities/towns.

The software may also provide a map image in the central information region 24, to help in planning that makes for a sensible geographic sequence. While only the cities of Rome, Venice, Florence, Milan, Naples, Verona, Turin, Bologna, Perugia, and Genoa are shown in the initial list, a message, as previously described, alerts the user that more cities may be viewed and selected by using the arrow down key. The options/directions list 25 currently shows (in FIG. 7) that there may be three options: either selecting a city choice and hitting the enter key to add that choice to the itinerary, or viewing photos of the city along with a description of the city's offerings, or returning to the planning options of FIG. 6A to use a different template to plan the itinerary. Of course, it may be desirable for other options to appear in different embodiments. There may be one provided to exit the software application, or if the software is utilized on a dedicated electronic unit, exiting may simply involve shutting off the unit using an on/off switch 14. The use of the photo library contained within the informational database relating to the destination will be discussed in more detail later. It is intended as an aid to the planner in deciding if the city architecture, sites, history, or other attributes, in the visual sense, make the city appealing enough to add to the itinerary. The photo may also become part of the itinerary itself, as a visual reminder of the choice made, as will be seen later.

In an alternate embodiment, each city in the list may have a corresponding photograph associated with it, and in yet another embodiment, the city list may include the map image displayed in FIG. 7, which may be a selectable map, wherein the cities or regions may be selectable either through the use of a finger tip, or more preferably, using a stylus 60 or an attachable pointing device such as a mouse. Moving the stylus over the city of Venice and tapping on the city name may cause a representative photo to appear with several options being selectable therefrom, such as the option of viewing the photo library for the city, or to add the city to the itinerary. This method of selecting geographic regions from the map may work in conjunction with the list of cities provided, as the user may want to become familiar with the various city options, which may be done more readily by browsing the map's associated city photos. However, it should be apparent that the list of cities may be too exhaustive to be visually generated on the map image for the entire nation, which may be enlargeable to accommodate such visualization.

If the user selected the “View Photos” option from the graphical selection of Venice from the map, it may show on the screen that place in a library of photographs at which begins all of the photographs of Venice that are in the database. The library of city photos at this entry point may also be organized alphabetically, and may also permit the user to just page through the library and select cities for the itinerary from the photo listing. (Note that selection of “View Photos” from the planning template of FIG. 7 may similarly display the same photos from the library, as may be viewed through the Photo Library Template of FIG. 6).

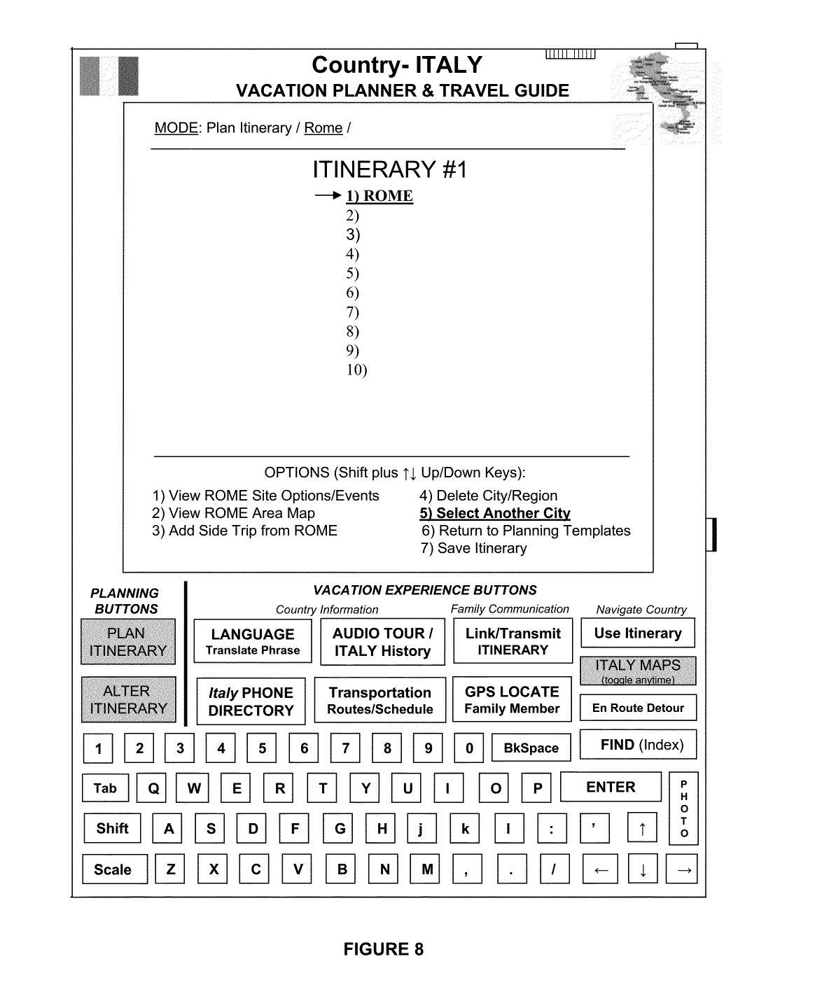

With the city of Rome selected from the list in FIG. 7, and with the user hitting the enter key to add Rome to the itinerary, the device may appear as seen in FIG. 8. The software may show a heading in the central information region 24 indicating that planning is ongoing for Itinerary #1, or alternatively, that information could be provided in the mode line 23. The software may then preferably show a listing, in the mode line, of all selections made for the itinerary, which so far, only includes the city of Rome.

Once a selection has been made from among those offered in the chosen template, various different choices may appear, to continue tailoring the itinerary returned by the software in order to create a custom itinerary. Also, the options/directions list 25 may present different options to the user, depending upon which portion of the planned itinerary is highlighted. In FIG. 8, seven options may be offered, including: viewing the possible sites or special events that may be available in the city of Rome; viewing an area map of Rome, which may be scalable to aid the planner; adding side trips from Rome, which may comprise part-day or all-day excursions to nearby cities or sites; deleting a selected city or region, altering of the itinerary; selecting other cities; returning to the template list to plan successive legs of the trip using a different template; and having the option to save the itinerary, no matter its stage of completion. Some of these options will be discussed later.

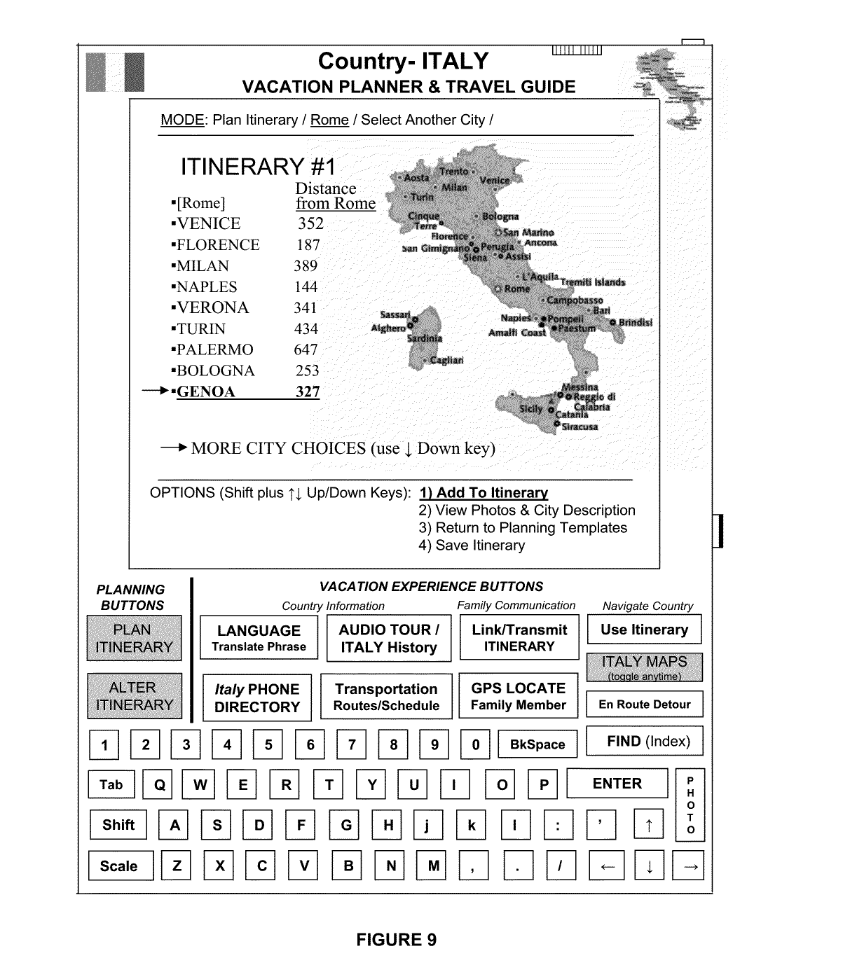

The option to return to select additional cities from the list, discloses other features of the invention. The “Select Another City” option may again cause the city list to appear as it did in FIG. 7, but its subsequent appearance in FIG. 9 may also include a distance from the initial city selected, to provide a numeric context for the visual map image that offers rough guidance as to the proximity of a city to the one that may have been previously selected. With successive selection of cities thereafter, the display may include the minimum distance between other possible destination cities and the next closest city which is already in the list of selected cities. Also, since the city of Rome has already been selected, it may be bracketed and/or no longer be in all-caps to indicate its previous selection. However, it may always appear in the list, and may nonetheless be selectable for multiple appearances in the itinerary, as a traveler may wish to return to a city at a later part of an itinerary.

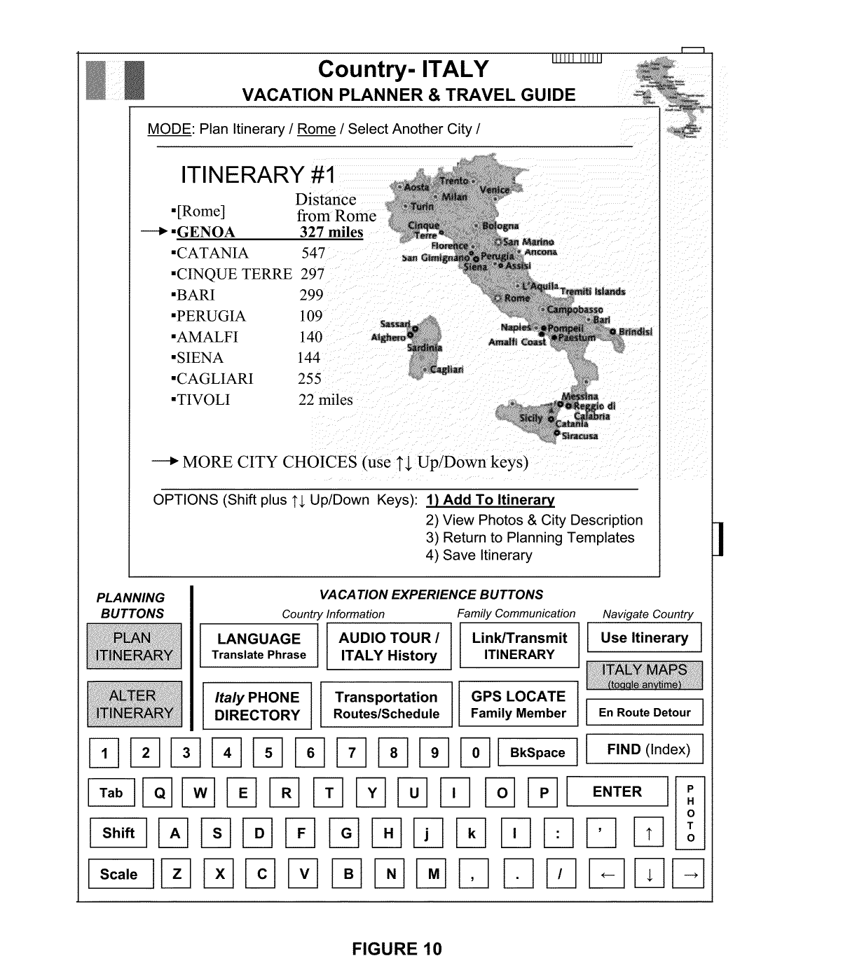

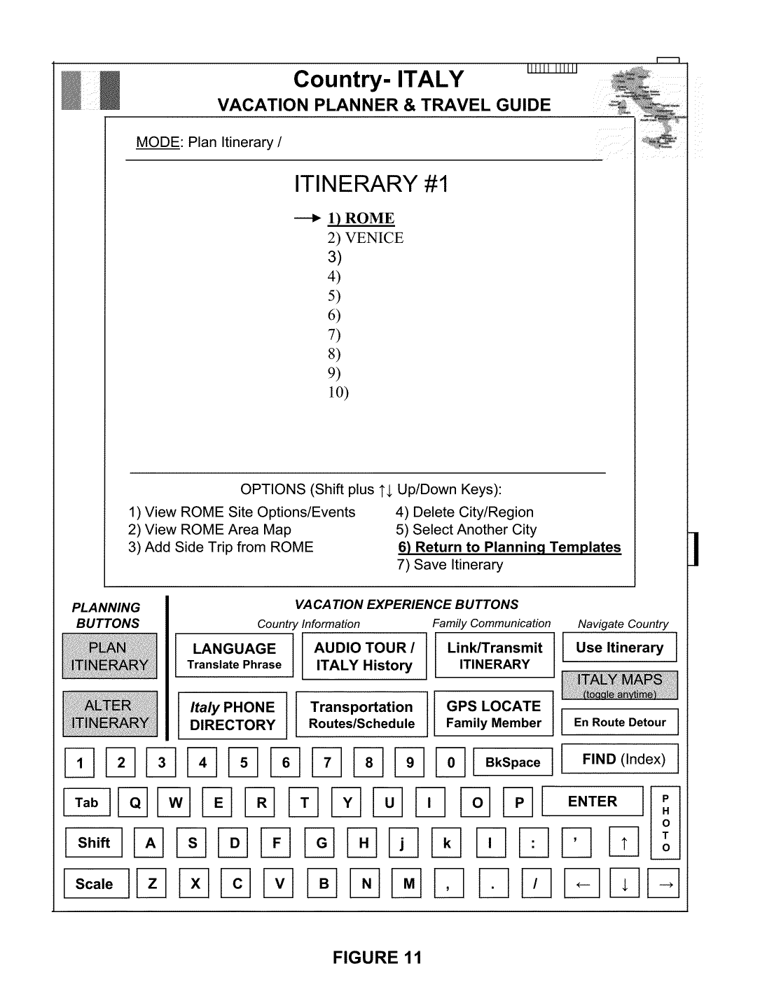

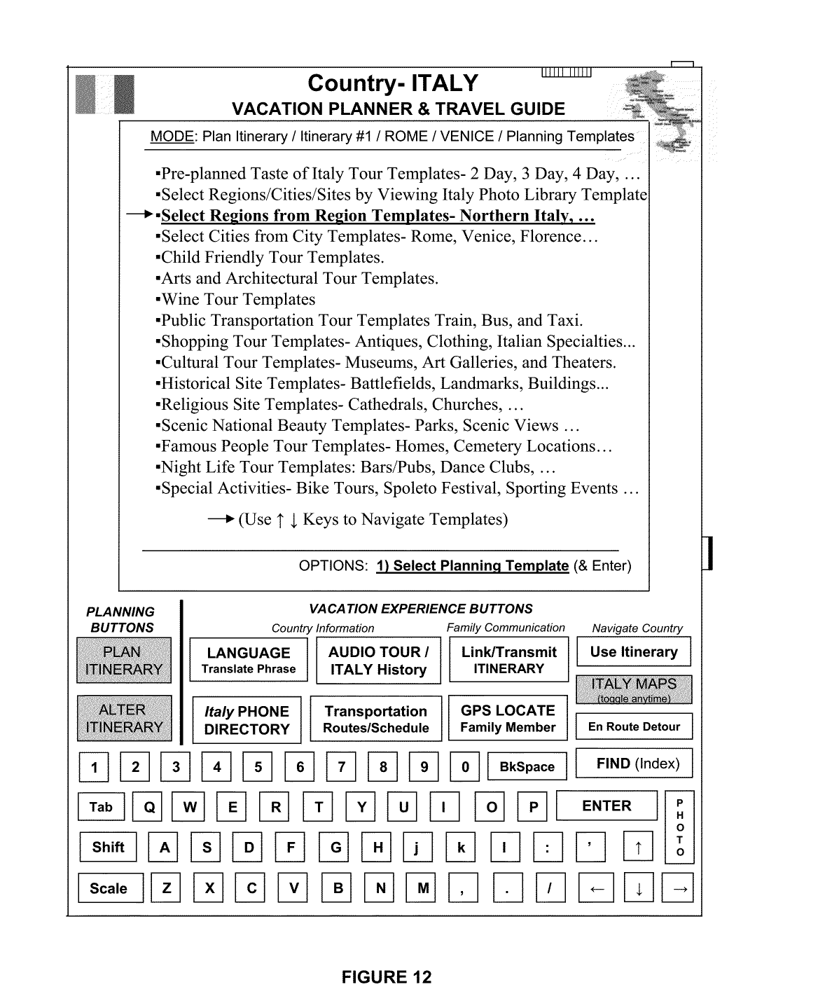

FIG. 9 illustrates using the arrow down keys to reach the bottom-most choice in the list of choices—Genoa—in the initial city list, wherein one more tap on the arrow down key may cause the screen to appear as in FIG. 10, where the list has paged down, with Genoa now being at the top of the list to provide viewing continuity. This paging down arrangement may be typical for lists of choices that are displayed in the central information region 24. Paging back up in the city list to select Venice for the itinerary, results in the updated Itinerary #1 list shown in FIG. 11. Selection, in FIG. 11, of the “Return to Planning Templates” returns the user to the list of planning templates as seen in FIG. 12, which resembles the choices in FIG. 2 (as well as FIGS. 6, 37, and 68), except that the mode text line 23 may display a running list of prior selections (Rome and Venice) to aid the planner.

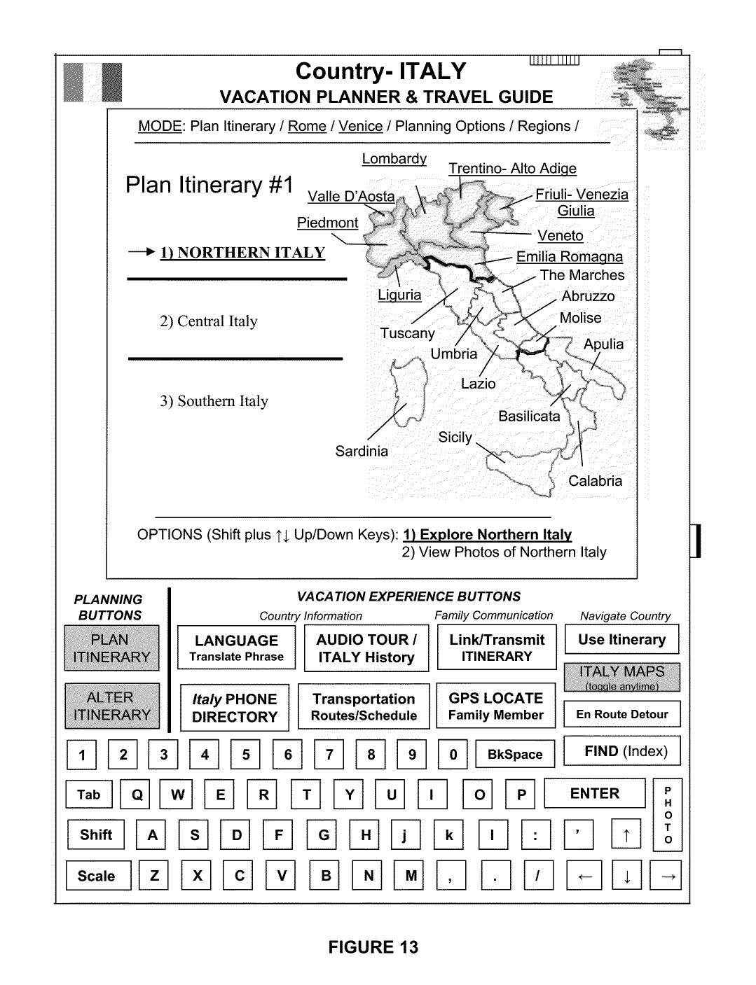

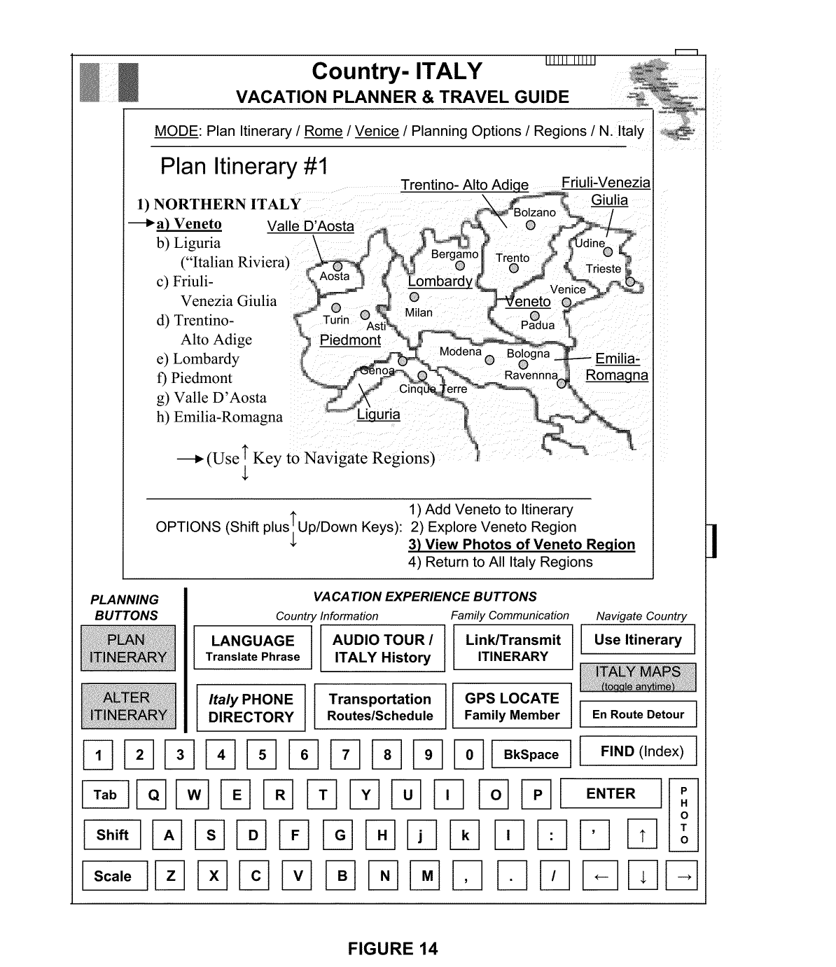

As another example of the possible templates in the invention, choosing the “Select Regions from Region Templates—Northern Italy, . . . ” in FIG. 12, may cause the display of FIG. 13. The display of FIG. 13 may include an Italy map that focuses upon identifying each of the distinct regions of the nation of Italy, and relates them back to their overall geographic location, rather than focusing on individual cities. However, it may also display city locations, but preferably in a less prominent manner. The software may permit selection from the map of one or more of those regions, and it may alternatively permit selection and exploration of the Northern, Central, and Southern portions of the country of Italy. Initially, the Northern Italy option may be highlighted, and the Italy map being displayed may include some subtle shading to indicate which of the regions comprise the Northern portion of Italy. The options/directions list 25 may permit the user to view photos of each of those portions of Italy (Northern, Central, Southern), or, a possible option that is not shown in FIG. 13, may permit viewing of photos of each of the regions (Liguria, Piedmont, . . . ) of Italy. The options/directions list 25 may also permit the user to further explore only the selected portion of Italy—for example, the Northern portion. Selecting the “Explore Northern Italy” option may cause the display of FIG. 14, where the Italy outline map of FIG. 13 has been enlarged to focus on the northern portion of Italy, and with the addition of major cities in those regions also now being displayed.

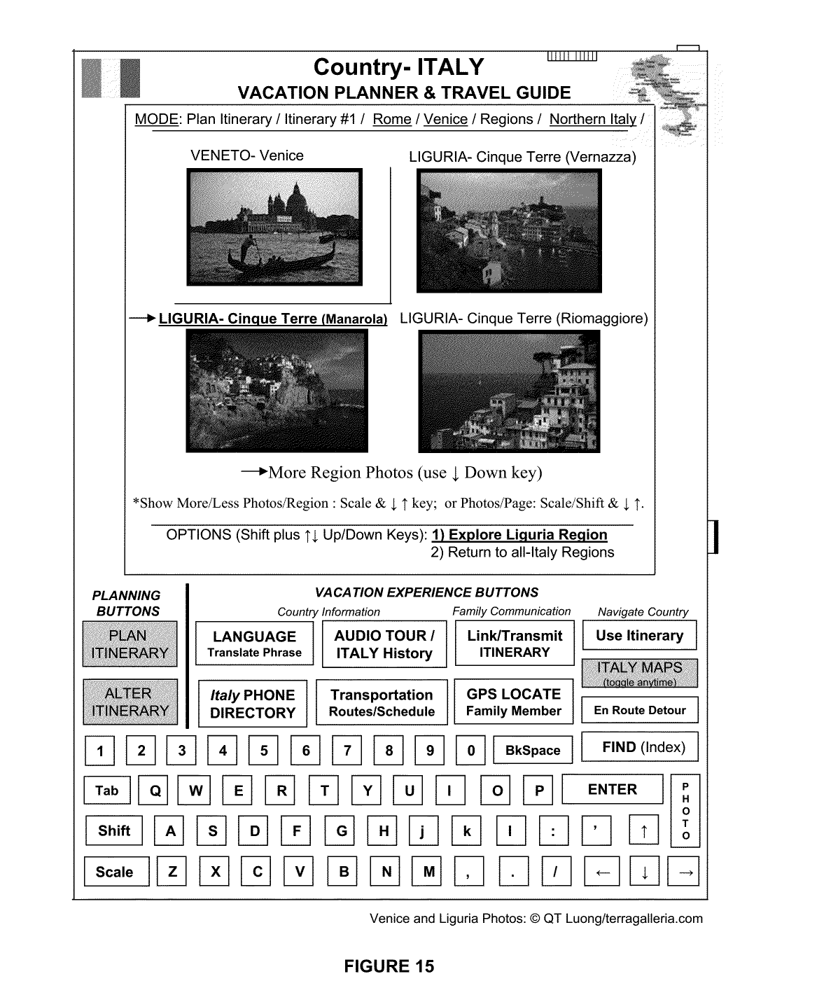

The directions/options list 25 may permit the user to immediately add a region to the itinerary, with greater detail, as to cities and sites, being added later. The region may be selectable from the list, or from its appearance in the map image. Note that the region names may be shown in all-capitals and/or be underlined to distinguish them from the names of cities therein that are being displayed. The directions/options list 25 may also permit the user to instead explore individual regions in more detail, before deciding to add one to the itinerary. Selection of the option to “View Photos of Veneto Region” may cause the display to appear as in FIG. 15, where one or more photos may be shown for each region. Although only one photo is shown for Venice, and there would likely be many more, this illustrates the possible continuity of the photo library, as it also shows photos of the Liguria region, another region in Northern Italy. It may therefore be possible to view each of the photographs contained in the digital photo library according to its appearance in many different templates and sub-templates, or options therein.

The size of the photos being shown may be alterable to be smaller, in order to be able to display on the screen, more photos at a time. Or the photo size may be made larger, to the point even where there may only be one photo displayed at a time. The size option may permit viewing that is suitable to a user because of his or her poor vision, or because of the particular size of the screen of the computing device upon which the software may be running. As an example, the display in FIG. 15 is showing four photos, one for the Veneto region, and three of the five photos for Cinque Terre (“five lands”) in the Liguria region. As noted in the central information region 24, the number of photos shown per page may be adjusted using the scale button 47 and either the arrow up (↓) or arrow down (↑) keys.

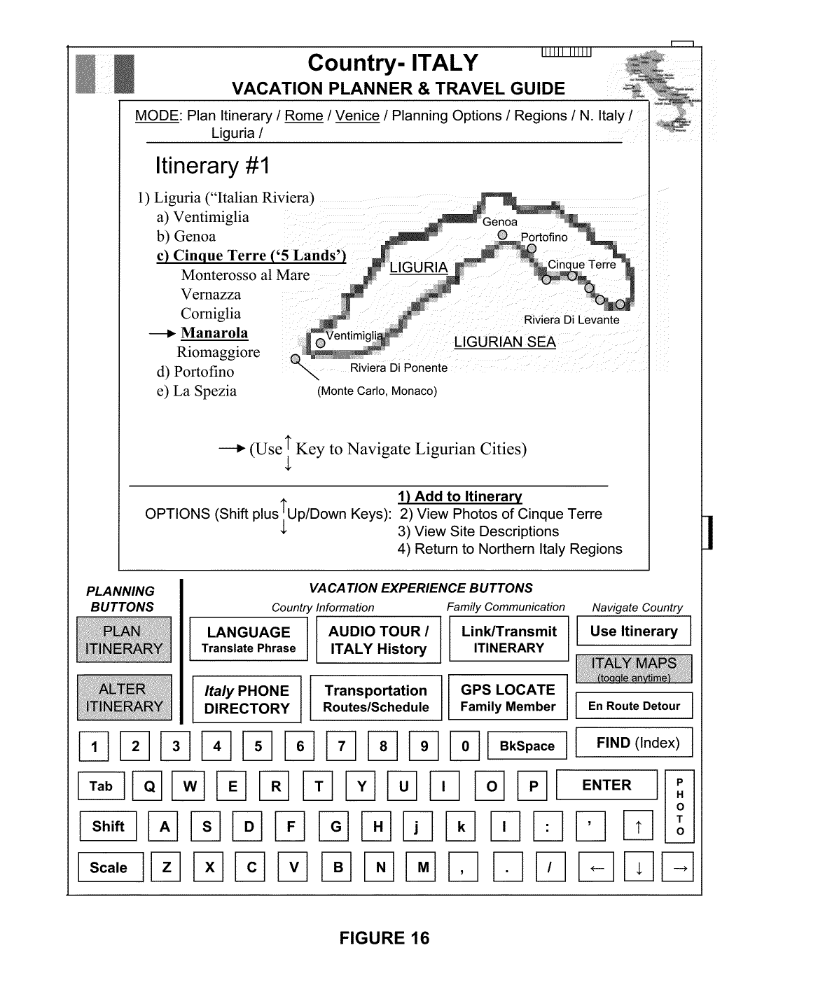

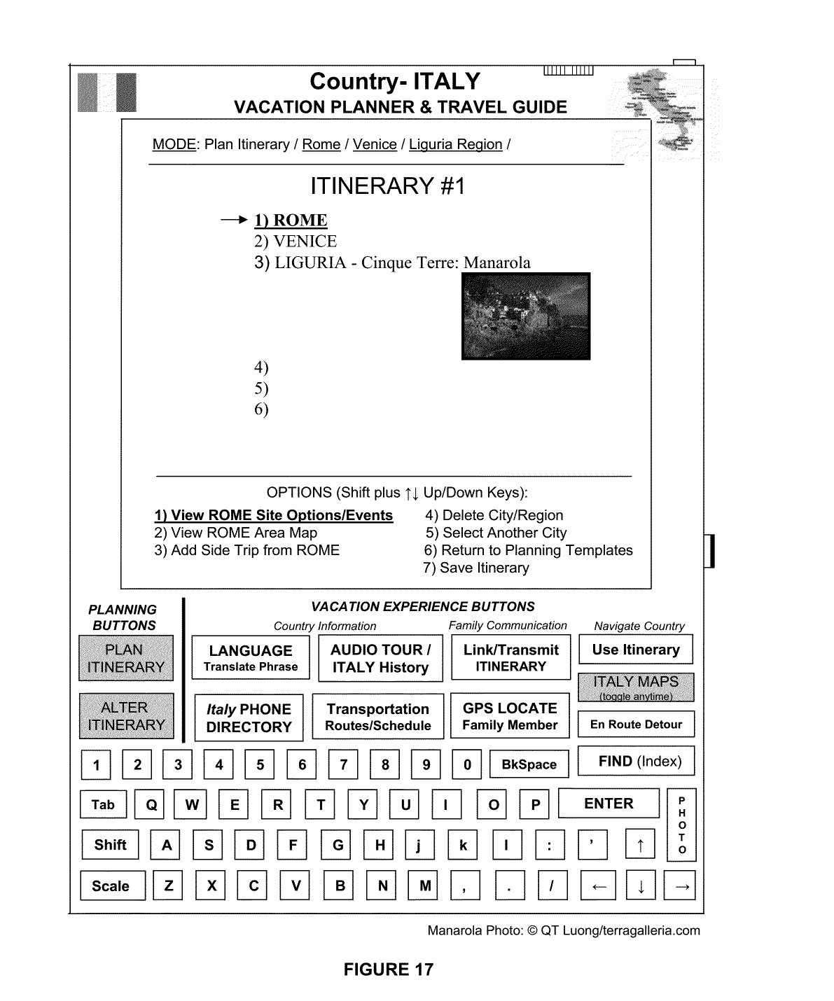

The directions/options list 25 in FIG. 15 may be set up to focus on exploration of the city photo being highlighted for a particular region, or on the entire region itself. In FIG. 15, the directions/options list 25 shows the option of further exploring the current cursor selection, which is the region of Liguria. Hitting the enter key to accept the “Explore Liguria Region” option, may cause the display of FIG. 16, where a map of the Liguria region is displayed, along with a list of cities therein. The directions/options list 25 may then permit the user to add individual cities to the itinerary, such as Ventimiglia, or Genoa, or one of the cities in Cinque Terre (meaning the five lands of Monterossa al Mare, Vernazza, Corniglia, Manarola, and Riomaggiore). The user may instead view a more detailed library of photos of each city, or may view descriptions of the sites that may be found at such city choices. Opting to add the city of Manarola to the current itinerary may result in the display of FIG. 17, with the associated Manarola photo being incorporated into the itinerary as a graphic reminder of the choice.

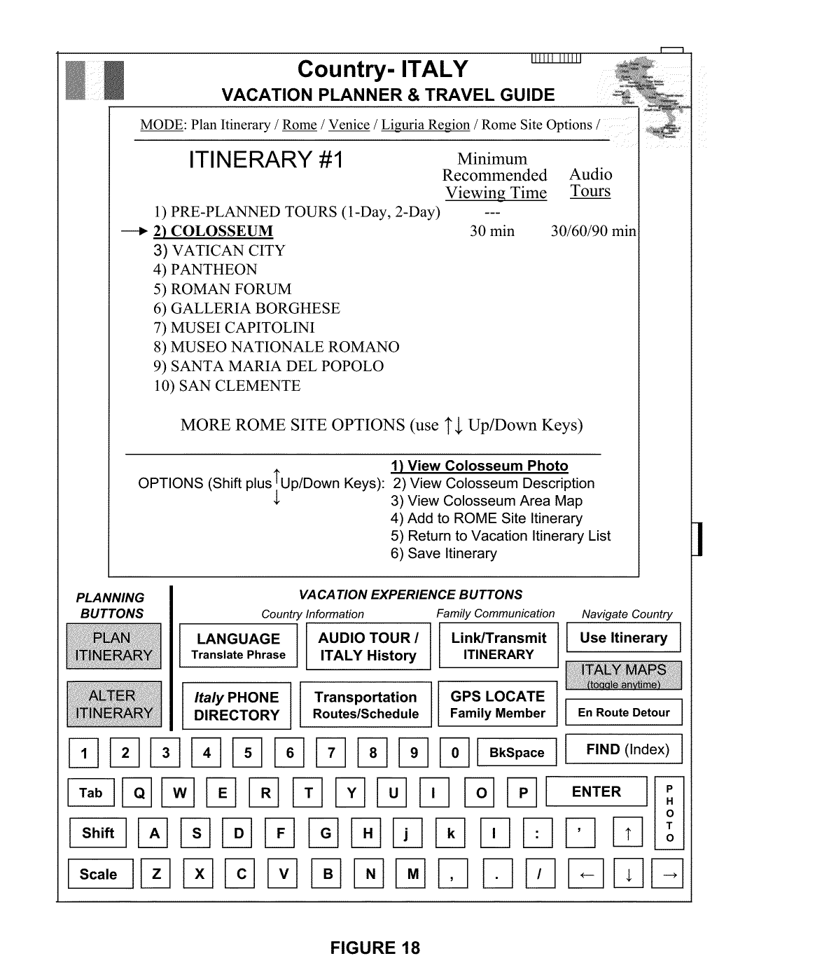

As seen in FIG. 17, the cursor, which may be in the form of an arrow symbol, may always default in successive screens to initially be pointing to and highlighting the first option shown in the screen. In FIG. 17, since the cursor is highlighting the city of Rome, the options are particularly directed to exploring options relating to Rome. But, as the cursor is toggled downward to Venice, and then Liguria, the options listed may be successively cross-referenced to the highlighted choice in the central information region 24, each of which may be at an earlier or later stage of planning than other legs in the itinerary. For example, if the cursor were toggled downward in FIG. 17, the options may instead offer to “View Venice Site Options,” or “View Liguria Site Options,” etc. With Rome highlighted, as in FIG. 17, hitting the enter key with “View Rome Site Options” being highlighted, may result in the display of FIG. 18. FIG. 18 shows one embodiment for the listing of sites to be visited for Rome. There may be an option-“Pre-planned Tours (1-Day, 2-Day . . . )”—that permits the user to choose from a professionally planned itinerary to tour Rome, and which has been optimized for the number of days the planner seeks to stay in the city. After that option, there may be a list of individual sites that may be selected by the user. The list may also preferably identify the minimum recommended viewing time for each site, to allow the user to determine the appropriate number of sites to select, according to how he chooses to tour the city, and although it is not shown therein, the list may also include a photo representative of each city on the list. If the software provides audio tours of the particular site, which will be discussed further hereinafter, it may also be preferable to display in that list, the running times for the audio tours that may be available, to further assist in selecting sites for a given day.

The list of sites that may be visited in a large city, such as Rome, may be quite extensive. As with the list of cities, the listing of sites may be ordered according to different preferences, such as a rank order according to popularity, or significance, or other categories. The directions/options list 25 may be tailored for the site highlighted, and may offer to display one or more site photos, a site description, a map of the area surrounding the site, as well as the option of adding the site to the itinerary for the city of Rome.

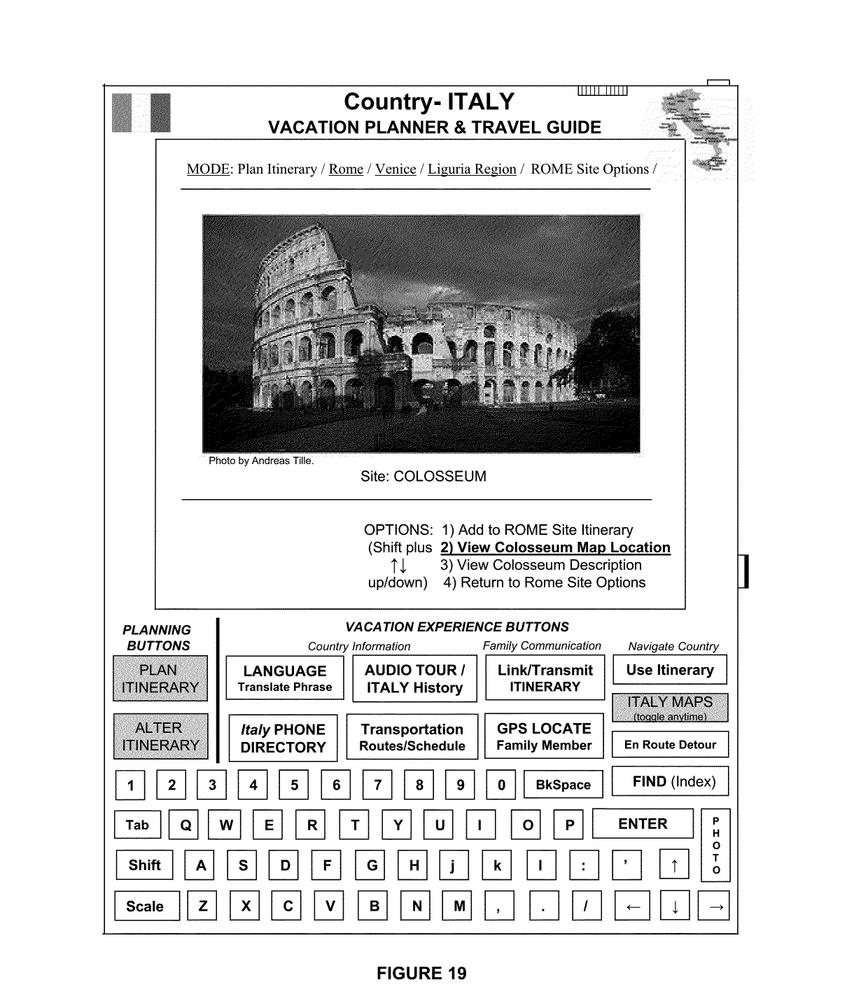

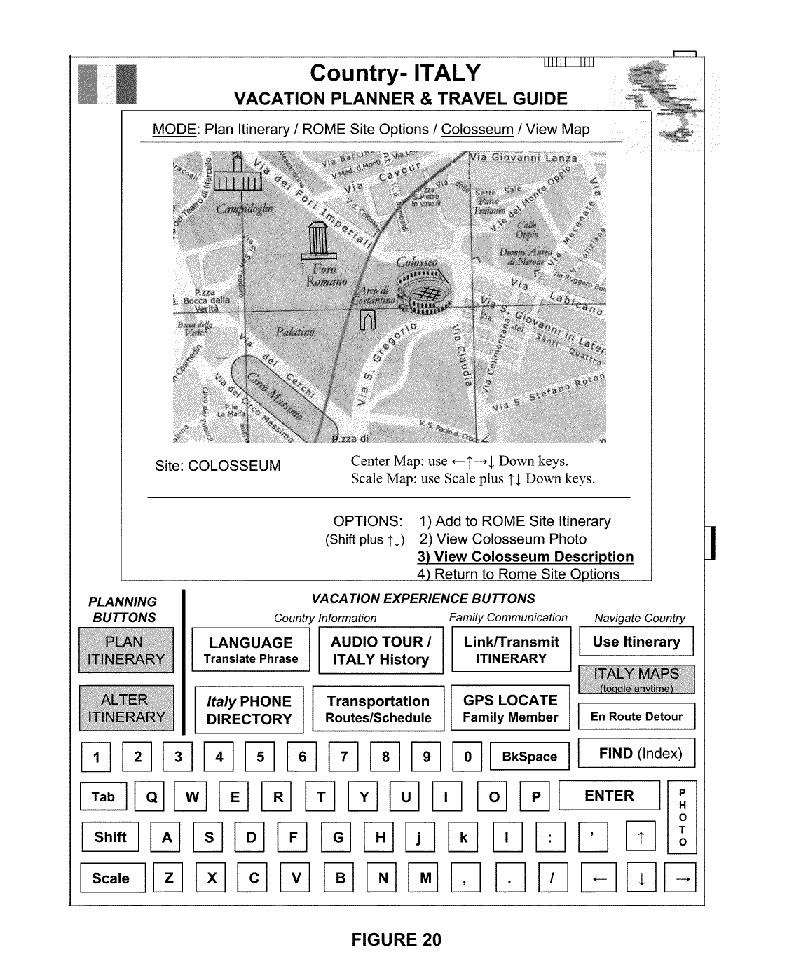

As an example, highlighting “Colosseum” and opting to view the site photo(s) for the Colosseum, may cause the display to appear as in FIG. 19. Some of the same pertinent options may appear in the display screen of FIG. 19, as had been previously offered in FIG. 18. There may still be options to add the site to the itinerary, if the photo makes the site appear desirable to the planner, or there may be an option to view a map showing the area around the Colosseum, or an option to view a description of the particular site. Selecting the “View Colosseum Map Location” option may cause the screen to appear as in FIG. 20, with a map showing the Colosseum centered in the screen, and with the surrounding streets also being depicted. The invention may include a series of maps specifically tailored for certain functions, or it may utilize a single, highly detailed Italy map that is scalable to aid the user. Scaling of the map may be by an algorithm, when prompted to do so, to cause the display to focus on certain features/locations, such as the Colosseum area in FIG. 20. The map returned by the software may be further scalable by the user through use of the scale button 47, in combination with the arrow up (↓) or the arrow down (↑) keys.

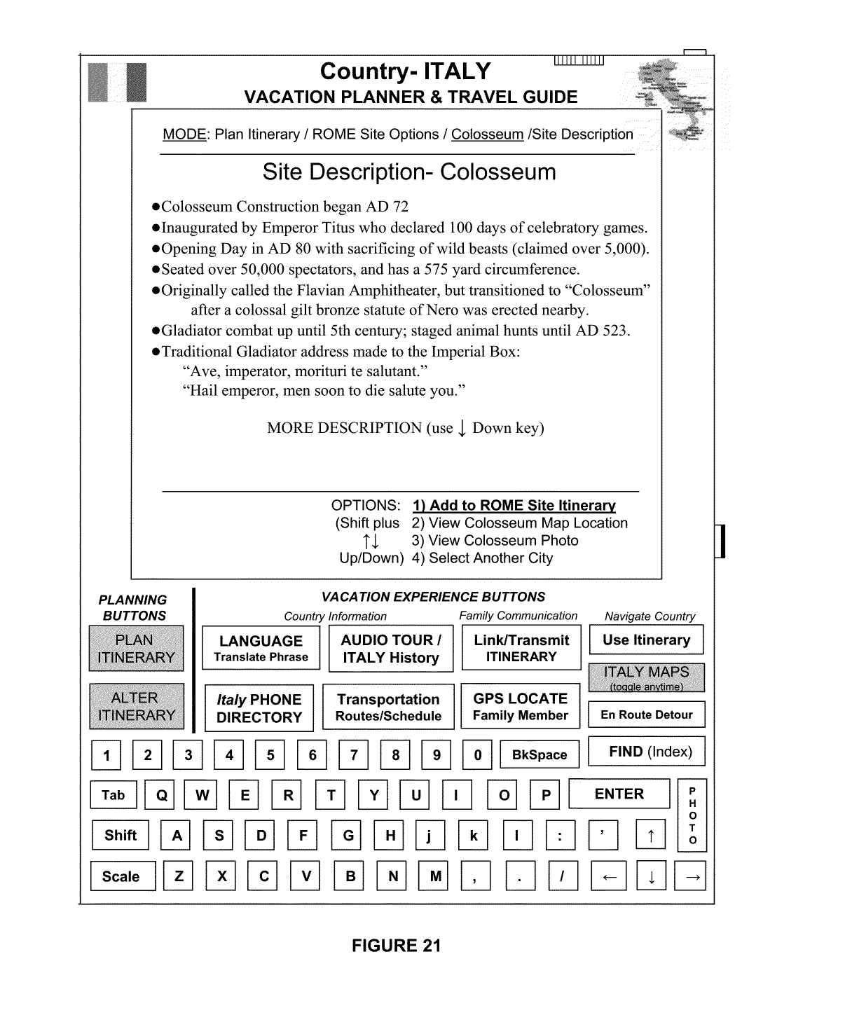

Selecting “View Site Description” from the options shown in FIG. 20, may cause the display of FIG. 21, which may comprise a textual narrative that may be in the form of a series of bullet points of factual information about the site, to help a user determine if he or she has sufficient interest to visit that site, The description may also be in the form of one or more paragraphs of information about the site. This description may also be useful to a planner who is trying to confirm that he or she has found a particular site that had been recommended by a third party. Once the user has decided to add the site to the itinerary, the “Add to ROME Site Itinerary” option may be toggled.

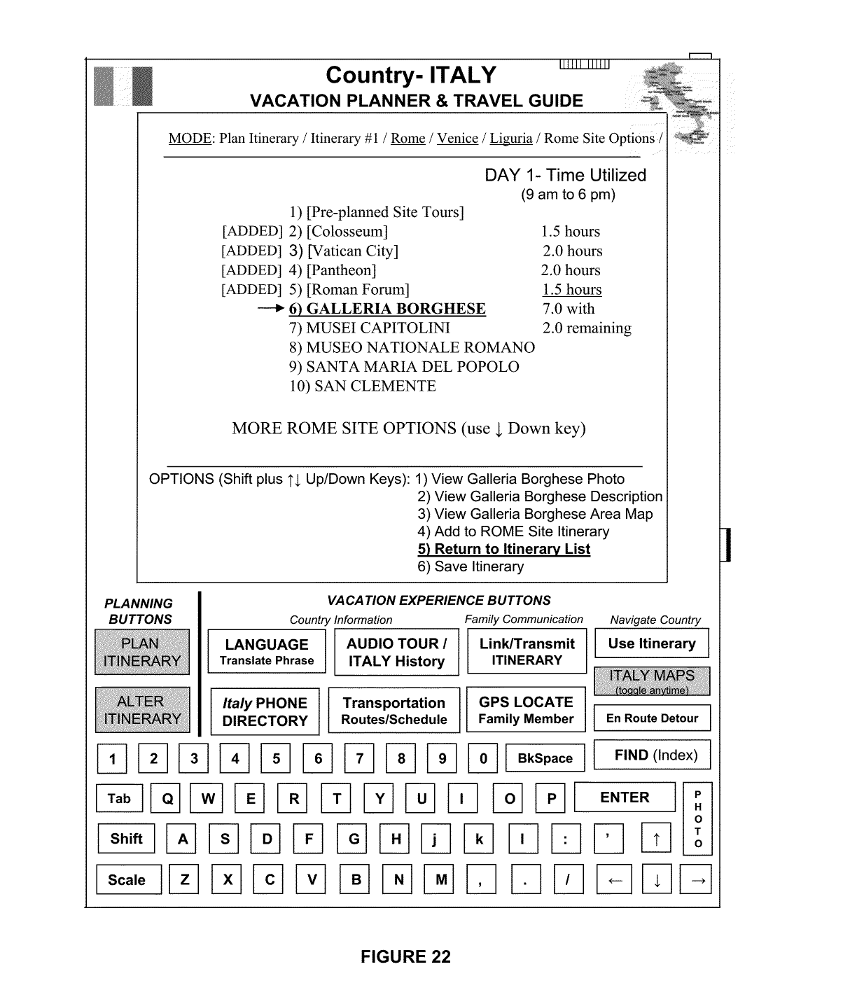

Successive selection, from the possible sites in Rome, to include the Colosseum, Vatican City, the Pantheon, and the Roman Forum, may cause the list to appear as in FIG. 22. Although not displayed in that figure, the software may provide a warning to a user when the list of selected sites selected may become too long to be comfortably visited in a single day, and might require continuation onto a successive day of touring, which may be based on recommended viewing times for the sites and travel times therebetween. The user may of course choose to ignore the suggestion, and not add a day to the itinerary at that point in the planning, and may instead utilize an option to add an extra day at a later stage of planning.

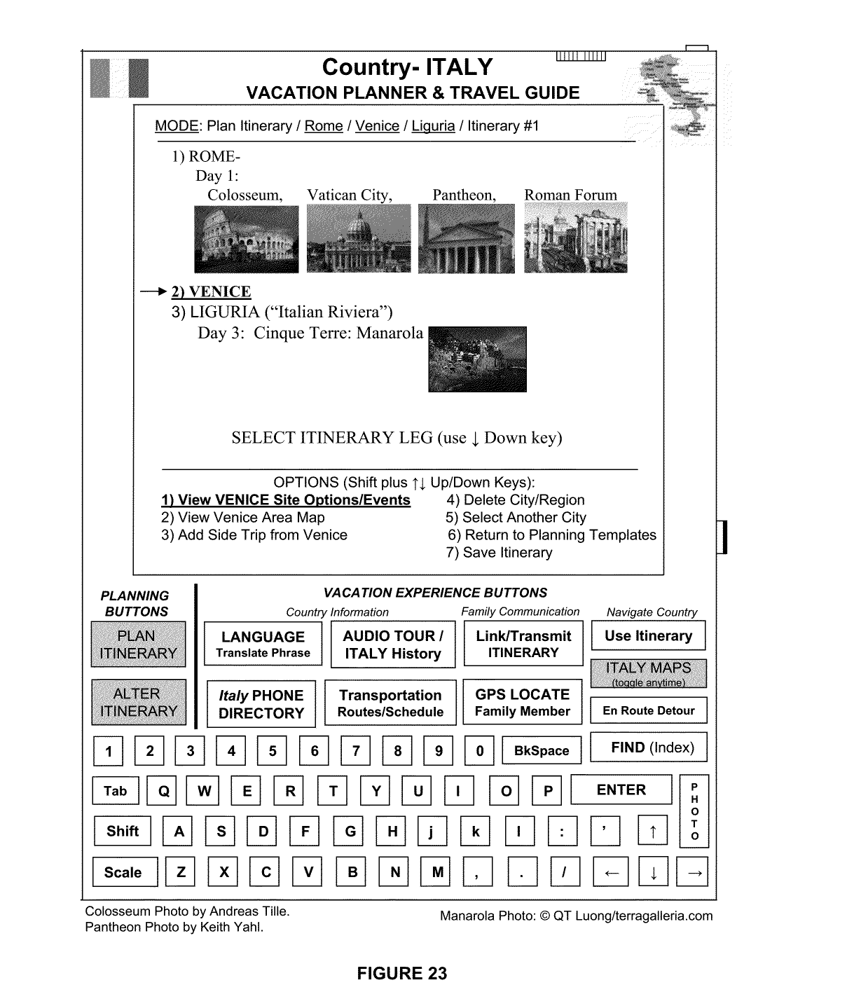

FIG. 22 does illustrate a recommended viewing time for each site selected, along with a total of 7 viewing hours used, out of what is suggested to be a nine hour viewing day—between 9:00 a.m. and 6:00 p.m. Where the software also includes listing the time of day for visiting a site, such times may be compared against known hours of operation for each site, to help preclude instances or erroneous planning, such as where a traveler plans to allot time to visit a site and some or all of the allotted time is before a site opens to the public or after it has been closed to visitors. Once the user has selected all of the sites for a particular city, the “Return to Itinerary List” option would cause the screen to appear as in FIG. 23, which is the same as FIG. 17, except for inclusion of the selected Rome sites and corresponding photographs. Selecting the “save itinerary” option at any point in time should not change the screen display, except perhaps to include a message, possibly a time-limited message flashing across the screen, to confirm that the itinerary was saved, or that it was updated after it has already been saved once.

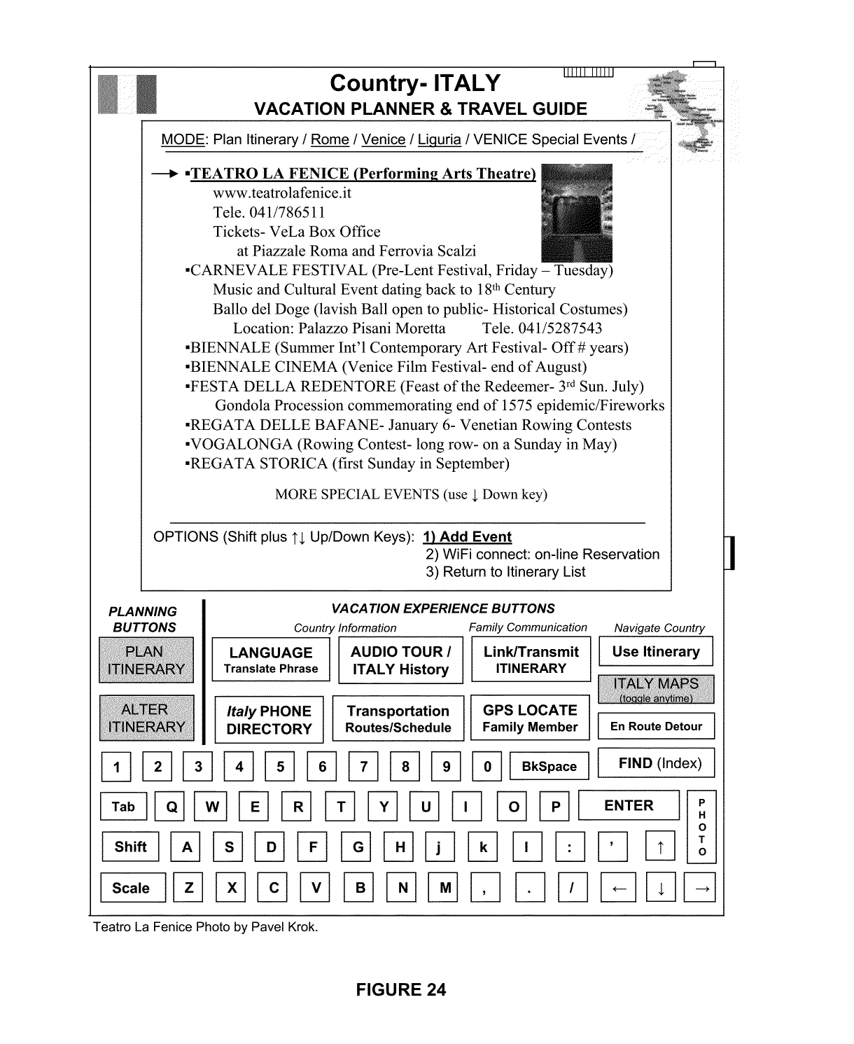

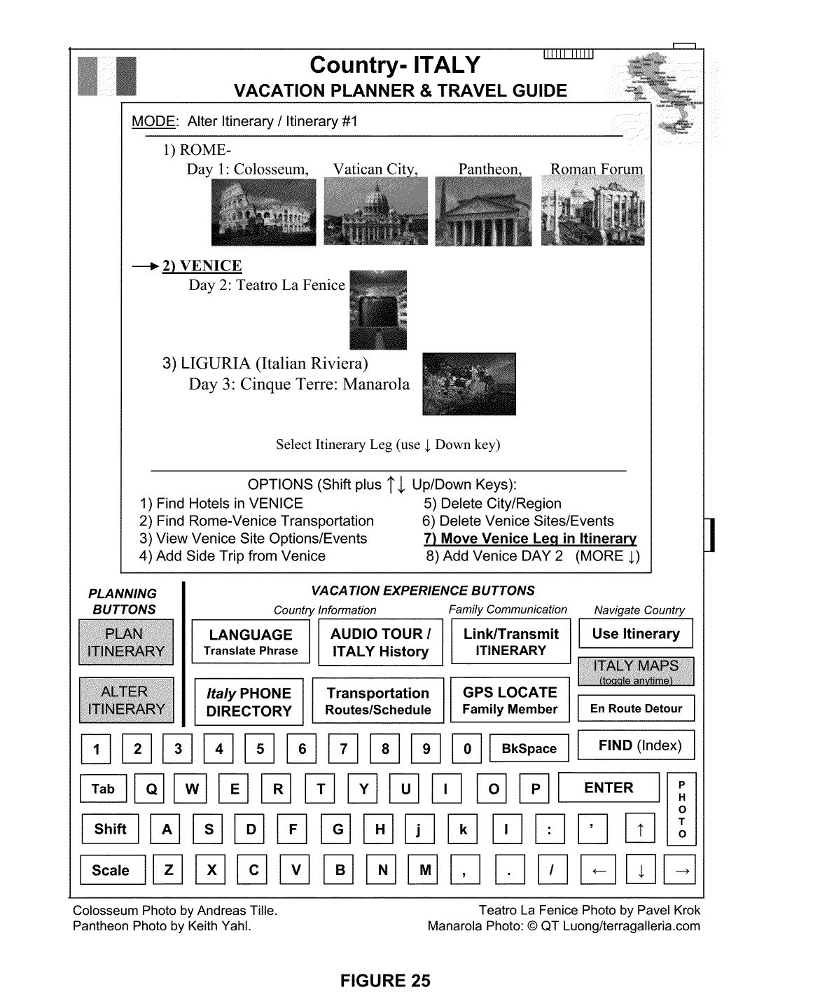

Many of the cities in Italy, as well as the cities in other nations, may host special events of interest to visitors, in addition to the usual tourist sites that may be in the form of historic structures or buildings or museums. These events may similarly be found, as for example with the city of Venice, under the “Find Venice Site Options/Events” option, as seen in FIG. 23. (Note that the city of Venice had been highlighted). Selection of that option may cause the joint display of both the sites and the special events for a city in a single list, or, in another embodiment, the software may be set up to present a separate list of sites and a separate list of events. A list of the events for the city of Venice may appear as in FIG. 24. Many of the events may occur only at a particular time of year, which may be so indicated. Where applicable, information for ticketing may be supplied, as for the Venice Performing Art Theater—Teatro La Fenice. The software may also, at such a point in the planning, supply an option to go online to find show schedules and ticket availability for a particular event. The “WiFi connect: on-line Reservation” option may be set up to automatically find the internet web page for the appropriate venue—Teatro La Fenice—which is www.teatrolafenice.it. Alternatively, the user may decide to merely add the event to the itinerary, and try to acquire tickets at a later time, possibly upon arriving in-country. Choosing to add Teatro La Fenice to the itinerary would result in the central information region 24 appearing as it does in FIG. 25.

A person planning a trip may decide at some later point in time to change the order of the itinerary, perhaps after acquiring airfare, and perhaps even once more thereafter because of other considerations, such as ticket availability at Teatro La Fenice. This re-ordering of the itinerary may be available once the itinerary planning has proceeded to a certain point, such as where there are two or more stops, and it may also be available at a later time after having completed the itinerary by using the “Alter itinerary” button 33, either of which may cause the displaying of the options shown in FIG. 25. These options allow for further planning and manipulation of the current itinerary. Note that use of the Alter Itinerary button 33 would first require selection of an itinerary to be modified from among a list of saved itineraries.

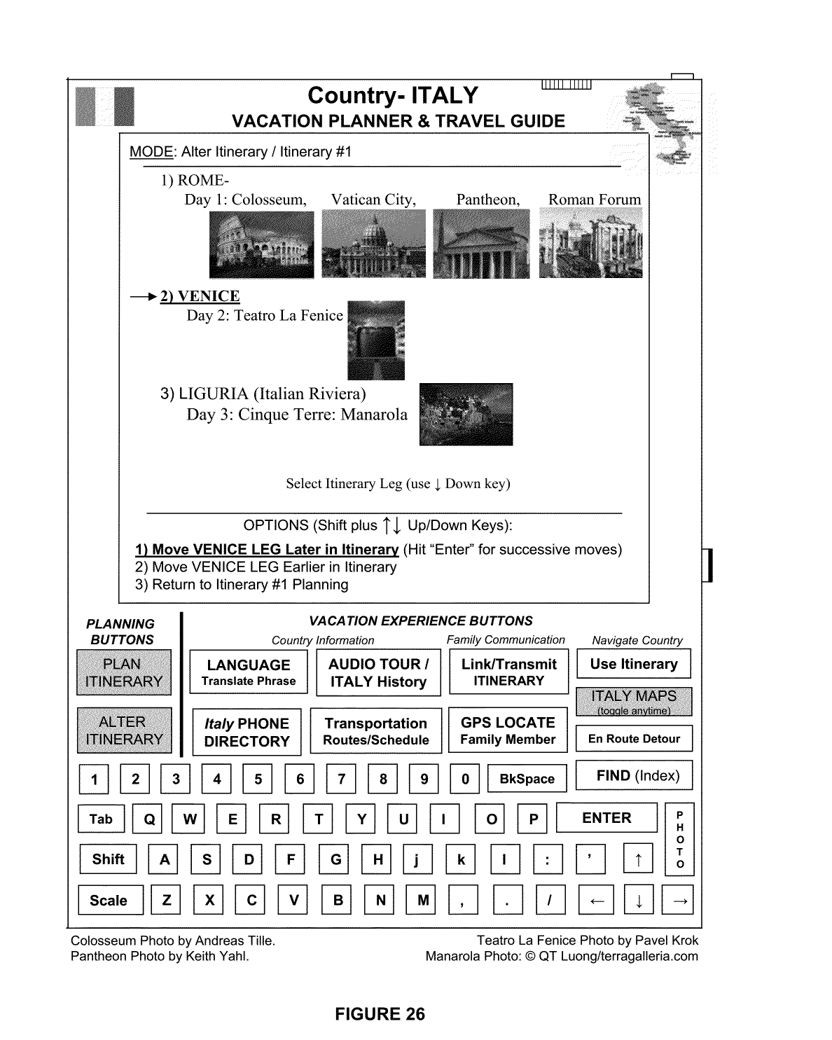

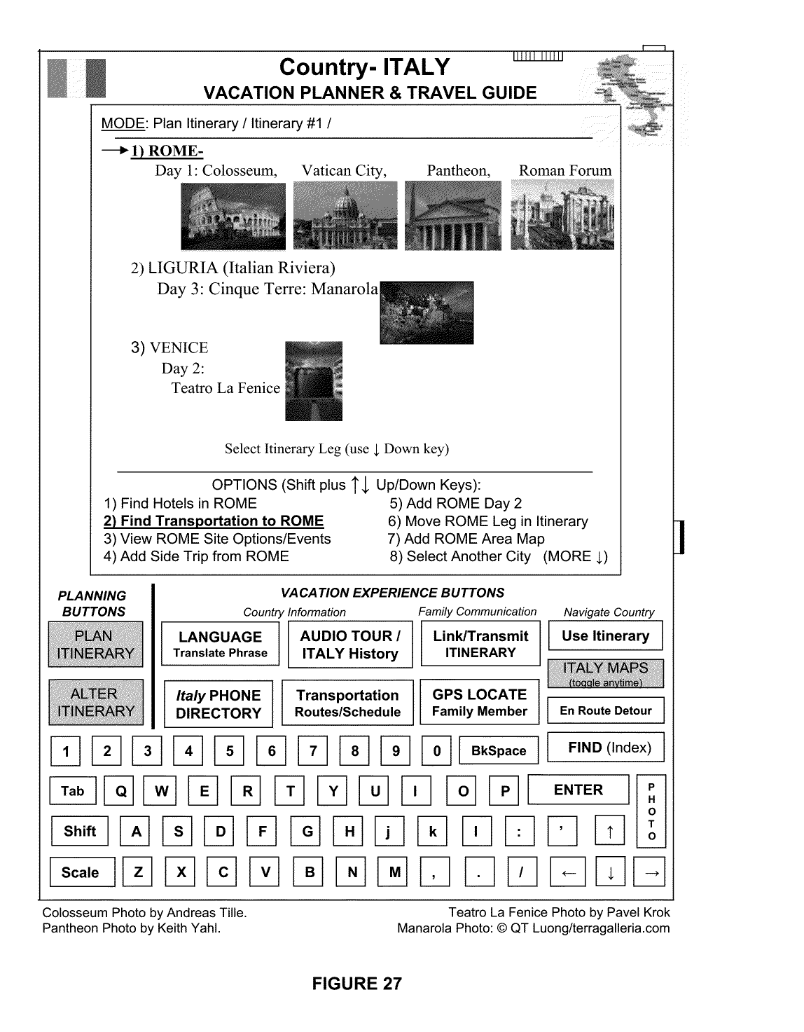

With the city of Venice being selected, the user may, among other things, delete certain of the site options already chosen for Venice, or delete the city of Venice entirely from the itinerary, or may rearrange the time in which it is to be visited relative to the other tour stops in the itinerary. Selection of “Move Venice Leg in Itinerary” results in the display of FIG. 26, in which two options permit rearrangement of the itinerary order—either allowing it to be moved earlier or moved later in the itinerary sequence. Selection of “Move Venice Leg Later in Itinerary” and hitting the enter button may move the Venice stop to occupy one slot subsequent in the itinerary list to where it had previously been. Successively pressing of the enter button may make additional moves farther back in the itinerary list. Pressing enter once would move the Venice leg to be last in the list, as seen in FIG. 27.

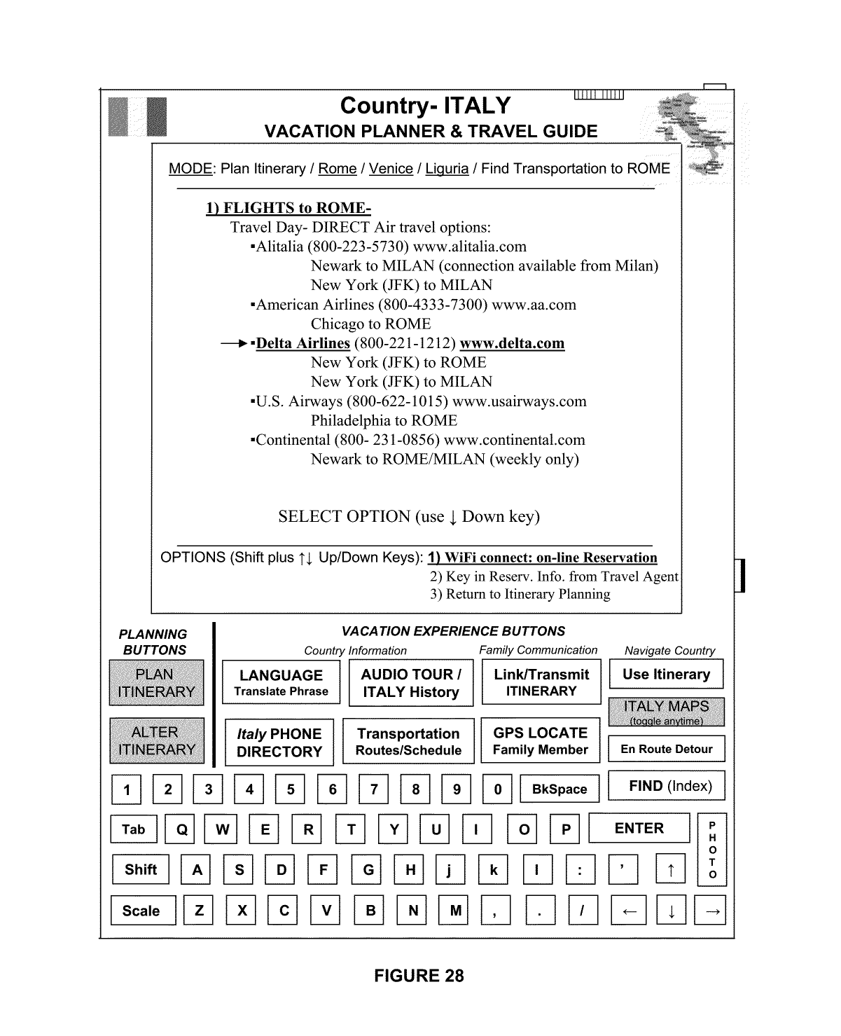

A user may consider the three-stop trip to Italy, including Rome, Liguria (Manarola) and Venice, to be a complete itinerary, at least as far as city/regional choices are concerned, and may prefer to check on airfare availability before customizing the itinerary any further. The highlighting of Rome, and selecting of the “Find Transportation to Rome” option, because it is the first leg of the itinerary, may cause the display of FIG. 28, in which airlines known to fly into Italy will be listed, along with respective information needed for making reservations with one of the carriers. The list may preferably note the cities in Italy which that airline flies into, as well as the U.S. departure city or cities. A person living in New York may choose to highlight Delta Airlines, since Delta flies direct from New York to Rome, and between N.Y. and Milan as well, which would be convenient for the return leg, as Milan is close to the currently planned final tour stop in Venice. A diligent user may thus be able to plan the entire itinerary without the assistance of a travel agent, but certainly, a person could simply employ a travel agent make the reservation, and thereafter the person could plan the itinerary to stay within the bounds of the arrival and departure times/dates.

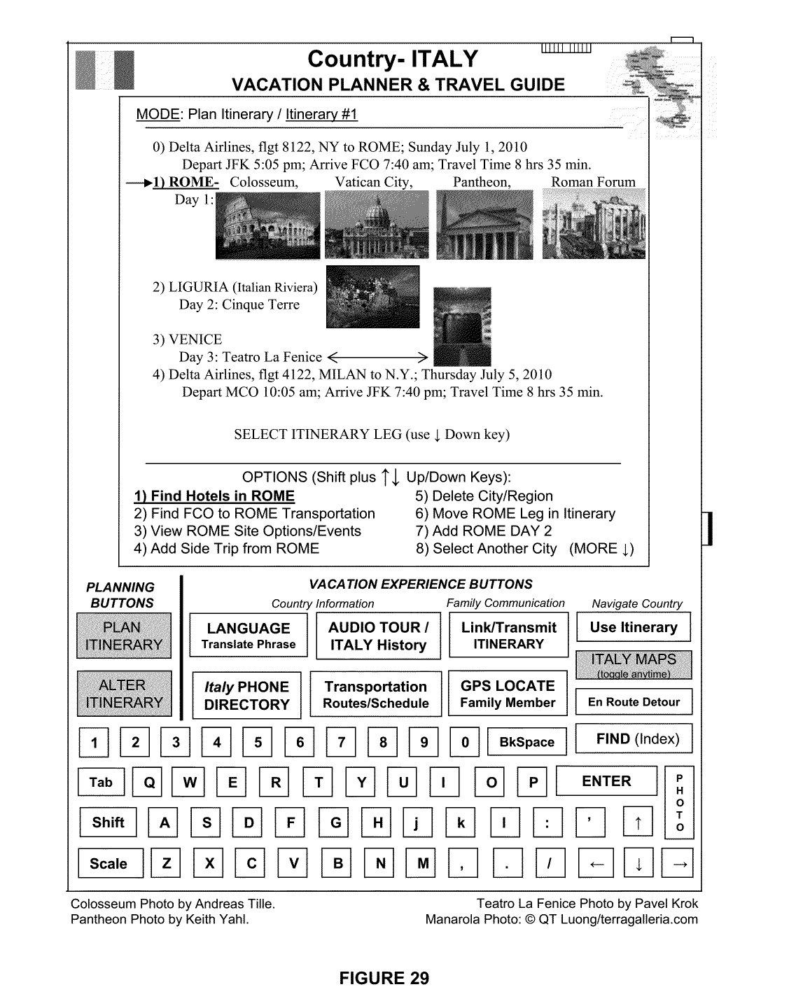

Selecting the “Wi-Fi Connect: On-line Reservation” option in FIG. 28 may allow the user to access the Delta Airlines web page in a separate screen, and make a reservation to depart on Delta's flight 8122 on Jul. 1, 2010 from JFK Airport at 5:05 pm, to arrive at FCO Airport in Rome at 7:45 a.m. on the morning of July 2. The flight is 8 hours and 35 minutes, and most people sleep on such trans-European flights so that upon arrival, they begin their touring. This would permit the three itinerary days in Rome, Liguria, and Venice, respectively, to occur on the 2^{nd}, 3^{rd}, and 4^{th} of July, with a departure on July 5, from Milan, on Delta Flight 4122 that leaves Milan's MCO Airport at 10:05 and arrives at JFK in N.Y. at 7:40 p.m. All of this flight information, when obtained as described, may automatically appear in the itinerary sequence as shown in FIG. 29. If a reservation is obtained from a travel agent or by the user calling the airlines directly, the information for that reservation may also be entered into the itinerary, for quick and convenient future reference by the traveler to alleviate the need to carry a paper airline ticket. The information may be entered manually using the “Key in Reserv. Info. from Travel Agent” option in FIG. 28.

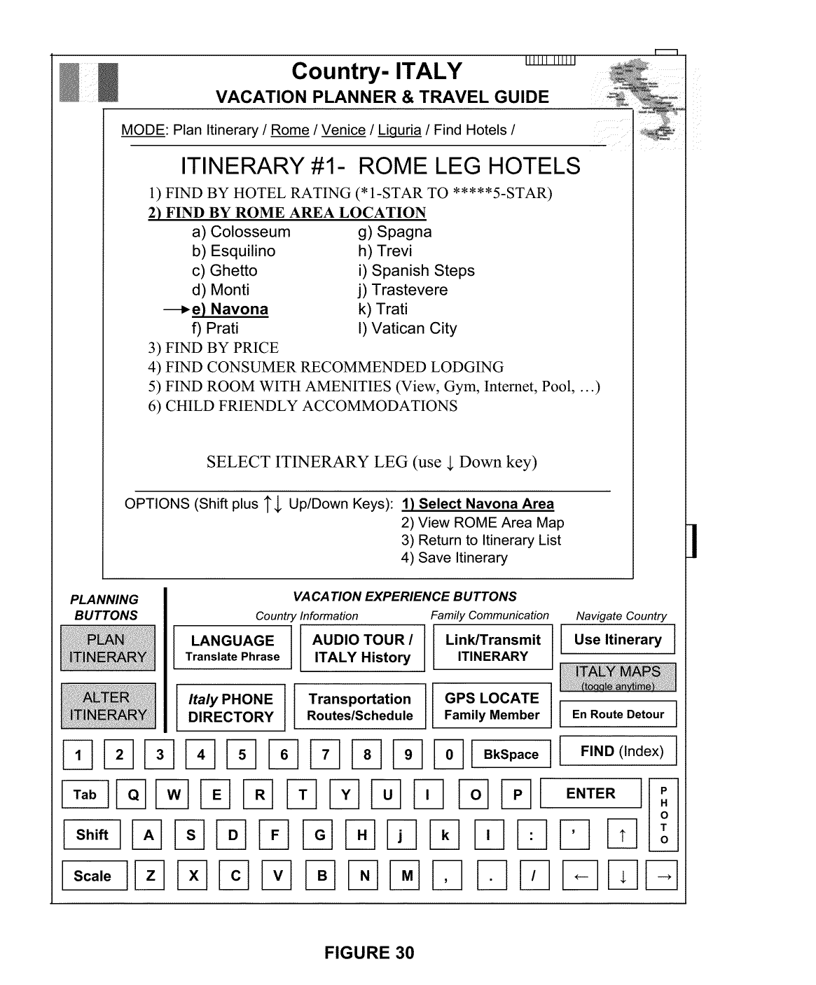

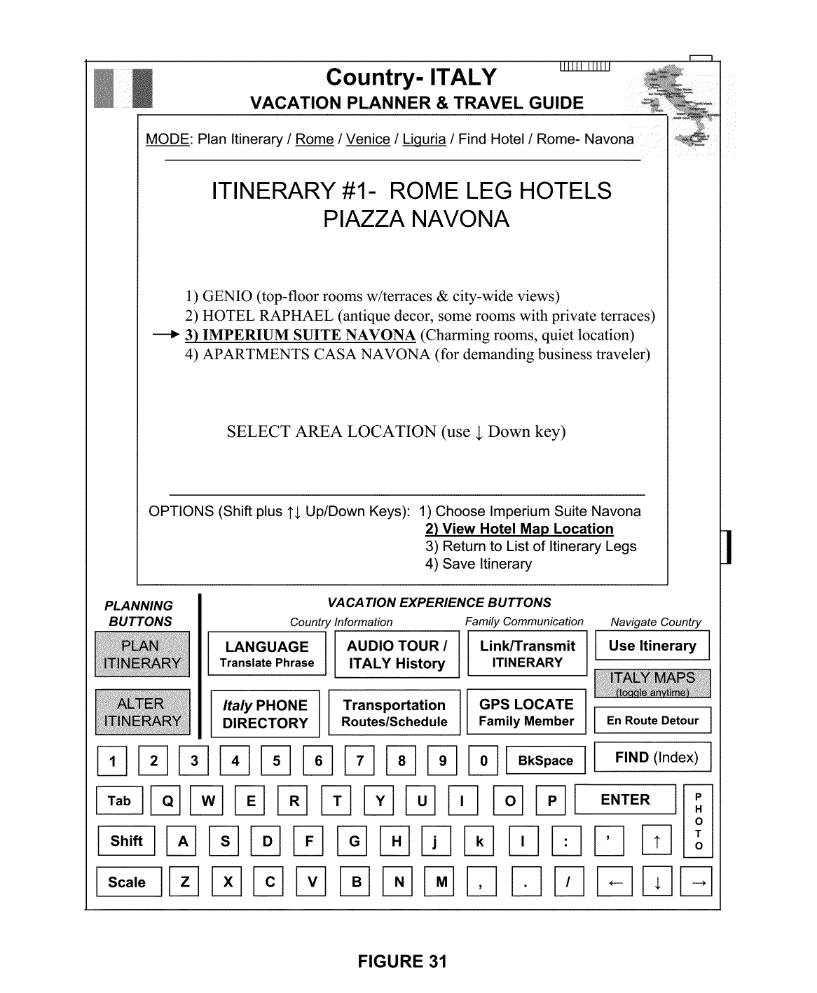

In FIG. 29, with the city of Rome being highlighted, selection of the “Find Hotels in Rome” option may cause the display of FIG. 30, which presents possible options for finding lodging in Rome according to certain attributes. Such attributes may include hotels listed according to standardized hotel ratings, or by hotel location, hotel price, by consumer recommendation, by particular amenities, or by being known as a child friendly establishment, etc. Naturally, this is a non-exhaustive list of the possible templates for choosing a hotel. If the user decided to search for a Rome hotel by location, because of a desire to be lodged near ancient Rome, tabbing down to highlight the “Find by Rome Area Location” choice may reveal choices according to the distinct areas of Rome, such as the Colosseum, Monti, Navona, etc. Tabbing down further to highlight and select the Navona area, would cause the algorithm to search the database of travel information for hotels in the Navona area of Rome, and cause the display as seen in FIG. 31.

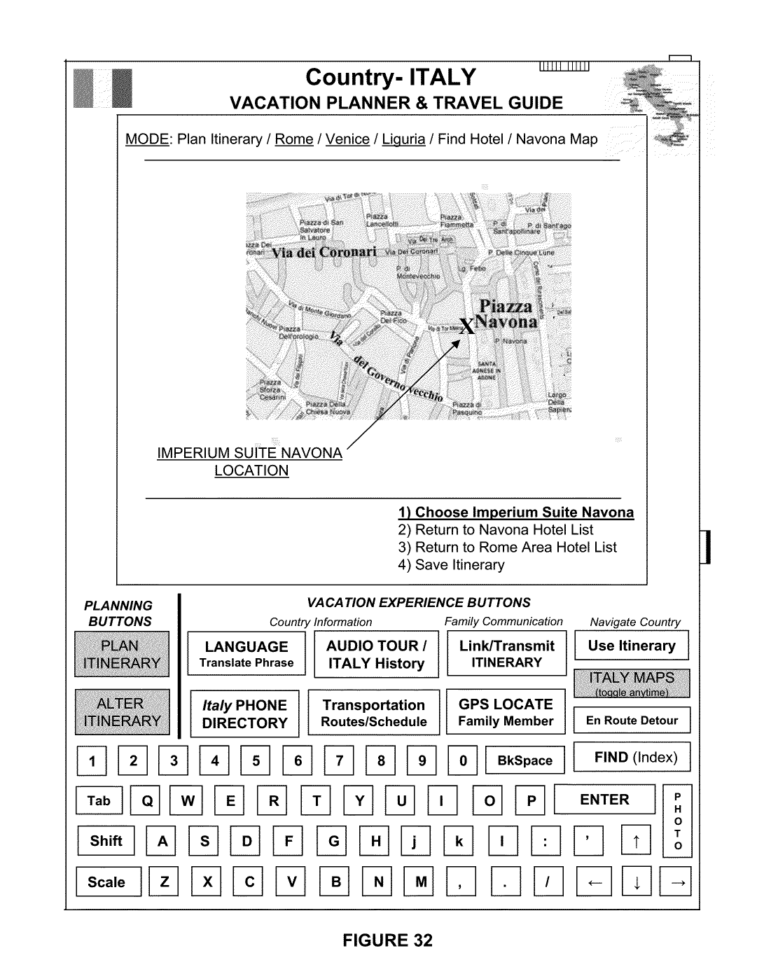

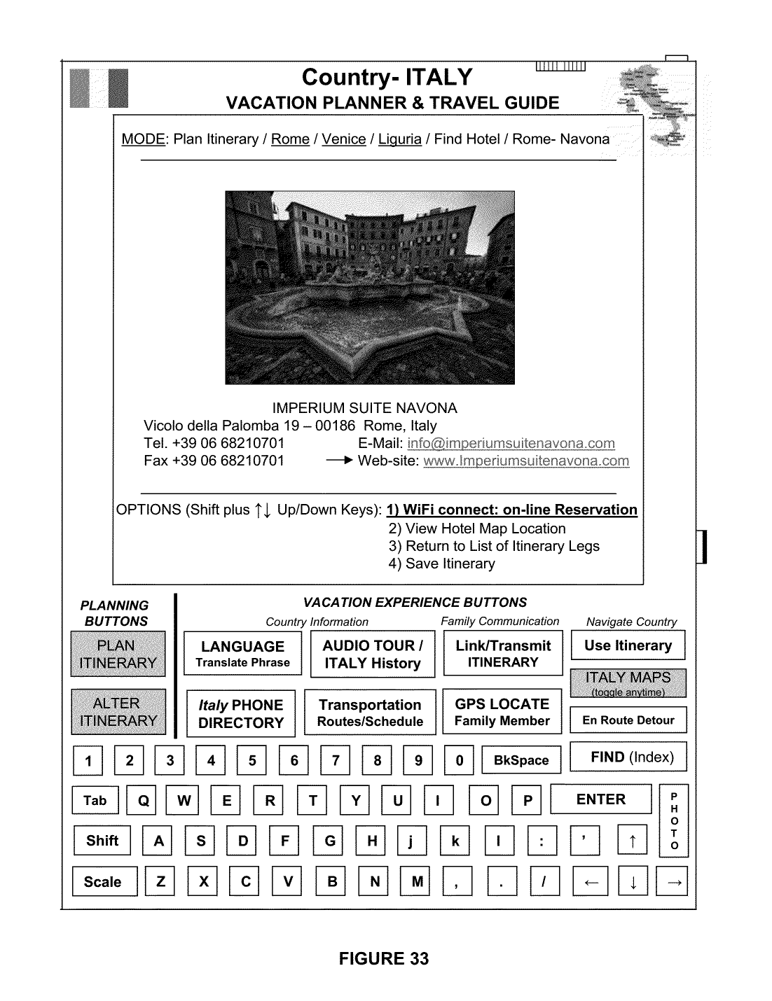

The list could be great or small, and could grow as hotels, motels, and bed and breakfast inns sought to gain exposure by being listed therein. Each of the listed lodging choices may preferably include a description of the hotel's features and character. Highlighting of the Imperium Suite Navona as the hotel choice may be accompanied by options to select the accommodation or to see its location on a map. Choosing the “View Hotel Map Location” may cause the display of FIG. 32, which shows a map of the Navona area, along with indication thereon of the location of the Imperium Suite Navona. Selecting the “Choose Imperium Suite Navona” option may cause the display of FIG. 33, which includes a picture of the selected hotel, and relevant information to obtain a reservation at that hotel.

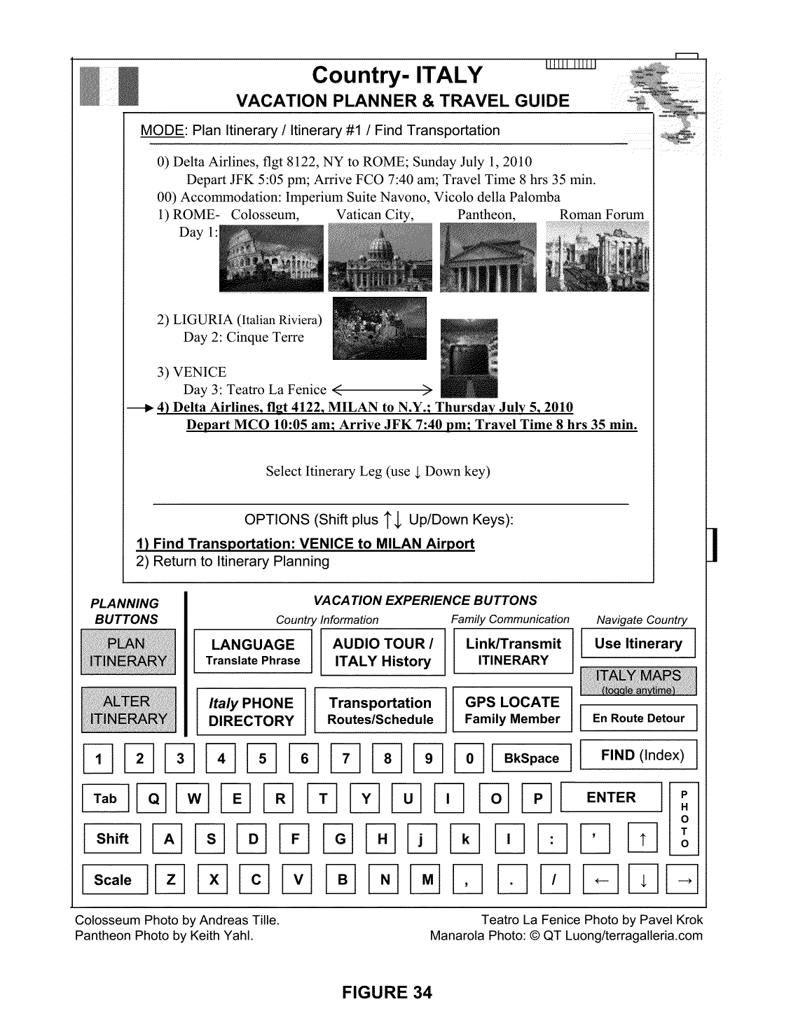

As with other reservation-specific steps of the itinerary planning within the device, an option may be provided to directly access the hotel's web-page to try to obtain a reservation corresponding to the first day in Rome—Jul. 2, 2010. Selection of the “Wi-fi Connect: Online Reservation” option may permit the user to access the Imperium Suite Navona web page to make the reservation, the information for which may also appear in the itinerary list, as shown in FIG. 34. It may be preferable to display all or only some of the reservation information in the itinerary list, and the user may be able to establish those display requirements in a preference settings screen. It may also be preferable to show the airline arrival information and initial accommodation information in a numbering sequence beginning with zero (“0”) and double-zero (“00”) so that each number for the listing of stops also corresponds to the itinerary day. Lastly, selection of the “Find Hotels in Rome” option may additionally or alternatively present the option of using an existing hotel reservation site to search for lodging, such as www.italytraveler.com.

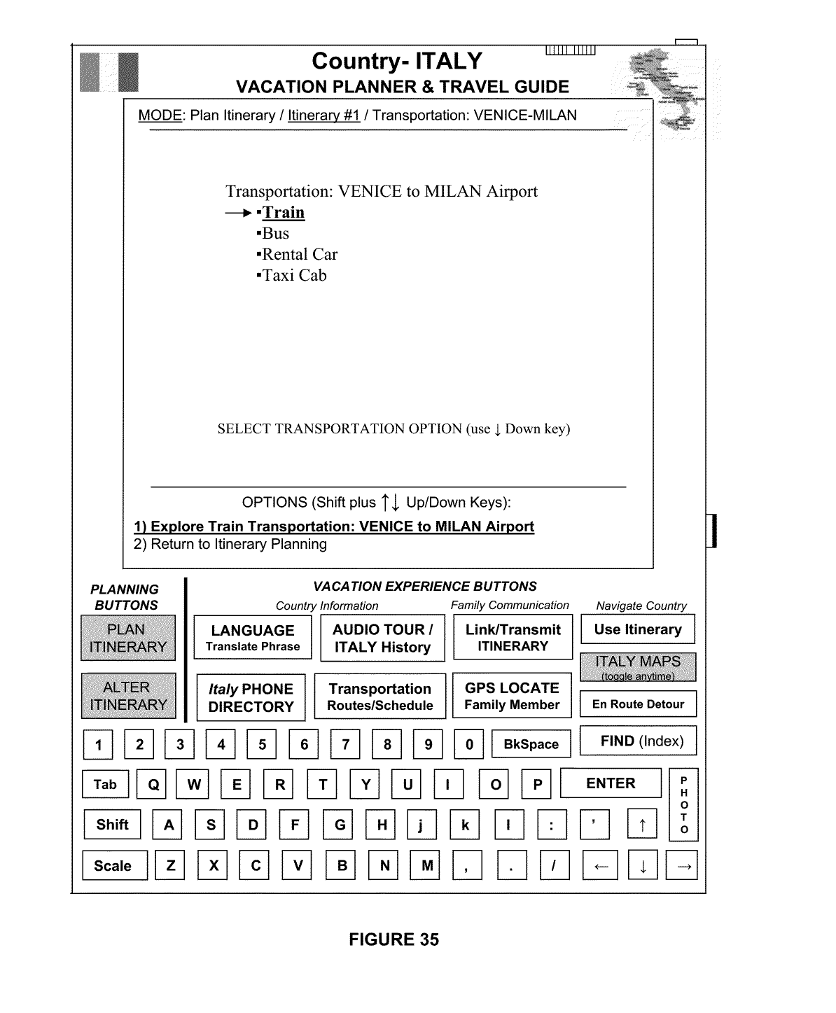

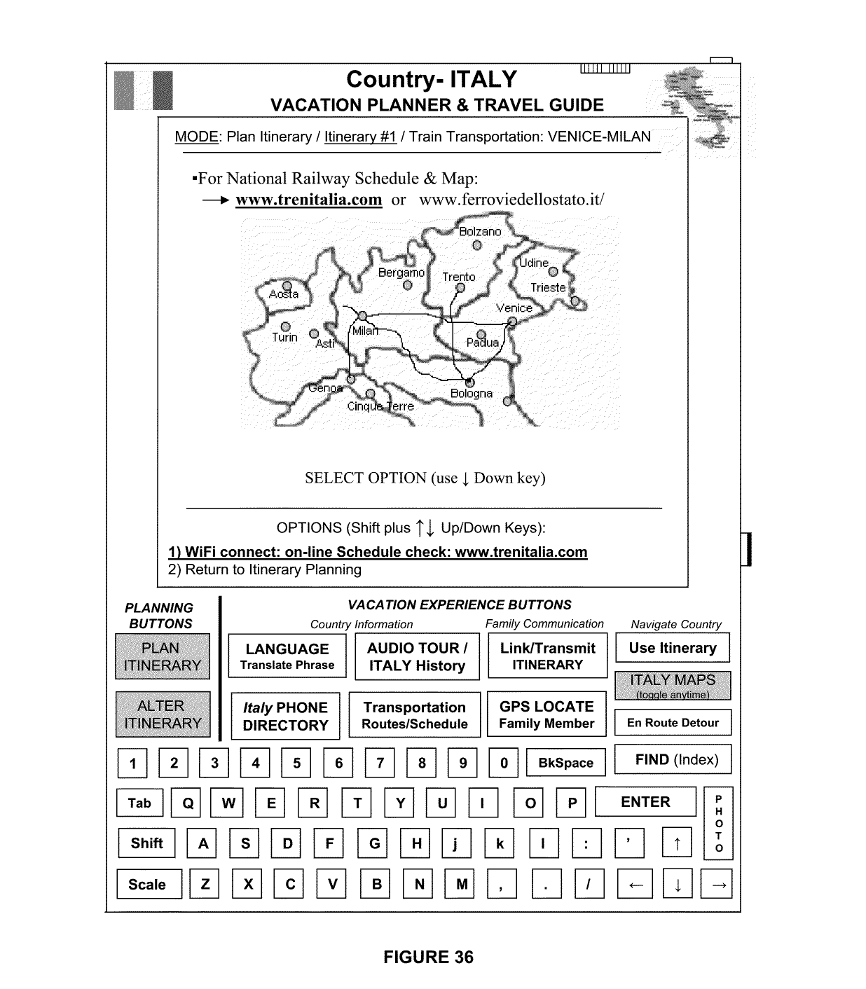

Tabbing down in the itinerary list of FIG. 34, to each of the other stops may similarly permit selection of transportation to that stop, but transportation may also be chosen at a later date, even when in Italy, using an itinerary planning option that will be discussed later. However, arranging transportation for the arrival and departure dates may be critical for most people, and tabbing down to the departure flight from Milan, in FIG. 34, may trigger the appearance of the “Find Transportation: Venice to Milan Airport” option. Selection of that option may cause the display of possible transportation options on the screen in FIG. 35, which include, but not be limited to, transportation by train, bus, rental car, and taxi cab. In certain cases, there may also be an option to catch a connecting flight between cities. If a traveler had initially chosen to rent a car in Rome, then this step may not be necessary. However, to be exemplary, the user may have taken public transportation throughout the trip, and may therefore choose here to highlight the “Train” choice, and select the “Explore Train Transportation: Venice to Milan Airport” option, which would cause display of the national railway map and related information shown in FIG. 36. There are two Italian web-sites shown (www.trenitalia.com and www.ferroviedellostato.it/), with each being translatable into English for obtaining schedules and tickets for travel on the Italian national railway system. As with other reservation-specific steps of the current invention, the reservation information thereby obtained may be displayed in the itinerary list.

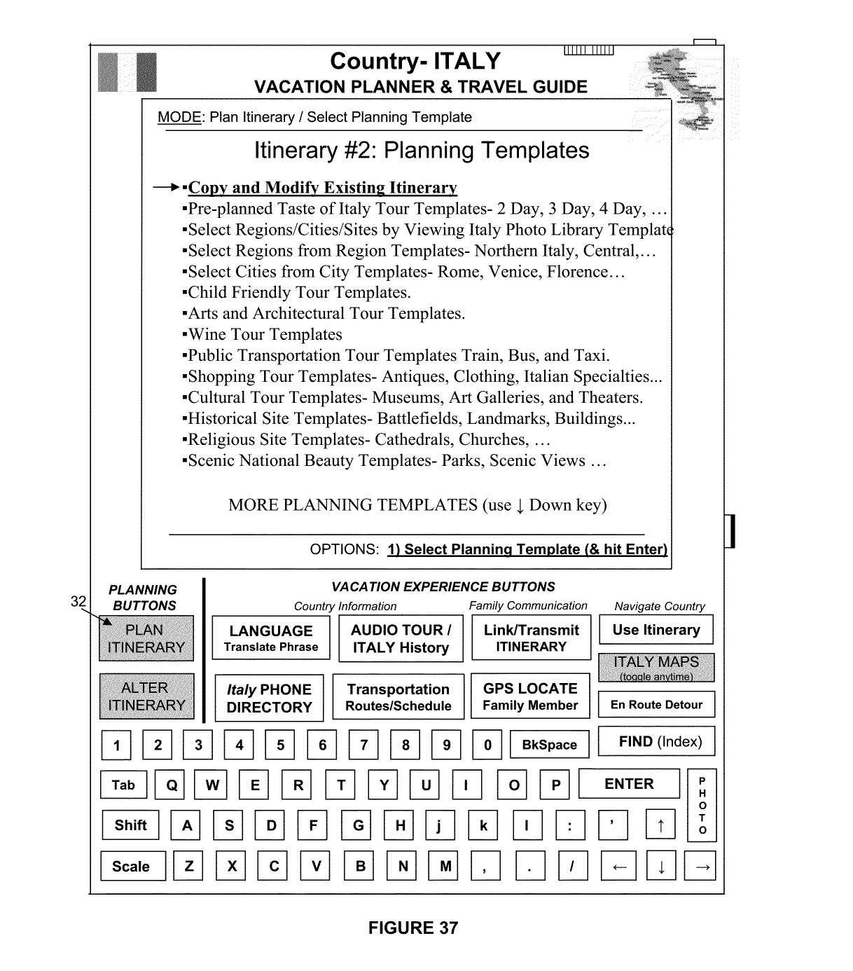

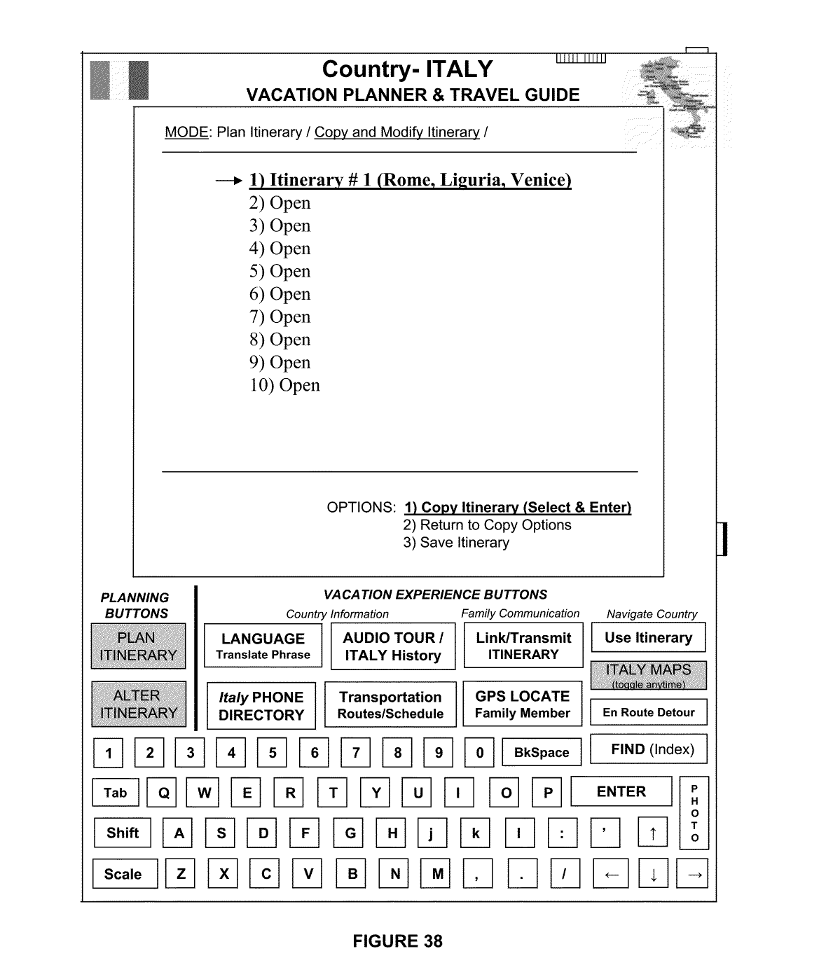

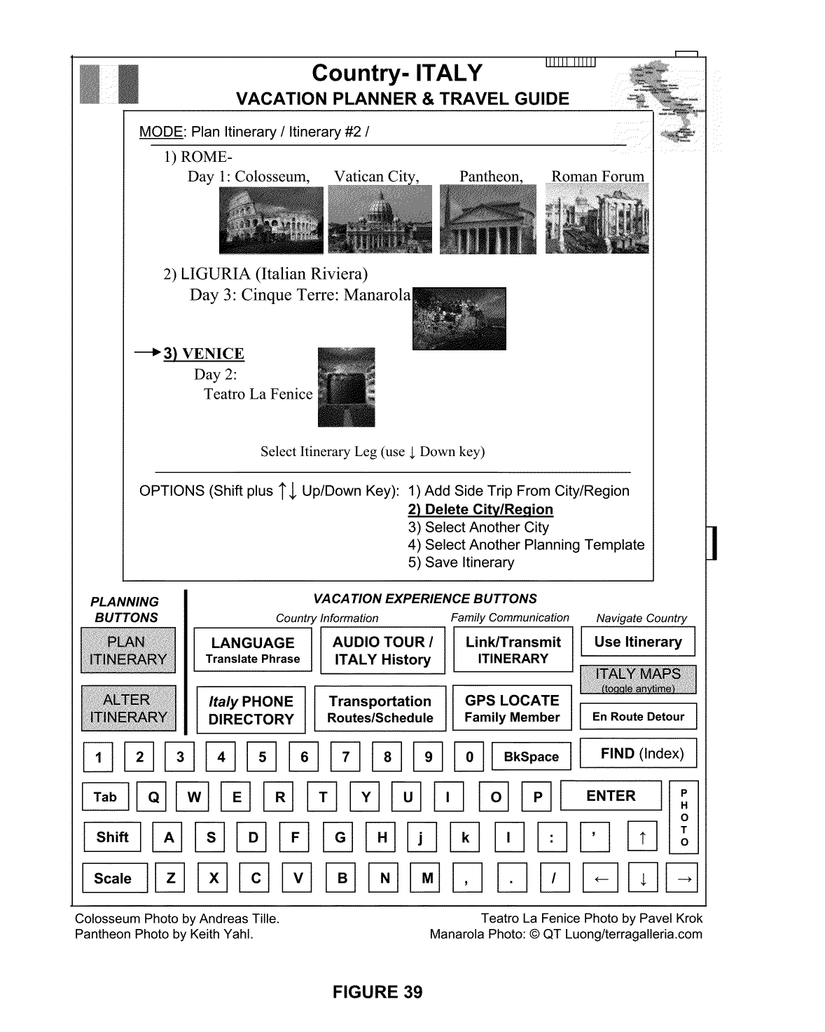

Once Itinerary #1 has been saved, later toggling of the Plan Itinerary button 32, may cause the display of the screen in FIG. 37, which closely resembles the screen of FIG. 2, except that the first option now shown permits the user to clone and modify a saved itinerary. This may be beneficial for a user who is uncertain about some of their choices, and may desire to plan alternate itineraries, or may wish to anticipate both good and bad weather upon arrival with corresponding itineraries, or may want to be prepared for the possibility that they will be in-country for more time than anticipated—particularly for a business traveler—and prefers to already have that extra time carefully planned and utilized. The traveler many want to have alternate itineraries prepared for many other possible reasons. Highlighting “Copy and Modify Existing Itinerary” and selecting that option produces the screen shown in FIG. 38, which is a list of all saved itineraries. Highlighting Itinerary #1 (Rome, Liguria, Venice), which currently is the only saved itinerary, and selecting the “Copy Itinerary” option, may create an Itinerary #2 exactly the same as Itinerary #1, however, as seen in FIG. 39, it may be without the airline reservation or other specially reserved/ticketed events or accommodations.

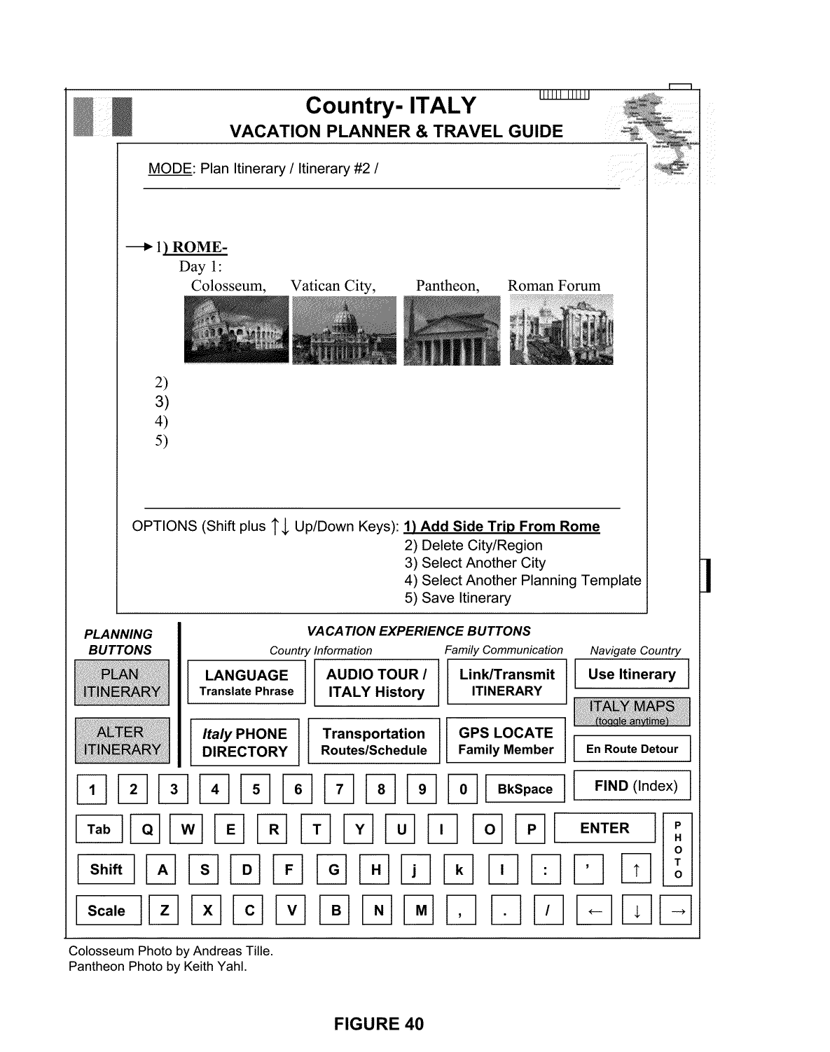

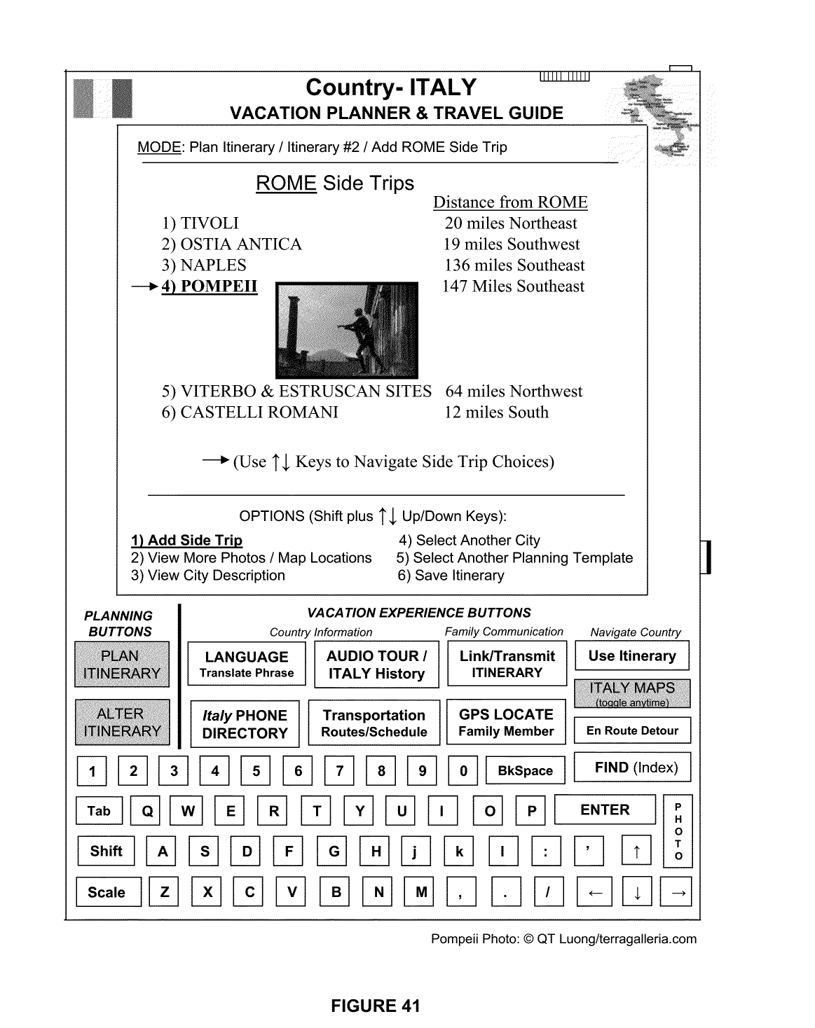

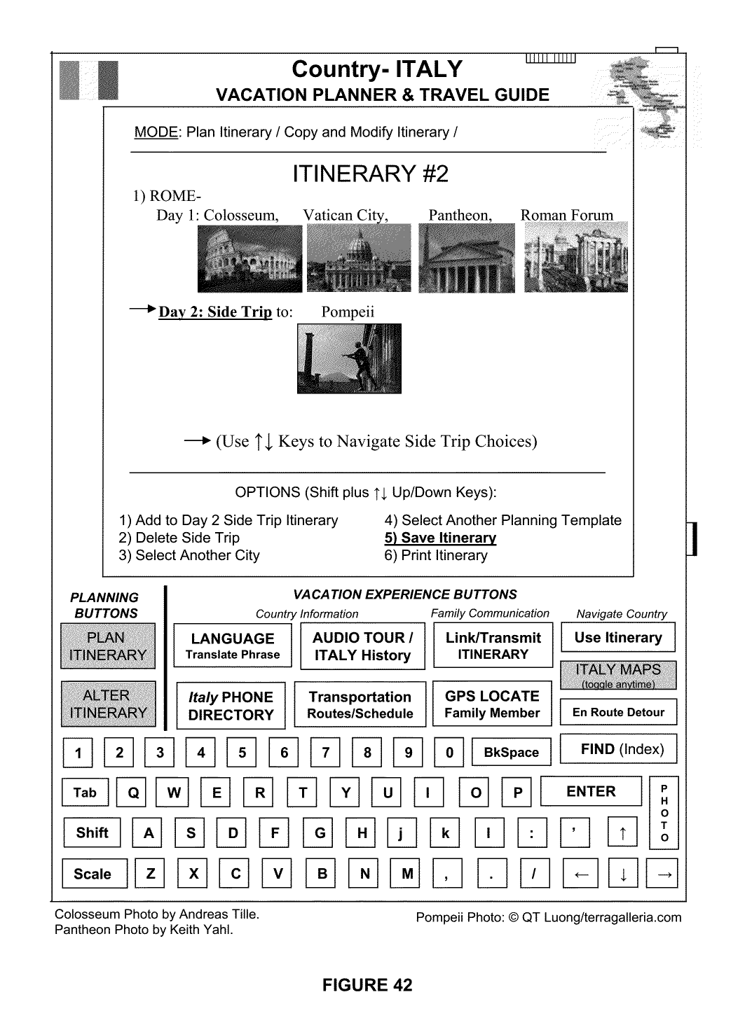

The user may wish to create an itinerary solely for another, more comprehensive visit to Rome, and thus may highlight the Venice leg, and select the “Delete City/Region” option, to remove the Venice leg of the itinerary. The same may be done for the Liguria leg to result in the itinerary list of FIG. 40. A more comprehensive trip to Rome may include more site visits within the city of Rome itself, but may also include visits to sites that are nearby, but outside of Rome itself. With Rome being highlighted, selection of the “Add Side Trip from Rome” option may cause the display of FIG. 41, in which sites that are proximate to Rome may be listed, and may preferably be listed according to their distance from Rome, with inclusion of such distances within the listing. Highlighting of the city of Pompeii may cause a representative photograph to appear. The user may elect to receive more information about Pompeii—photos, maps, or a description—or may simply decide to select the “Add Side Trip” option, resulting in the itinerary list of FIG. 42, which may then be saved for later use. In addition, there may be an option to print out a copy of the saved itinerary. The printed copy of the itinerary may serve as a back-up in case a traveler's portable computing device, running the software herein, is damaged, stolen, or lost during the trip. The printed copy may also be conveniently given to family members not traveling abroad, to allow them to track the travelers' progress and the expected return date/time.

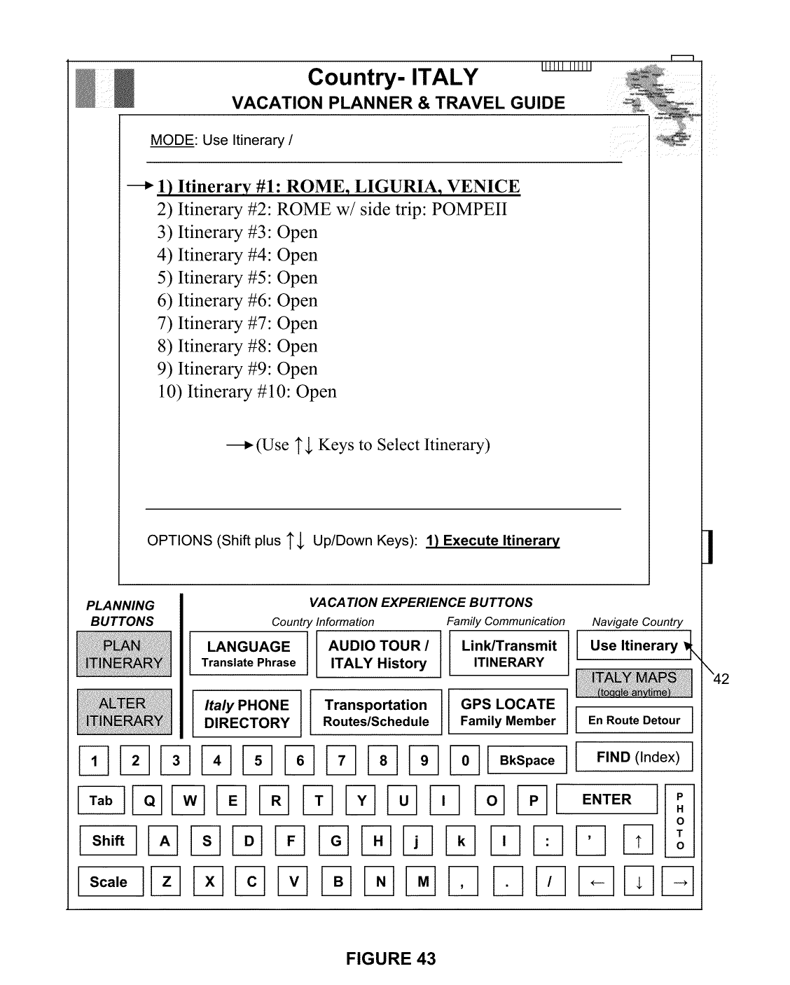

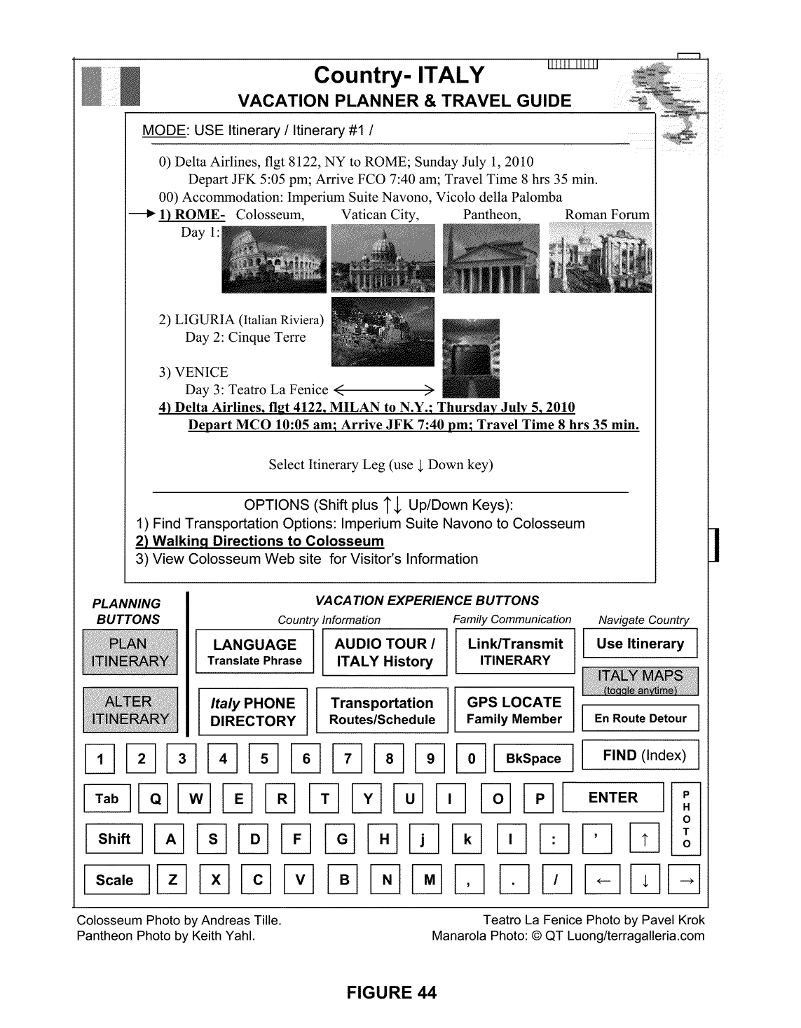

Once arriving at the destination, the user may power up the device, and select the Use Itinerary button 42, as seen in FIG. 43, which may cause the display of all saved itineraries to permit selection therefrom. Presuming that the three-day Itinerary #1 with the airline reservations was the intended itinerary for use on the trip, the user would highlight Itinerary #1, and select the “Execute Itinerary” option. This would cause the itinerary to be displayed, as in FIG. 44, the same as it had finally appeared in FIG. 34, but with a different options/directions list 25 being offered. In one embodiment, the itinerary could be customized to include times of the day at which the traveler may spend viewing particular stops, and the system may also provide alarm prompts to give the traveler notice of when one site visit is to end, and movement towards another site is to begin.

As seen in FIG. 44, an option may be offered to find transportation to an itinerary leg, once a leg is highlighted, and it may also offer to give walking directions or other guidance to a site. The directions may be a rote recitation of steps necessary to progress from place to place, or it may alternatively comprise active guidance through the use of a GPS receiver. A GPS receiver may be attached to the device using a cable, or may preferably be integrally included in a specially designed mobile device running the software of this invention.

Another option may be to offer access to internet web-sites for the Rome sites to be visited, to assist in providing current information to the traveler. There are many possible forms of further assistance that may be provided to the traveler, some of which will be discussed in the following sections.

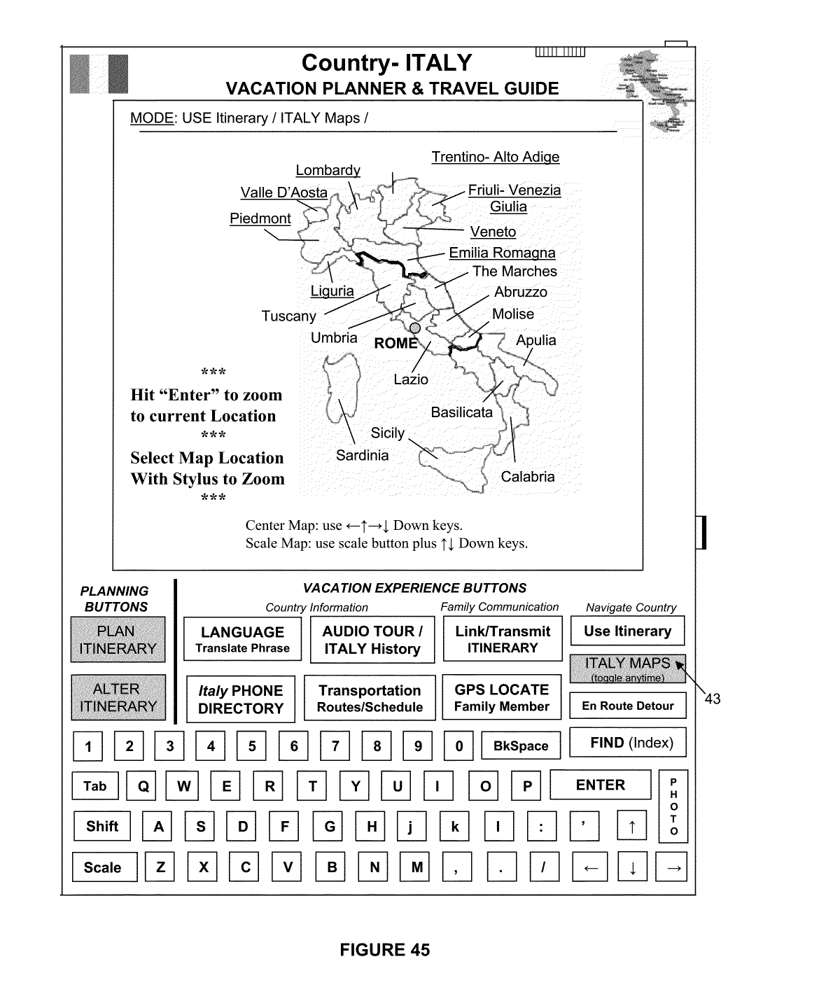

One possible means of providing further assistance may be in the form of the “Italy Maps” button 43. Toggling of the Italy Maps button 43 may cause the display of FIG. 45, in which a complete map of Italy is displayed. It should be pointed out that the Italy Maps button 43, and both of the planning buttons—the Plan Itinerary button 32 and the Alter Itinerary button 33—may have colored background shading on the button, which may serve as a visual indication/reminder for the user that the Italy Maps button 43 may be toggled any anytime that it is needed—during a planning stage or a touring stage—to provide a map image upon the screen for navigation purposes. The Italy Maps button 43 may subsequently be toggled a second time to thereby remove the map image from the screen, once the user is ready to return to the itinerary display that had previously been in use. This may be advantageous because, although the software often provides the option of viewing a corresponding map image during planning steps, a person planning the itinerary may want to think ahead by looking at a map, which need not have to be an additional paper map, and should more conveniently be an electronic map of Italy stored within the information database.

The map image's first appearance in the screen of FIG. 45 may be full size, to be functional for both the planning and the execution of the itinerary. To more quickly aid the user who may be lost and is seeking a quick map reference, the software may be constructed to allow the traveler to hit the enter key to have the map instantly scroll to the users current location in Italy, and simultaneously be scaled up to permit recognition of street-level data, which would naturally be dependent upon its communication with a GPS receiver. Alternatively, the map initially returned by the Italy Map button 43 may preferably be full size when in a planning stage, and zoomed in on a current location when in a touring stage during execution of the itinerary. GPS communications in relation to the map may occur according to the National Marine Electronic Association Standards, NMEA 0183 and NMEA 2000, the disclosures of each are incorporated herein by reference. It is also possible to not incorporate the GPS receiver into the device utilizing the software herein, and simply provide a moveable electronic map that may nonetheless be able to aptly substitute for a folded paper map.

As seen in FIG. 45, there may be many different ways to manipulate the map. For example, the arrow keys may be toggled to shift the map so as to be centered on certain other locations. Also the scale button 47 may be depressed in combination with the arrow up or arrow down keys to alter the map scale. There may alternatively be separate mechanical buttons—one being a “scale up” button and one being a “scale down” button, or there may be touch-screen buttons that permit tapping thereon in order to scale up or scale down the map image. Lastly, the translation and scaling of the map may be by the user's finger contacting the touch-screen with them expanding outward to scale up the map or moving together to scale down the map image—a function that is currently available on many digital devices, such as the Apple iPhone and iPad.

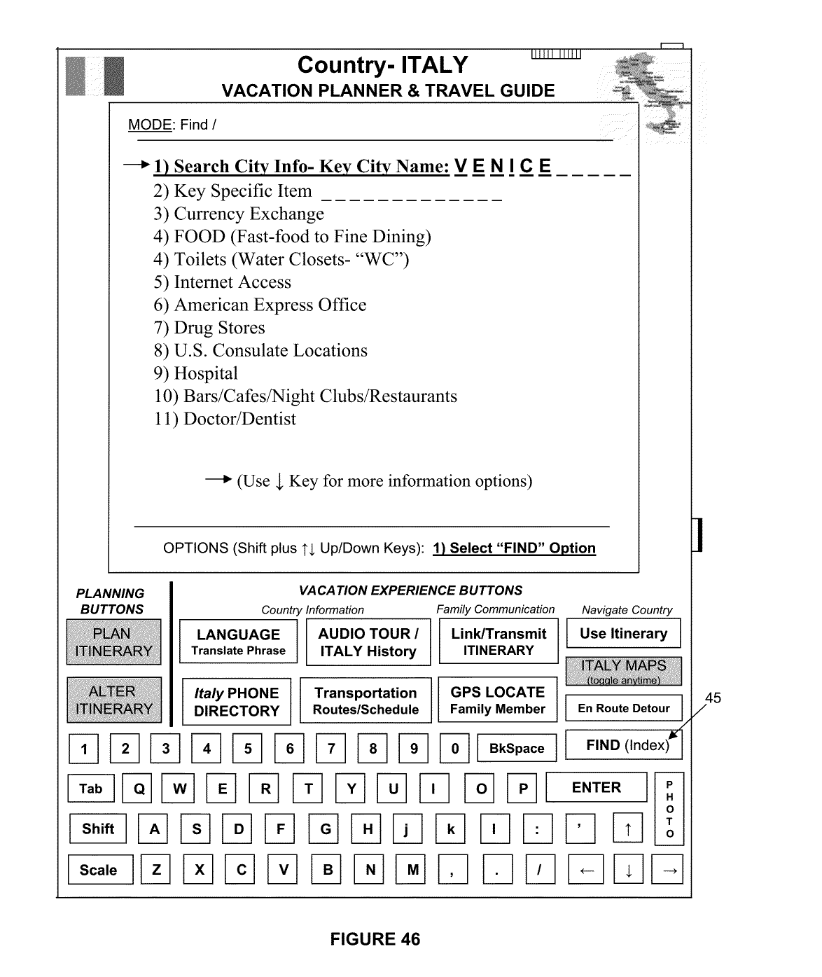

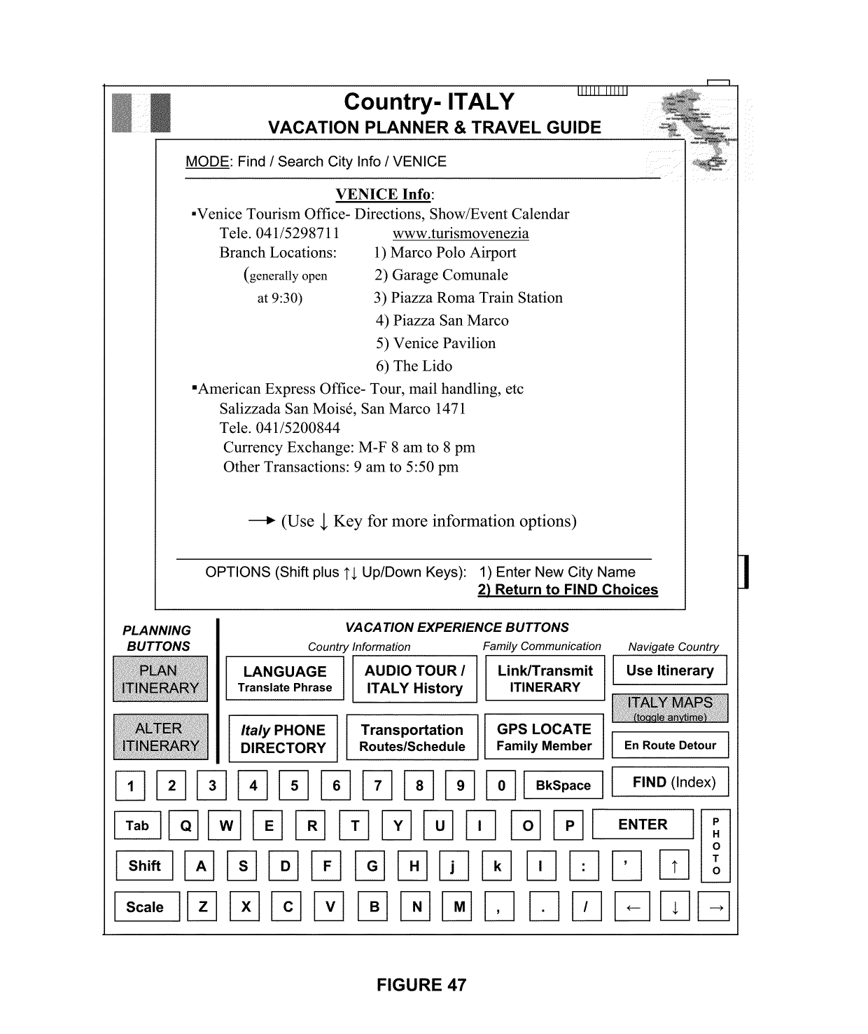

Another possible means of providing assistance to the traveler while at the destination may be the “Find” button 45. Depressing the Find button 45 may produce the screen image of FIG. 46, which permits a search for certain country-specific information. The options shown in FIG. 46 are merely meant to be exemplary, and definitely do not constitute an exhaustive list of the possible options. An example of use of the Find button 45 may involve a user searching for general information about the city of Venice. The user may key in “VENCE,” in the “Search City Info—Key City Name: ______” choice, which may produce the screen of information illustrated in FIG. 47.

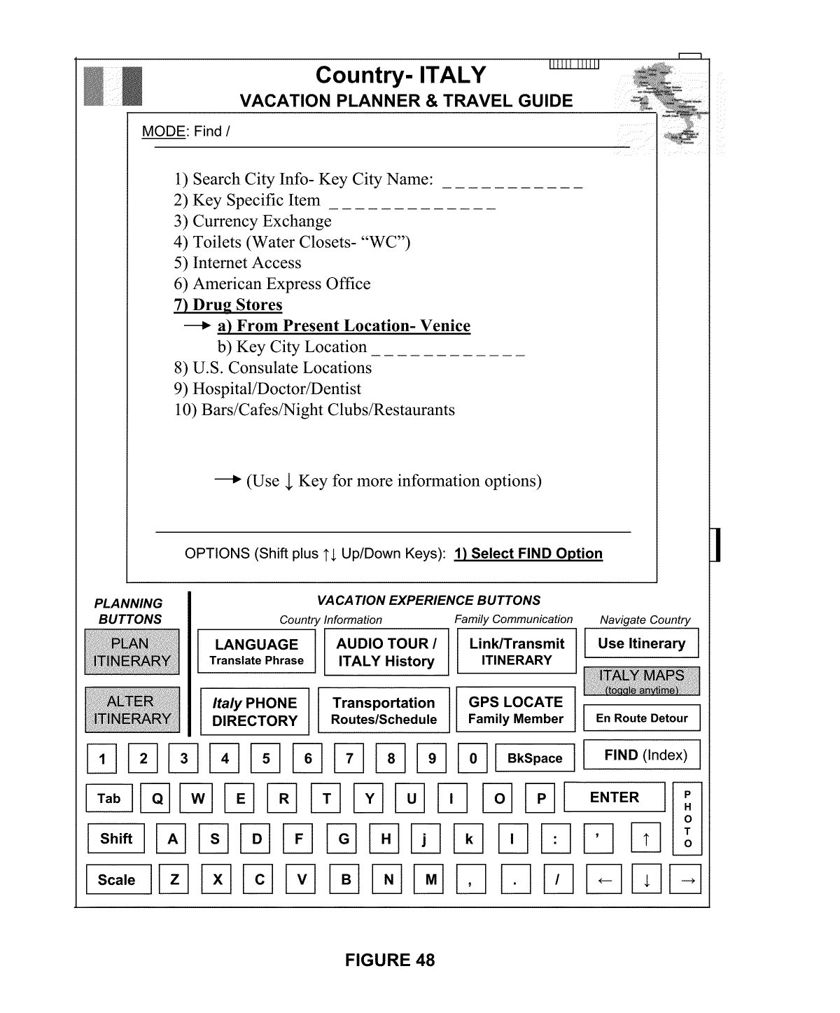

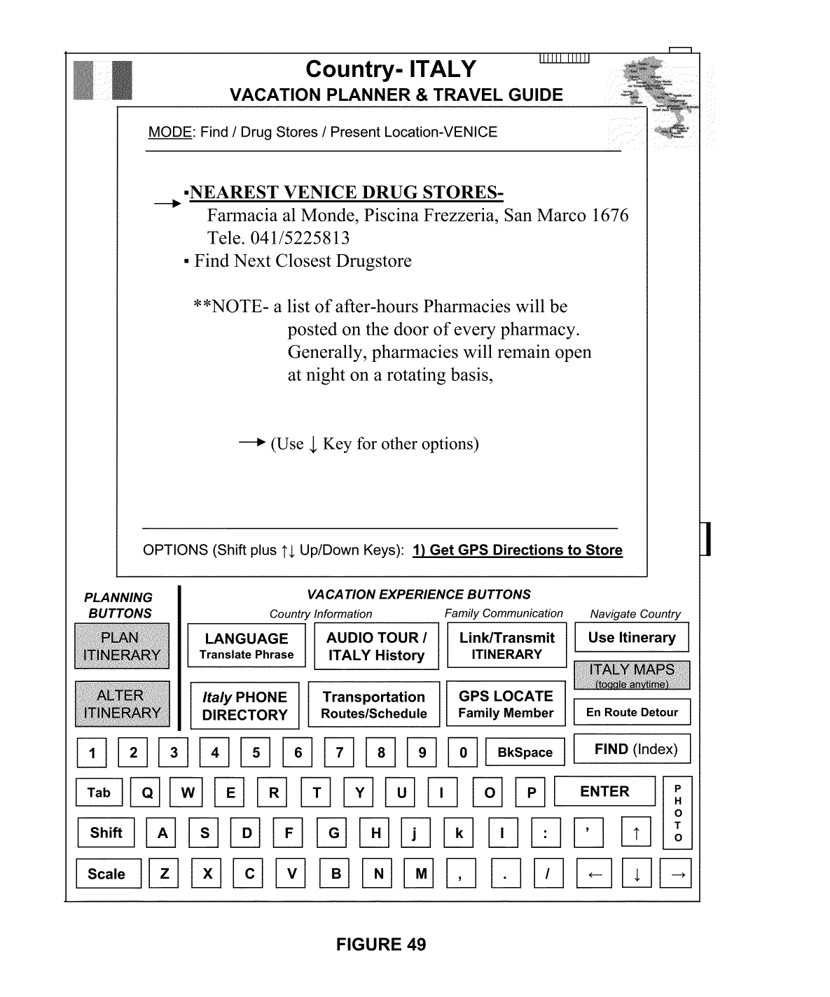

The user may also be seeking certain specific retail stores or services that would be conveniently available at home, but may require assistance to locate while touring in Italy. So selection of the “Return to FIND Choices” option may permit the user, as seen in FIG. 48, to toggle down to the seventh choice in order to find a drug store. The highlighting of “Drug Stores” may automatically cause the addition of other logical choices—those possibly being to find the drug store nearest to the user's present location, or to find a drug store in another city that the user will be traveling to next. Selecting the choice of “From Current Location—Venice” may operate in conjunction with a GPS receiver to list the nearest drug store (FIG. 49), and any related information, and to possibly provide a map with directions to the store.

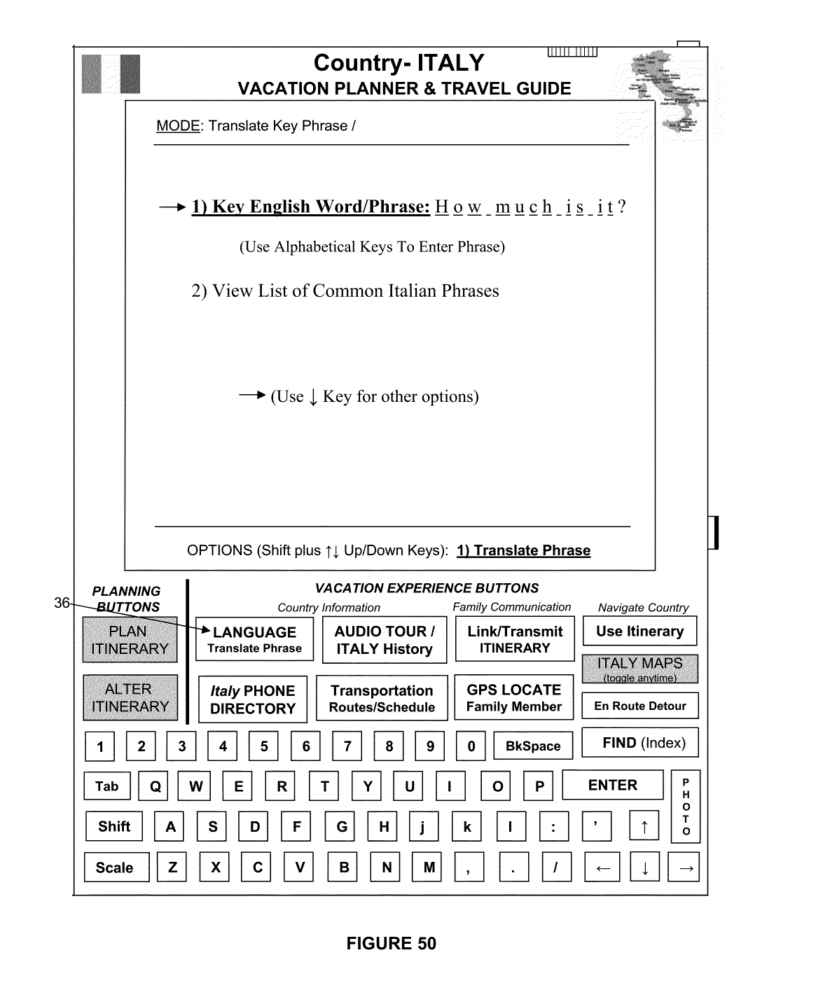

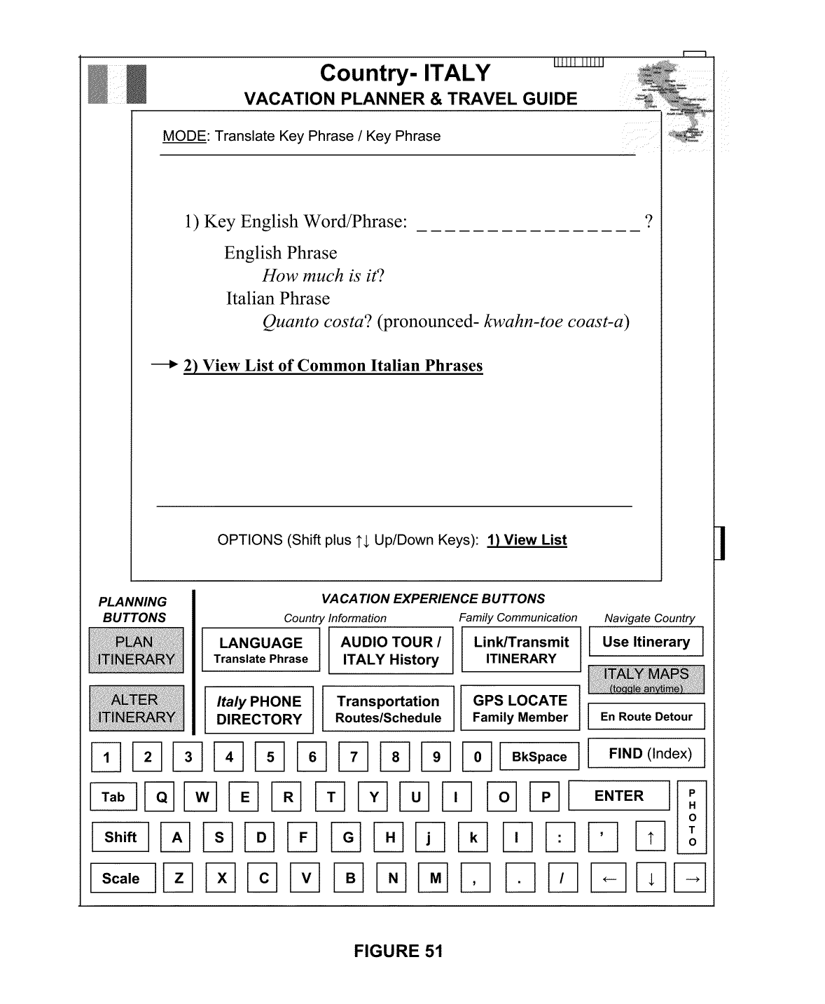

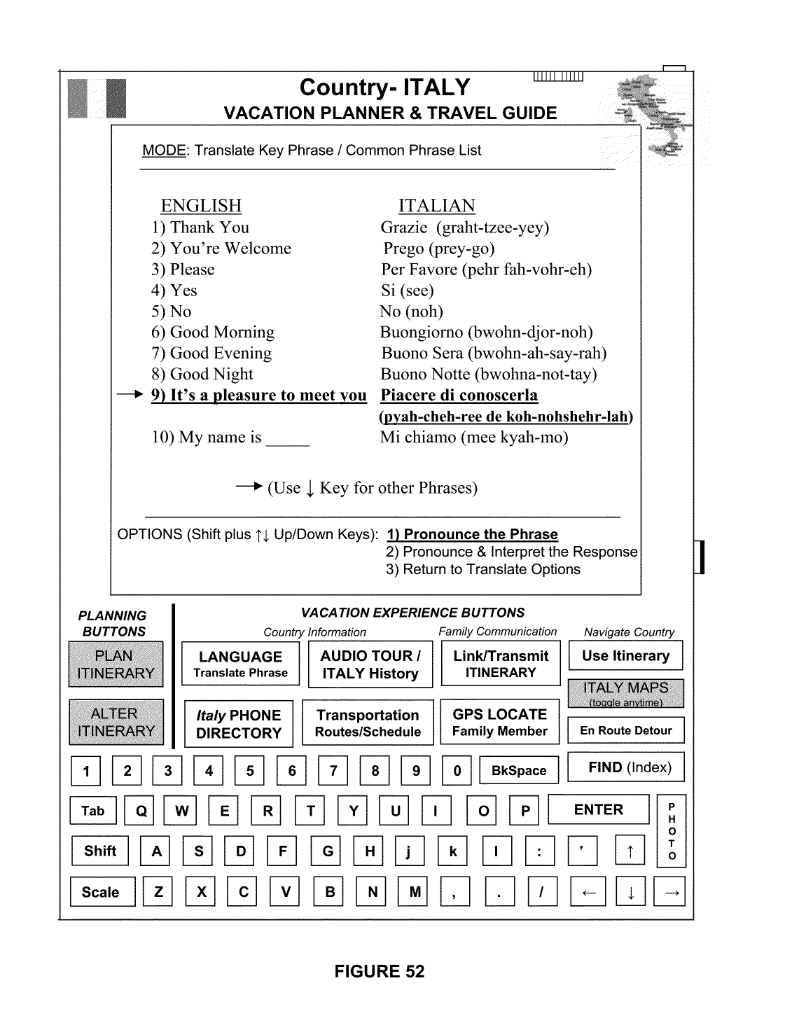

Additional assistance to the traveler may also be provided by the “LANGUAGE Translate Phrase” button 36, which may produce the screen image of FIG. 50. The first option therein may permit the user to type in a word or a phrase that the user is trying to express to a foreign national at the destination country. Although many Italians also speak English, this feature may nonetheless be invaluable at certain times, and at certain other destination countries. Typing in the phrase, “How much is it,” yields the result shown in FIG. 51, where both the English phrase and the Italian translation are listed next to each other, along with a phonetic aid for proper pronunciation. That same page may still be utilized to key in additional phrases for translation, or alternatively, highlighting the choice “View List of Common Italian Phrases” yields the screen of FIG. 52. The phrases therein may be ordered alphabetically or according to their frequency of usage, and possibly with a screen option to view them according to either ordering scheme.

There may also be a “Pronounce the Phrase” option, which may use a sound generator/speaker 13 to enunciate the phrase to either coach the traveler so that the traveler may be able to correctly say it to the foreign speaking native, or so that the traveler may simply toggle the option to have the travel planner/guide speak the phrase to the person. There may also be, within the processor of the device, one or more voice recognition algorithms, including a Hidden Markov Model, so that a complex response made in the foreign language by the foreign national, may be received by microphone 15 (FIG. 1) and interpreted into the traveler's language through use of the algorithms. (See, “A Revealing Introduction to Hidden Markov Models” by Mark Stamp, available at http://www.cs.sjsu.edu/faculty/stamp/RUA/HMM.pdf; and “A Tutorial on Hidden Markov Models and Selected Applications in Speech Recognition,” by L. Rabiner, IEEE 77(2): 257-286, available at http://www.cs.ubc.ca/˜murphyk/Software/HMM/rabiner.pdf., the disclosures of each being incorporated herein by reference) Therefore, below the “Pronounce the Phrase” option in FIG. 52, may be an option to “Pronounce and Interpret the Response.” The interpreted response may be translated into the traveler's language and be vocalized using the speaker/sound generator 13, or be translated into text that appears in the central information region 24 of graphical display screen 20.

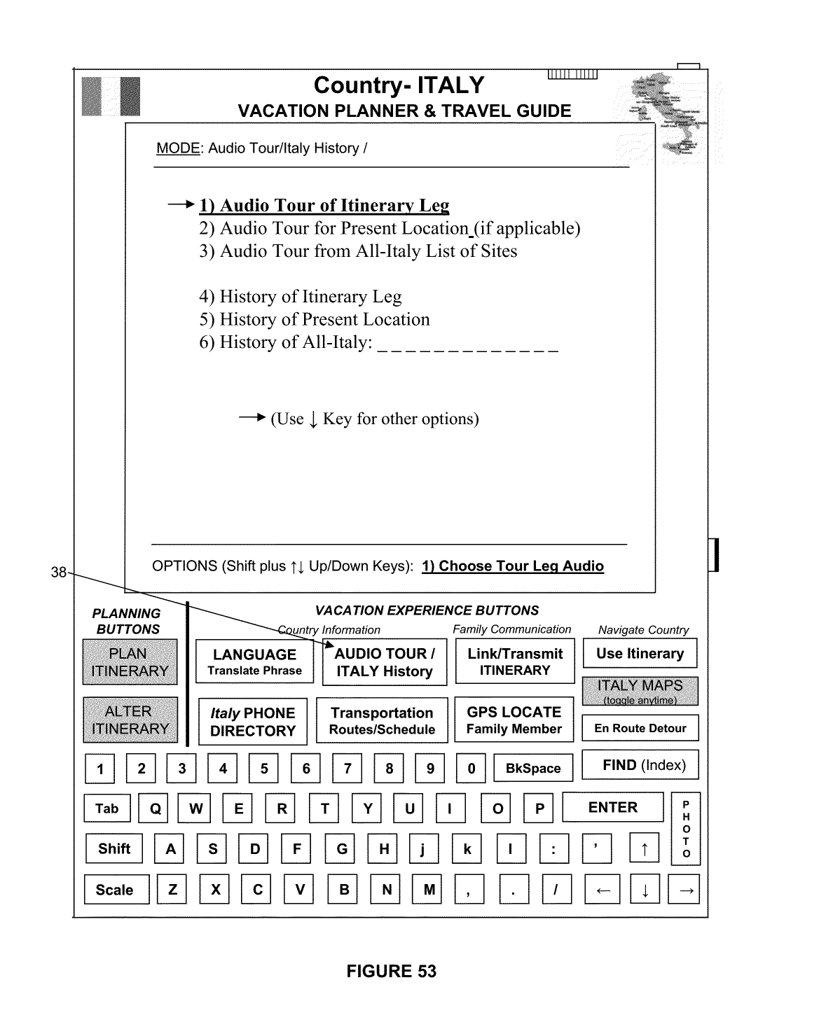

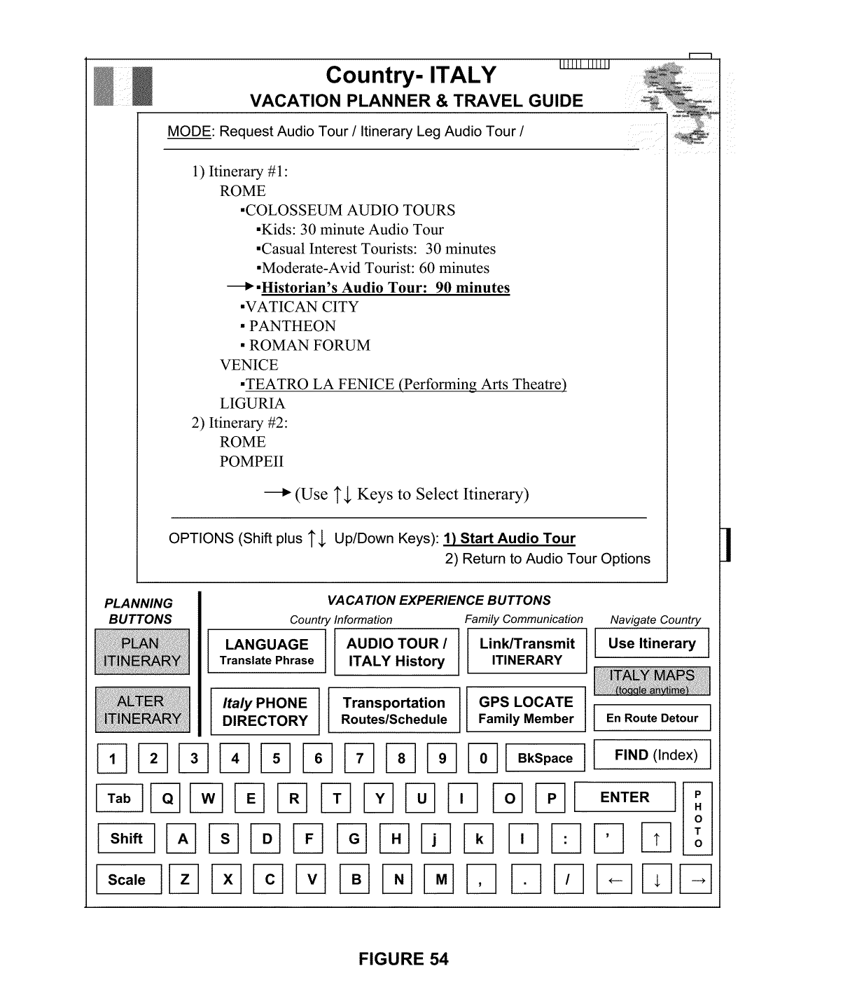

Another beneficial aid to the traveler, to enhance their experience while on vacation, may be the inclusion, within the database of travel related information, of audio or video tours of each of the sites that may be visited. Toggling the “AUDIO TOUR/ITALY History” button 38 may yield the screen of FIG. 53. There may be several options for audio tours because different users may wish to experience the site in different ways. One visitor may wish to listen to the tour while en route to the site, which may require use of choice number three, “Audio Tour from All-Italy List of Sites.” Another traveler may be walking randomly in relation to the planned itinerary and discovers a site not chosen previously, but becomes interested and decides to learn more about it by selecting choice number two, “Audio Tour for Present Location,” which may require use of a GPS. However, many people may prefer to have an experienced guide explaining the significance and features of a site while they are actually viewing the site, making the first choice, “Audio Tour of Itinerary Leg” a valuable feature, the selection of which results in the screen of FIG. 54.

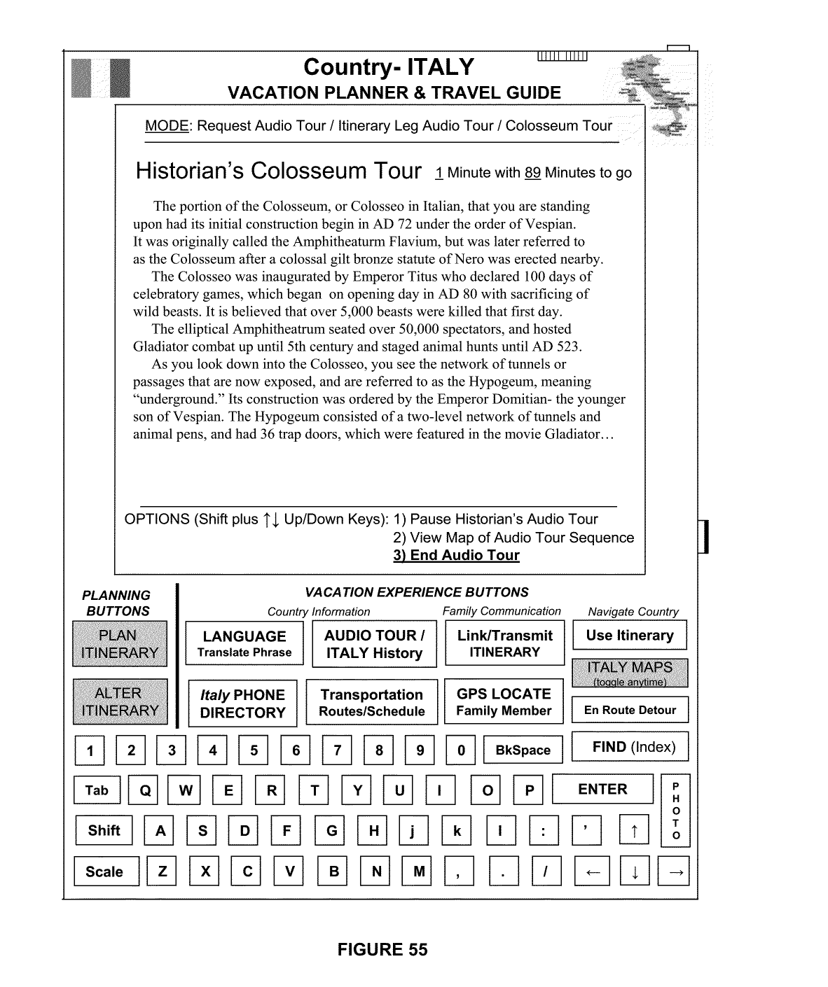

The audio tours may preferably be offered in different pre-recorded lengths of time for the presentation, and/or in incrementally distinct intellectual levels, to accommodate various travelers. The interest level of children may be very different than for travelers having only a modest interest, although both may be for about the same length, perhaps being only 30 minutes long for the entire Colosseum. Each audio tour—a child's tour, a casual interest tour, a moderate-avidly interested tourist, and the historian's audio tour—may be constructed to be suited for the respective level of interest/learning. For the person having great archeological interest in the Colosseum, selection of the “Historian's Audio Tour: 90 Minute Audio Tour” choice may be appropriate, and may yield the tour represented by FIG. 55. The actual text of the audio tour may appear on screen, along with graphical illustrations to help the user to recognize the features being spoken about. The screen may also indicate the time remaining for the tour, in case a listener becomes concerned about making it to the next site in the itinerary, and wonders how much time remains in the audio tour. The device may preferably include a headphone jack 16 (FIG. 1) to provide for silent listening, and the device may also preferably transmit the audio tour on various radio frequencies so that an entire family of travelers could listen using individual wireless headphone sets. In one embodiment, the device may transmit the audio tour wirelessly to personal area networks, using, for example, Bluetooth wireless technology, which may permit transmission of the audio tour to up to seven mobile phone headsets.

The Audio Tour/Italy History button 38 may also, as seen in FIG. 53, provide historical information about the country, which may be offered for a particular itinerary leg, for a user's current location, or in relation to any aspect of the entire country by searching the entire database

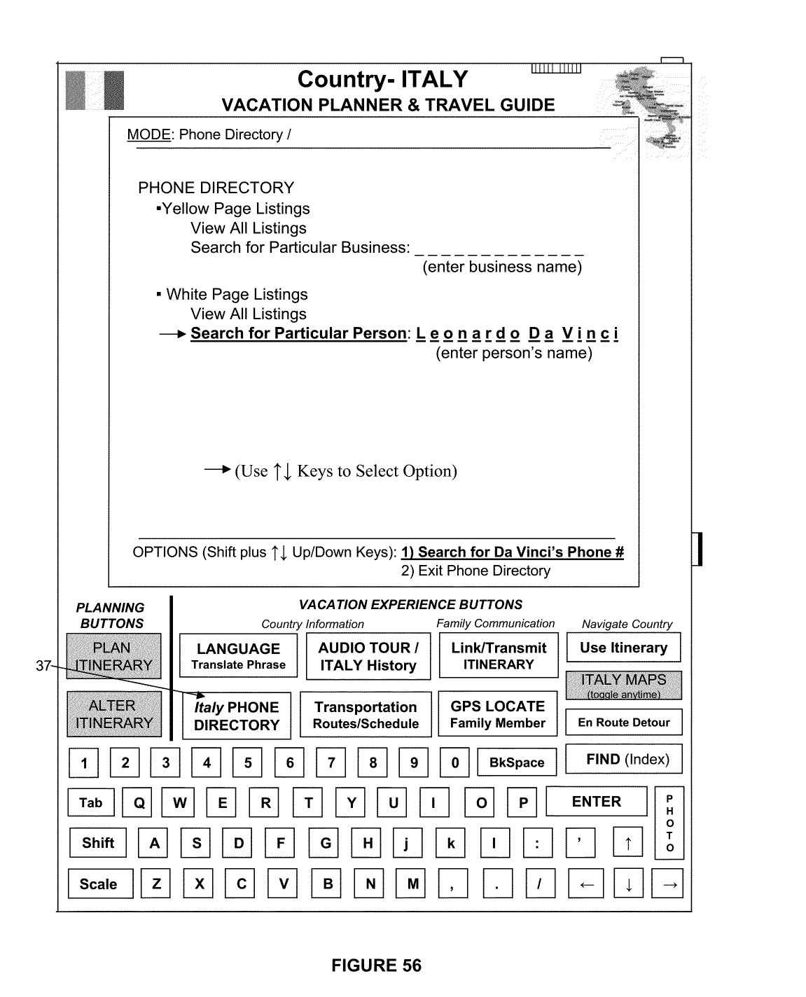

Another useful feature for the traveler may be found in the “Italy Phone Directory” button 37, which, when depressed, may produce the screen of FIG. 56. The user may therein search for a person or business, according to a white pages search or a yellow pages search, by keying in a name. Much of the commercial information accessed in this manner from the yellow page listings may also be found by using the FIND button 45, which was previously described.

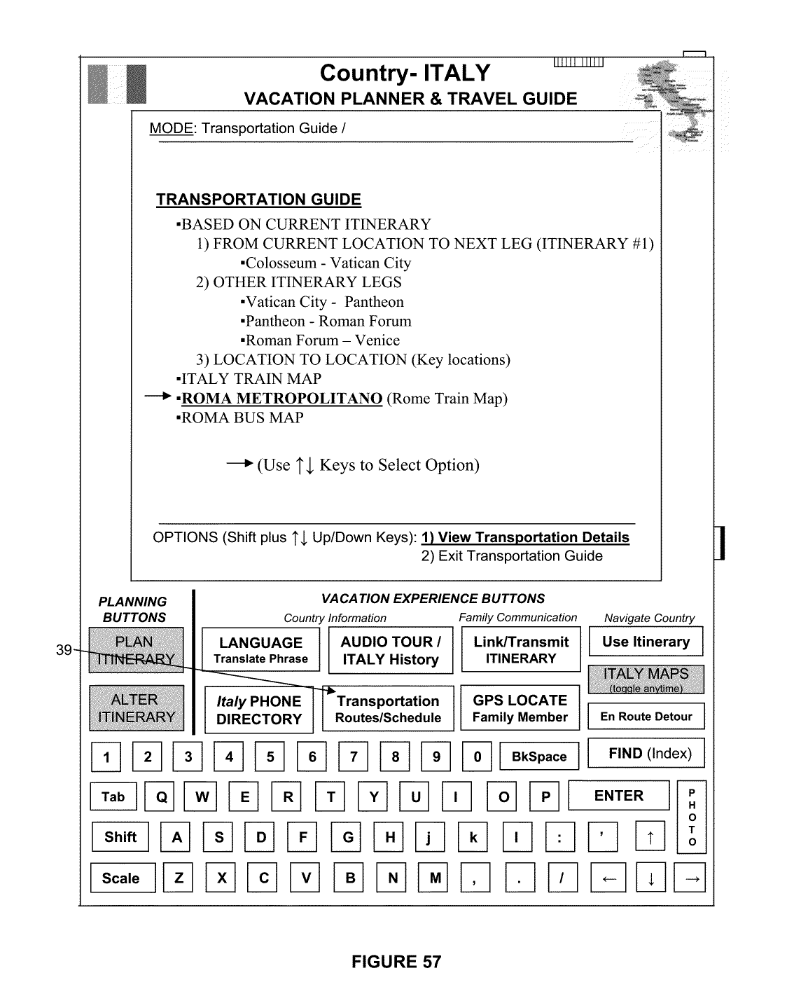

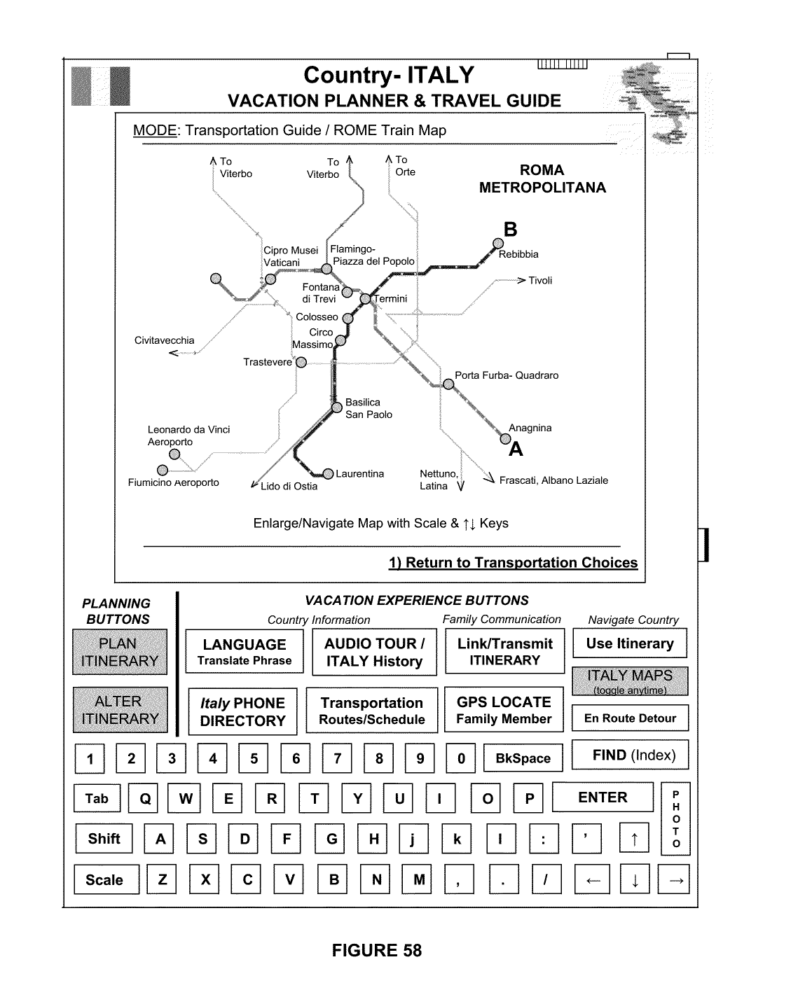

The “Transportation Routes/Schedules” button 39 may also provide the user with information to better navigate between tour stops, or across a city or a region of Italy, whereby depressing of the button may result in the display of FIG. 57. There may be many possible choices therein, and so to be exemplary, two of them will be discussed. Highlighting the “ROME Metropolitano” choice and selecting the “View Transportation Details” option yields an electronic version of the map for Rome's metropolitan-area train, as seen in FIG. 58. This map may be manipulated the same as the maps described in the discussion of the Italy Maps button 43. Viewing the entire Rome Metro map may assist the viewer in planning some in-country changes to the itinerary.

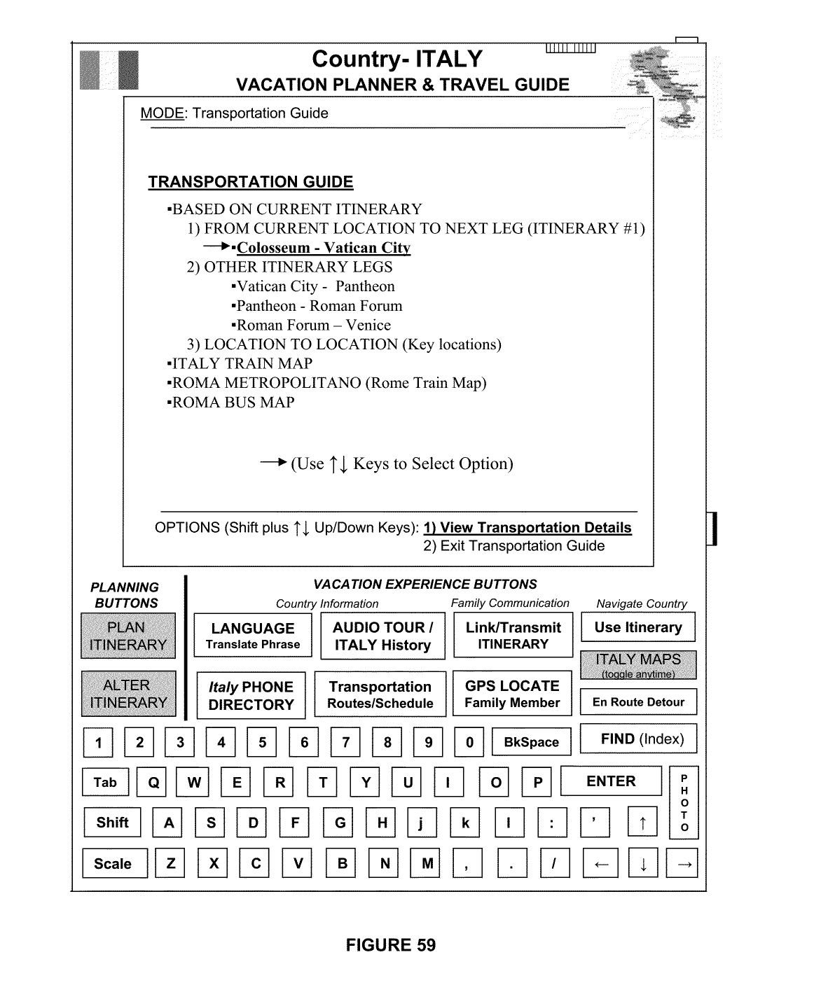

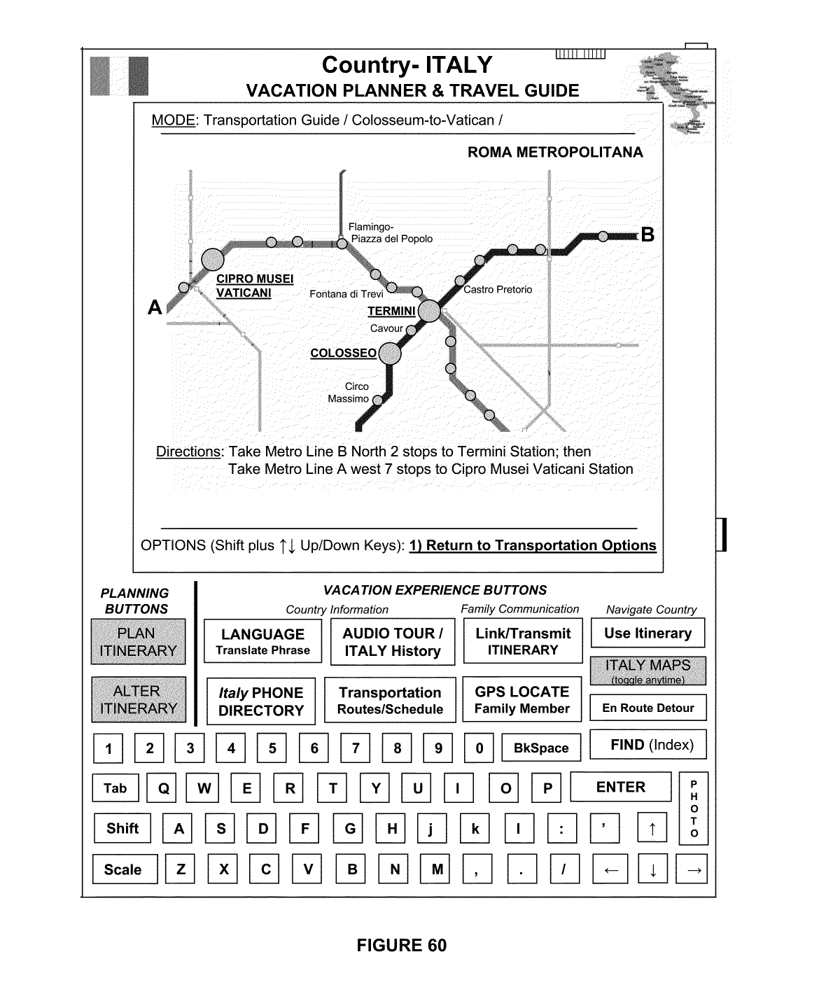

For the user following his or her planned itinerary, selecting, from FIG. 59, the choice based on the current itinerary, going from the current location to the next itinerary leg, “Colosseum—Vatican City,” may result in the screen of Figure of 60, which has enlarged the Rome Metro train map to focus on the stops in going from the Colosseum to the Vatican. Each stop may be distinctly denoted by a circular bubble, and the beginning stop, the end stop, and any stop at which a change in train line must occur, may be designated by a larger circular bubble, or other symbol that may alert the traveler. There may also be textual directions, as seen at the bottom of the screen in FIG. 60, to reinforce the steps necessary for the user to take, namely being, in this case, to take the Metro Line B North two stops to Termini Station; and then to take the Metro Line A west seven stops to the Cipro Musei Vaticani station.

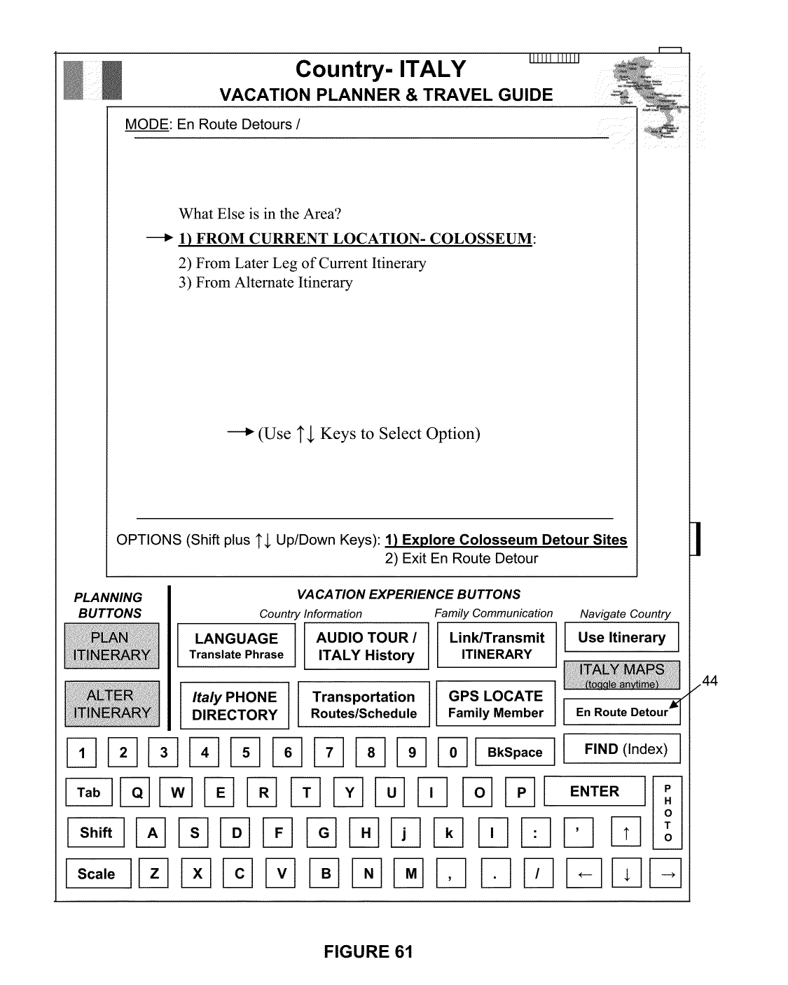

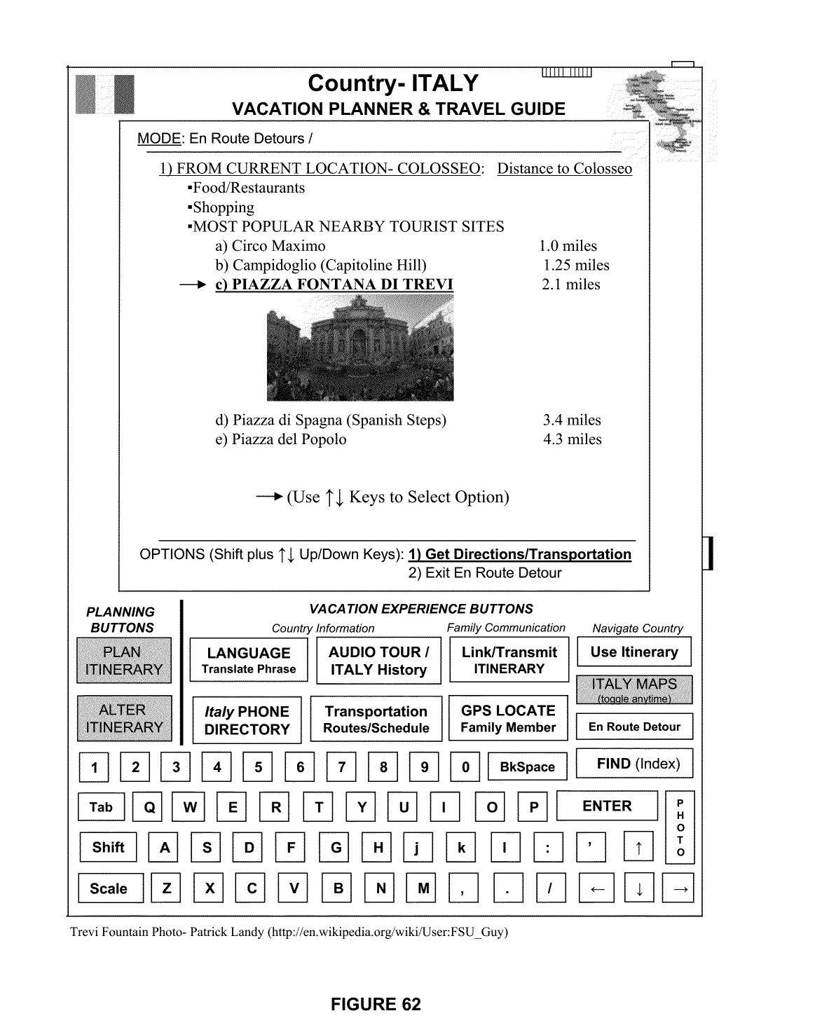

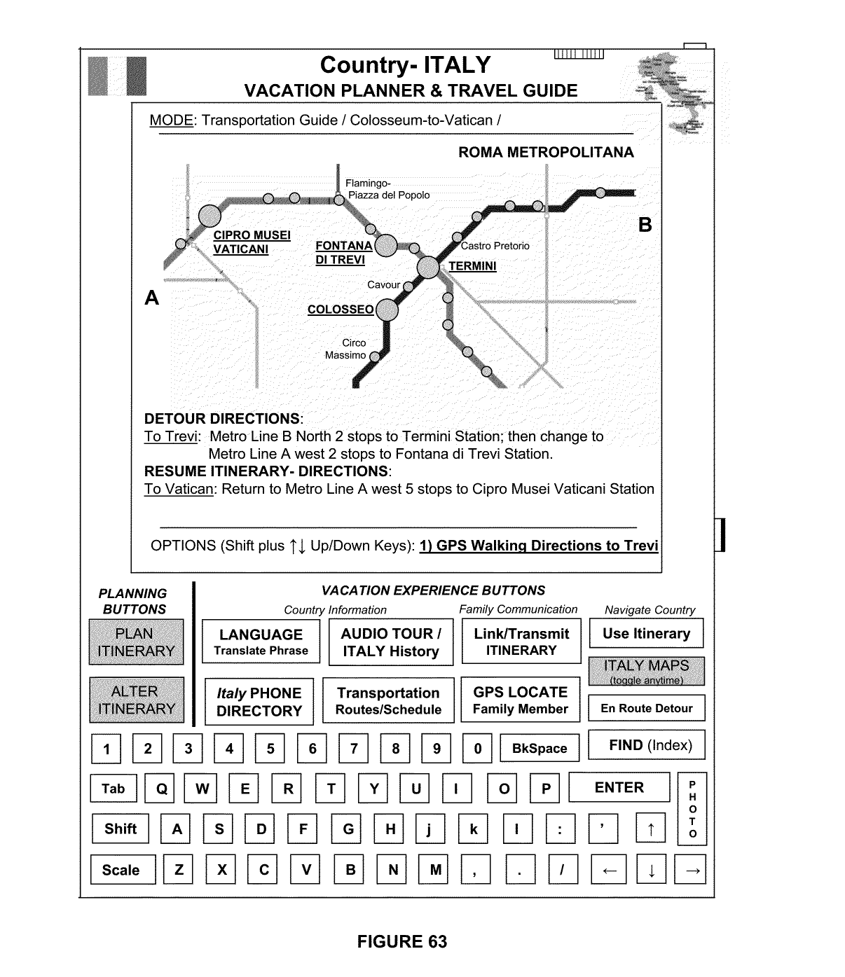

Another feature to enhance the travel experience, for a person using this software on a mobile computing device, is the “En Route Detour” button 44, which yields the screen of FIG. 61. This screen lets a user, who finds extra time left at the end of the day, or was perhaps disinterested in remaining very long at one of the planned sites, to search the database to quickly ascertain what other sites of interest may be in close proximity to his/her current location, or in close proximity to other legs of the itinerary. Selecting the “From Current Location—Colosseum” choice yields the screen of FIG. 62, which may be broadly arranged to include lists of nearby eateries, and shopping centers, as well as tourist sites of interest. Highlighting the “Most Nearby Popular Tourist Sites” choice produces a list, which may include the site's distance away from a user's current location. This list may also include, particularly in Europe, sites for visiting a neighboring country, which is often very close by. For example, it is only about 18 miles or a forty-five minute train ride from Ventimiglia on the Italian Riviera in Liguria, to Nice, France, which is on the French Riviera. Highlighting the “Piazza Fontana di Trevi” choice with the “Get Directions/Transportation” option yields the screen of FIG. 63, which may be the same Rome metro train map of FIG. 60, but now showing a large bubble for the Fontana di Trevi stop, and with textual directions for how to get to that stop, as well as for how to continue on with the itinerary. There may also be an option to request walking directions if the distance is not great, because the user may be more inclined to walk short distances.

The software may preferably have communications ability whereby one user having a mobile computing device running the software herein, may communicate with another user having a second mobile computing device that is also running this software. This may be advantageous for groups of travelers, such as several college students traveling about different parts of a country, or a family that decides to split up to explore different parts of a city or region on one day or for several days, but did not elect to acquire international phone service for the trip, which is available from most U.S. cell phone service providers. It may also be valuable even where a family may have provided certain members with international phone service, but have concerns about such independent travel in a foreign nation, and wish to have additional means of monitoring the travel progress of their companions. E-mail communication would be helpful, but is not instantaneous. However, the software running on a custom or preferred mobile computing device may preferably provide two additional different types of communication.

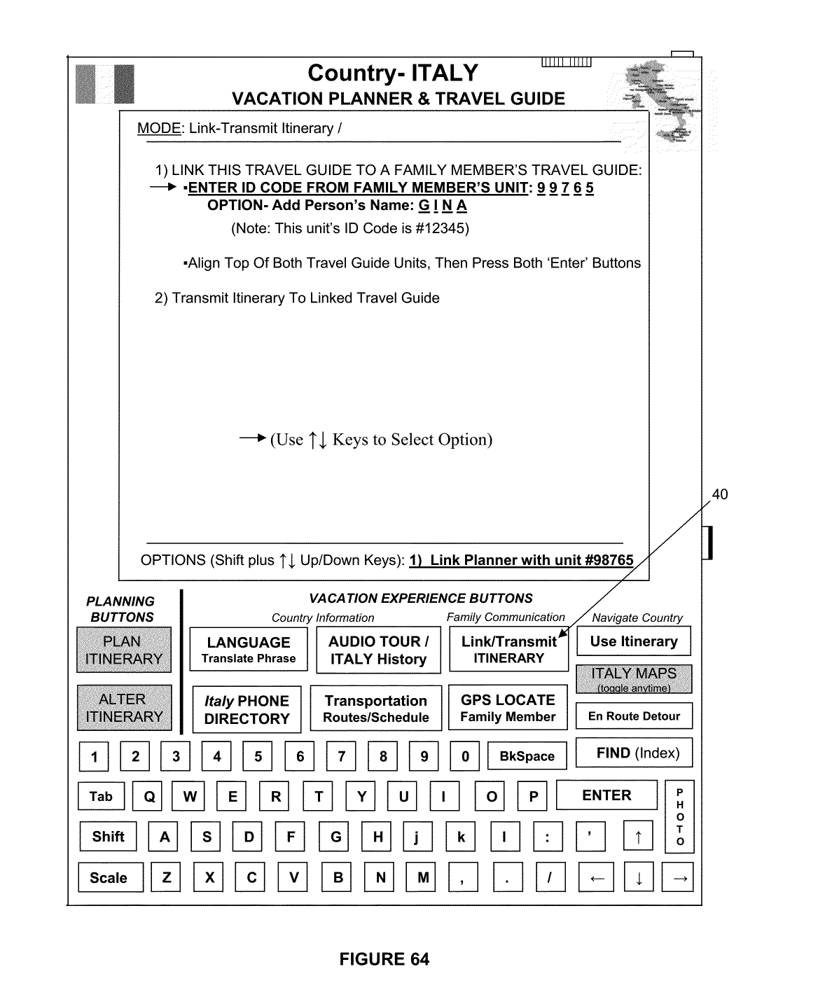

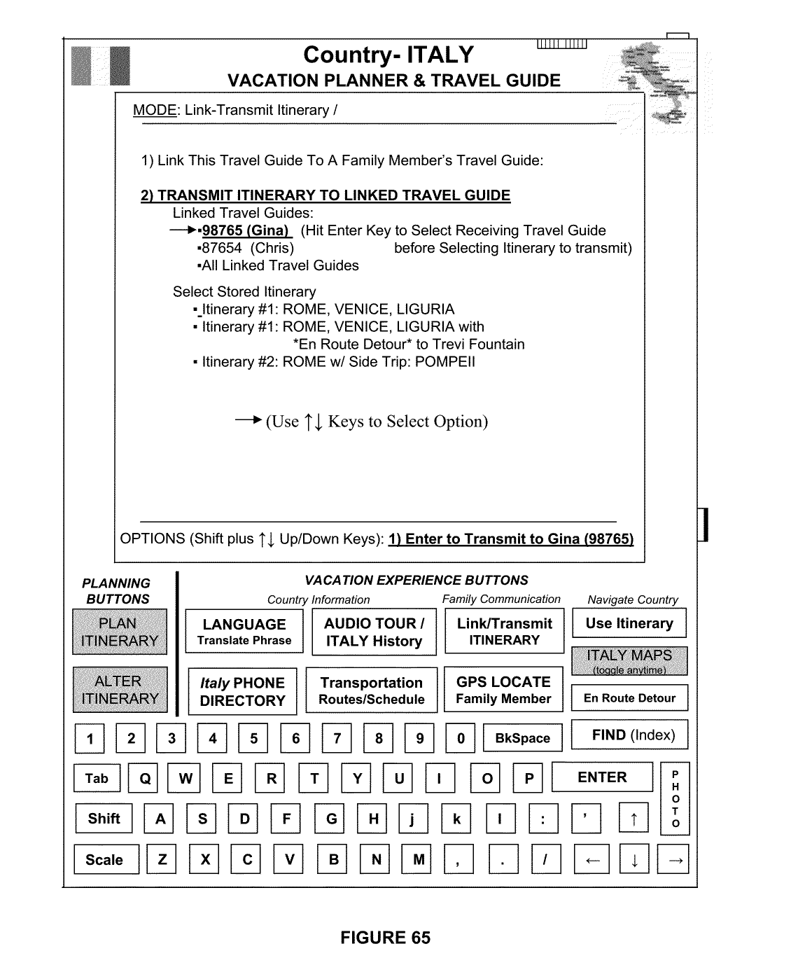

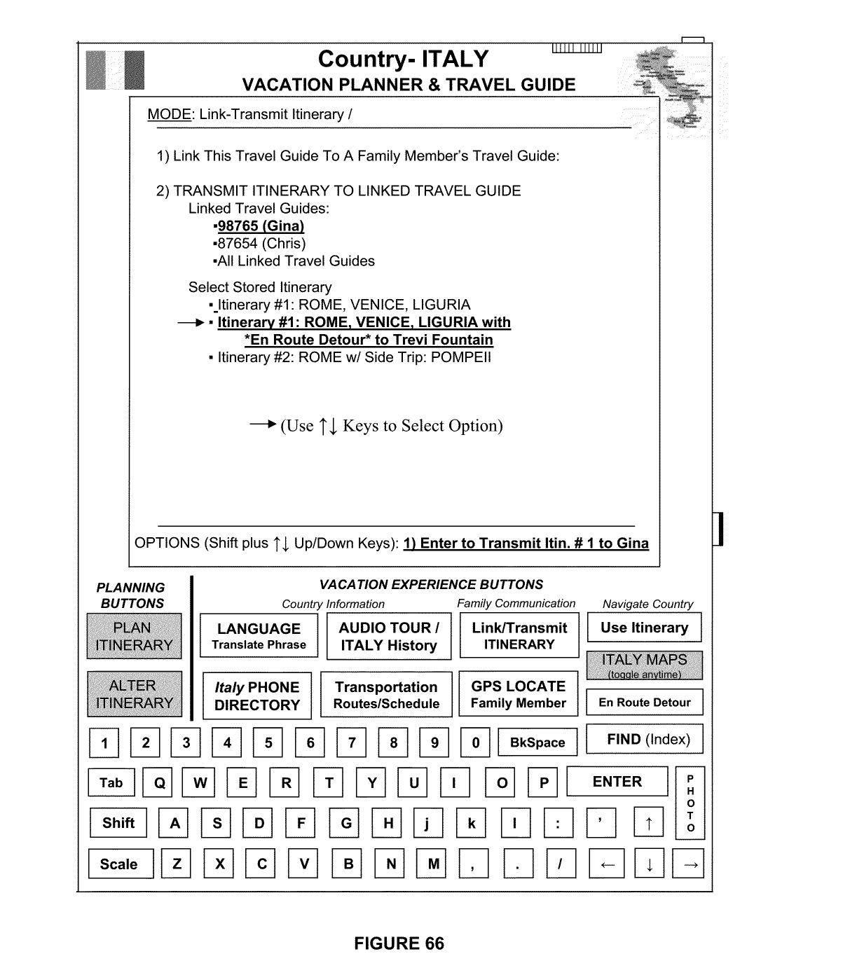

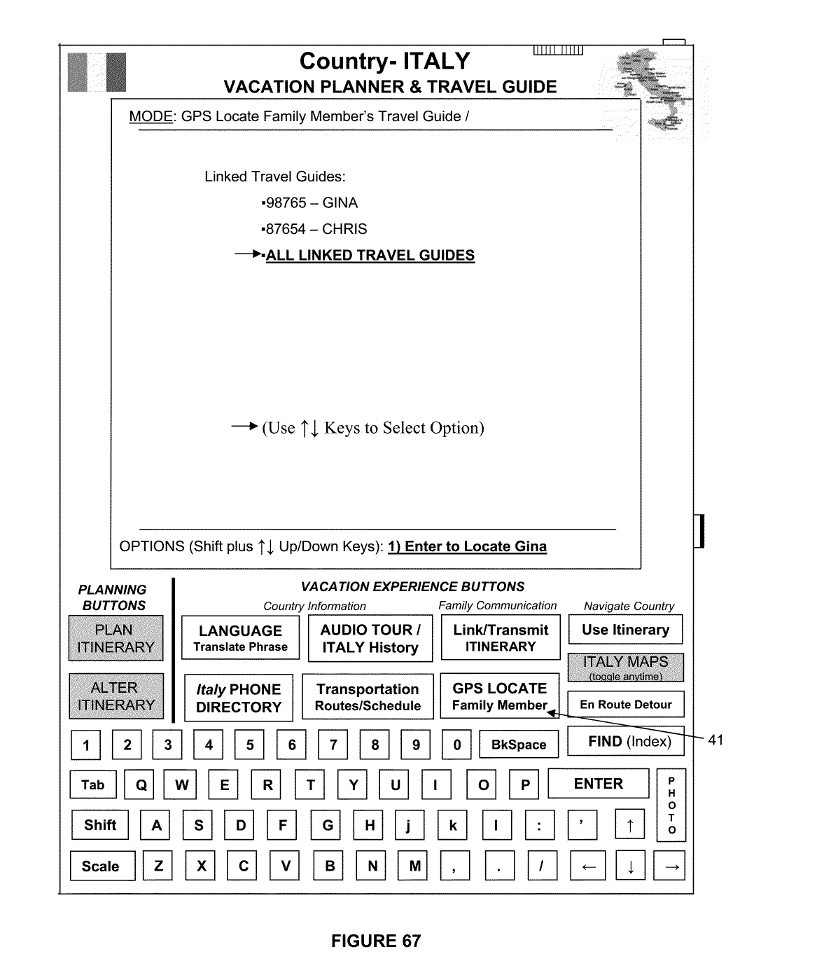

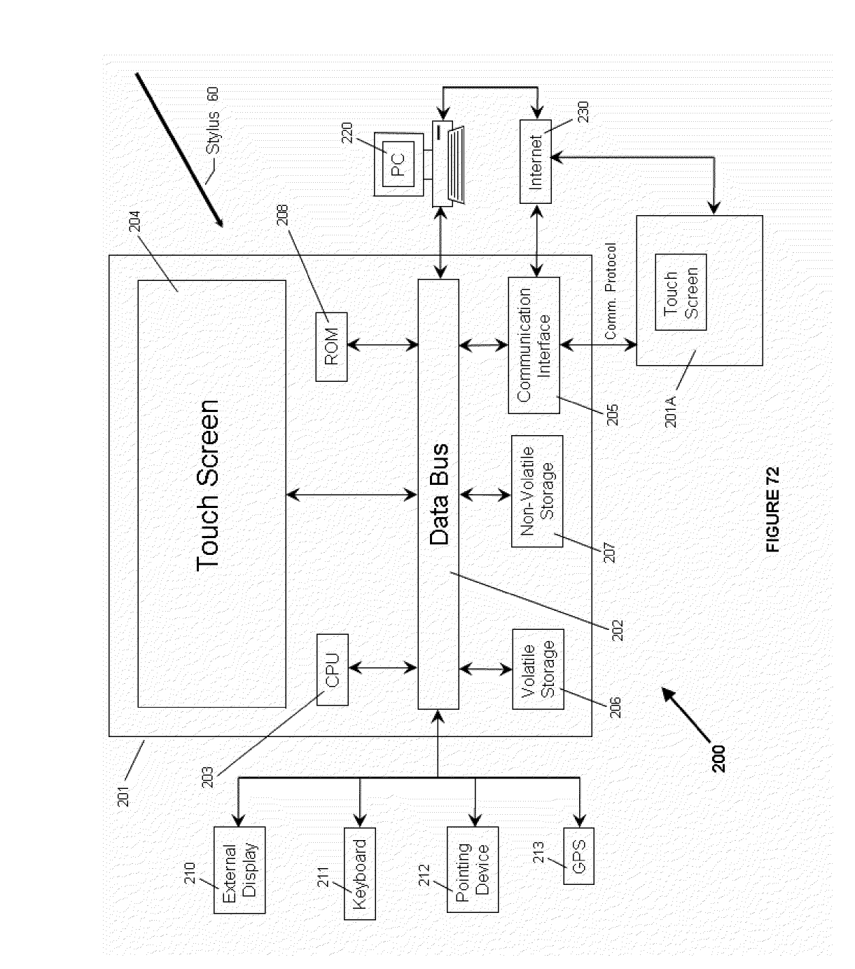

Unique addresses for each of two devices running this software may be exchanged and permit the two devices to communicate exclusively therebetween, to communicate either an itinerary or a GPS positional location. FIG. 64 illustrates one possible screen to exchange addresses for a mobile computing unit prior to travel, under the “Link/Transmit Itinerary” button 40. The screen may include the option to enter a person's name, rather than simply the electronic address. FIGS. 65 and 66 illustrate screens for transmitting, to “Gina,” who possesses a second linked travel planner (see also FIG. 72), one of the stored itineraries, which may include any last minute itinerary detours added using the En Route Detour function button 44. FIG. 67 illustrates a screen to make use of the “GPS LOCATE Family Member” button 41, and shows selection of “all linked travel guides,” which enables the user of the shown device to check upon the travel progress of one or more linked travel planner/guides. The software may either continuously broadcast, or routinely broadcast a travel planner's location throughout the course of a day, along with a time-date stamp for the location transmission, in order to provide assurance of a traveling companion's or a child's separate progress along a planned itinerary.

The software may be adapted to transmit GPS communications according to NMEA 0183 from unit to unit according to many different means, some of which are disclosed in currently unexpired patents, while other methods are in the public domain, such as the Open Device Monitoring and Tracking Protocol, or as trademarked, OpenDMTP™, which is a protocol permitting bi-directional data communications between servers and devices over the internet, with emphasis on location-based information such as GPS. OpenDMTP is an open source protocol, the disclosures of which may be found at http://www.opendmtp.org/ or available therefrom, and which are incorporated herein by reference. The dependency upon internet service may be limiting, and as such, the device may also broadcast the location information by other means, such as by simple radio transmissions, or according to a radio frequency protocol, such as Interim Standard 136 (IS-136), which is a specific Time Division Multiple Access (TDMA) based radio frequency (RF) standard. The transmission may also be according to a mobile networking protocol, such as one of the following: the Global System for Mobility (GSM) networks, which had been deployed in Europe and elsewhere in the world, and uses a protocol known as the GSM Mobile Application Part (MAP) that is promulgated by the European Telecommunications Standards Institute (ETSI); or the American Code Division Multiple Access standards—the CDMA2000 networks, which uses the ANSI-41 protocol promulgated by the Telecommunications Industry Association (TIA) and American Standards Institute (ANSI).

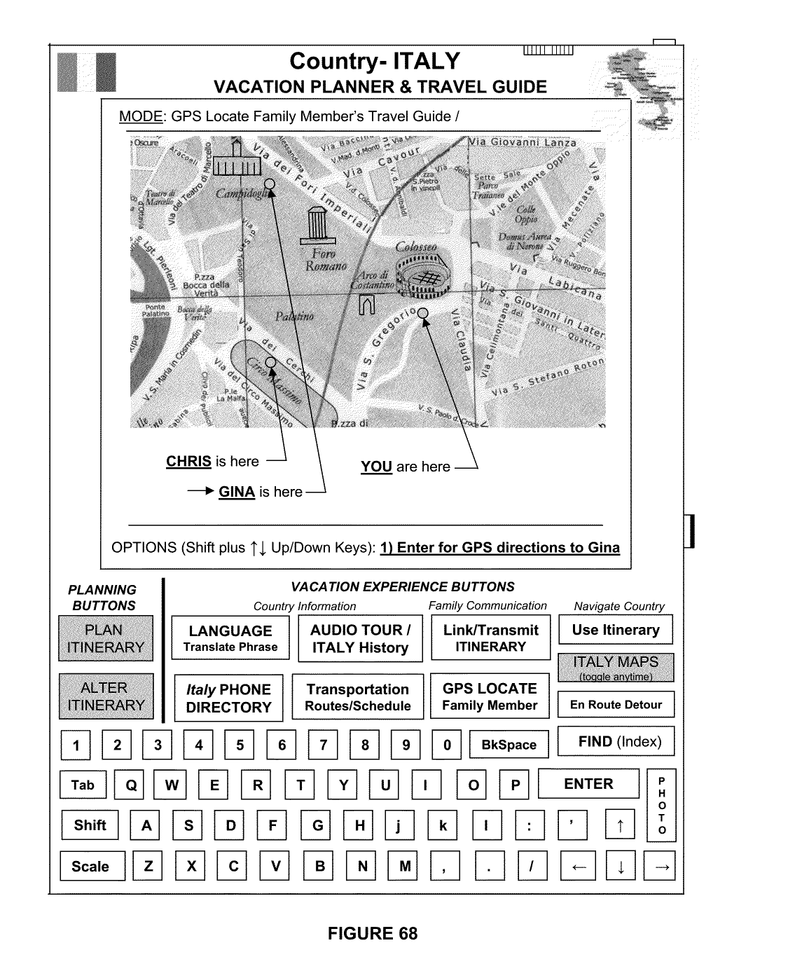

Choosing, in FIG. 67, “All Linked Travel Guides,” may cause a map display, as illustrated in FIG. 68, which may identify the location of the user's position (his/her travel planner) as well as the positional location for Gina's travel planner and for Chris's travel planner.

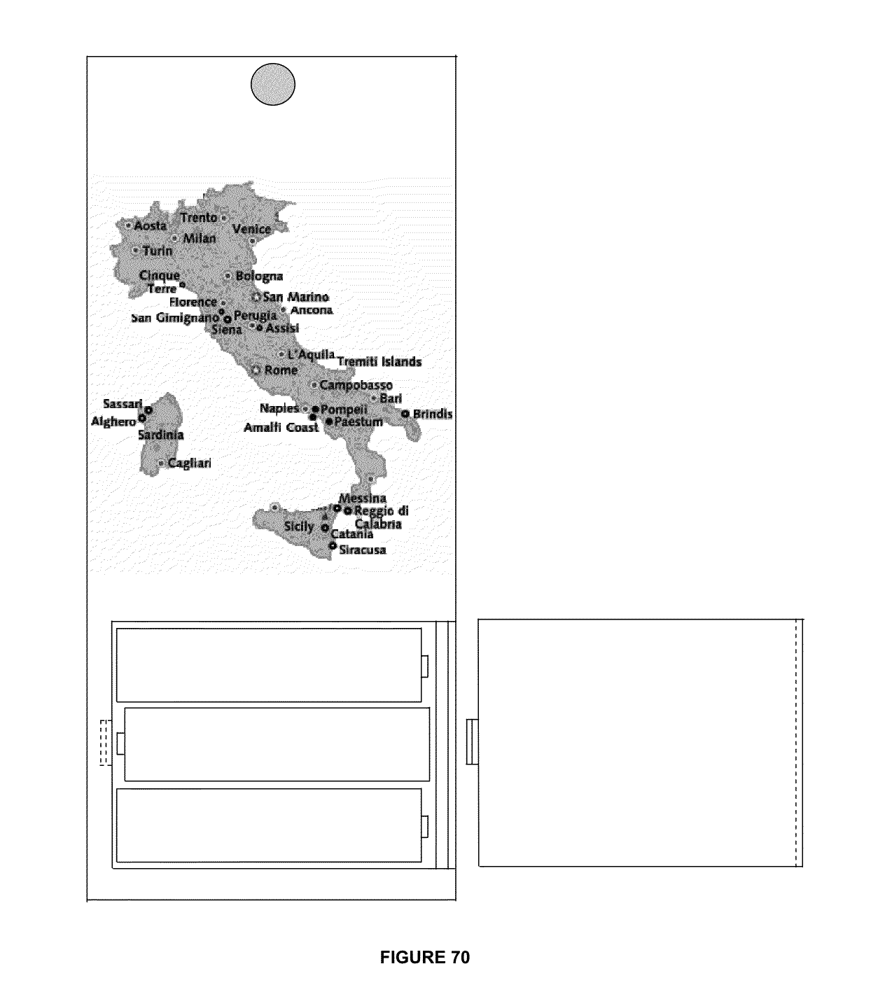

FIG. 69 illustrates a smaller travel planner unit, and one being without all of the functionality previously disclosed, as it may be without the country-specific information offered by the Language button 36, the Italy Phone Directory button 37, and the Audio Tour/Italy History button 38, and it may also be without the “family communication” offered by the Link/Transmit Itinerary button 40, and the GPS Locate Family Member button 41. FIG. 70 shows the back side of the device of FIG. 69, which may include a raised map of the destination country for quick reference, as well as a camera lens 50, as a digital camera may be conveniently incorporated into the custom device, which may be actuated using the “Photo” button 48 (FIG. 1). The custom device may also be battery powered by a rechargeable Lithium Ion Battery Pack, which may utilize the 18650 battery. The 18650 lithium-ion battery is cylindrical in shape, having a diameter of 18 mm (0.7 inches) and a length of 65 mm (2.6 inches), and may have a nominal voltage of 3.7 volts, and is favored for use in mobile computing and other electronic applications.

Lastly, FIG. 71 illustrates the software of the present invention running on a touch screen mobile computing device, where each of the buttons may be actuated by touching its digital appearance on the touch screen, rather than by depressing mechanical buttons. Such an example may be the case where the software is running on a device such as the apple iPad. In such cases, the software may be available by a disc or by an internet download, and individual country-specific information for the planner for various different nations or geographic subdivisions may similarly be available by disc, by download, by a USB memory device, or some other form of computer memory.

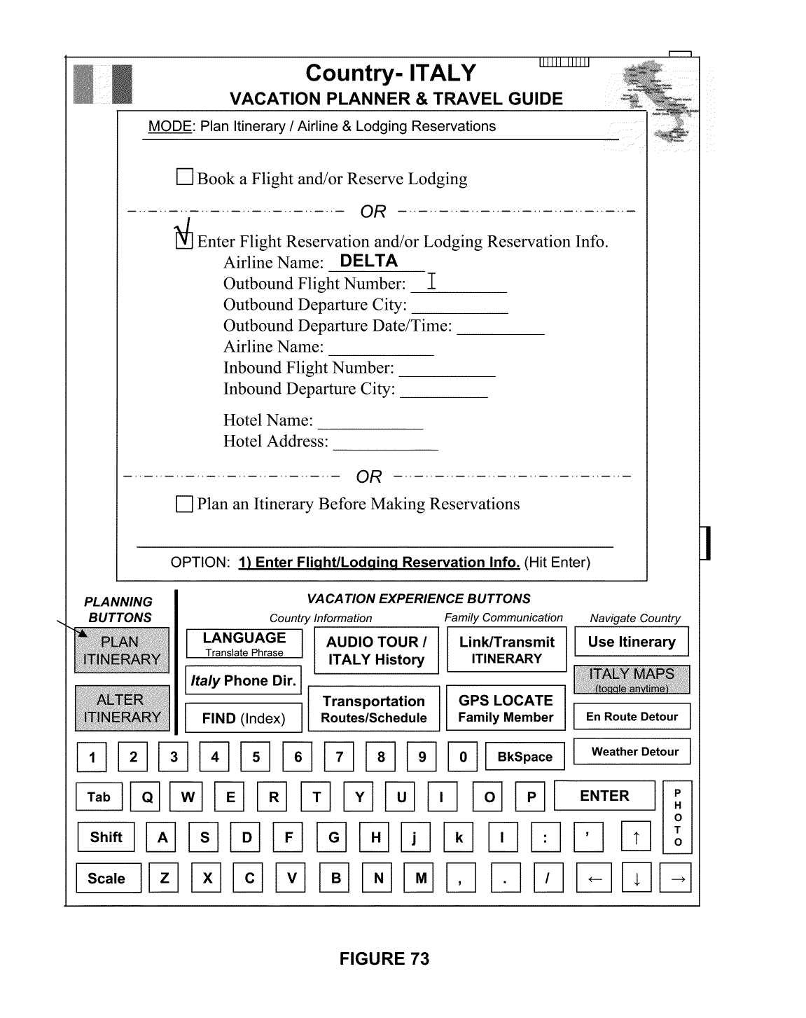

FIG. 73 merely illustrates, on its display screen, another way to access the previously discussed functionality. The first option, to make an airline reservation for a flight to and from the destination, may direct the user to those options shown within FIG. 28-29; and to make a lodging reservation at the destination, it may direct the user to those options shown within FIGS. 30-34. The second option in FIG. 73, which is shown as having been selected by the check-mark, merely illustrates the information box that may be accessible using the second option in FIG. 28, to “Key in Reservation Info.” This may, as previously noted, cause the displaying of the flight/lodging information within the itinerary sequence, as seen in FIG. 34. The third option in FIG. 73 may direct the user to options found in FIG. 2 for toggling of the “Plan Itinerary” button, or to other options disclosed hereinafter.

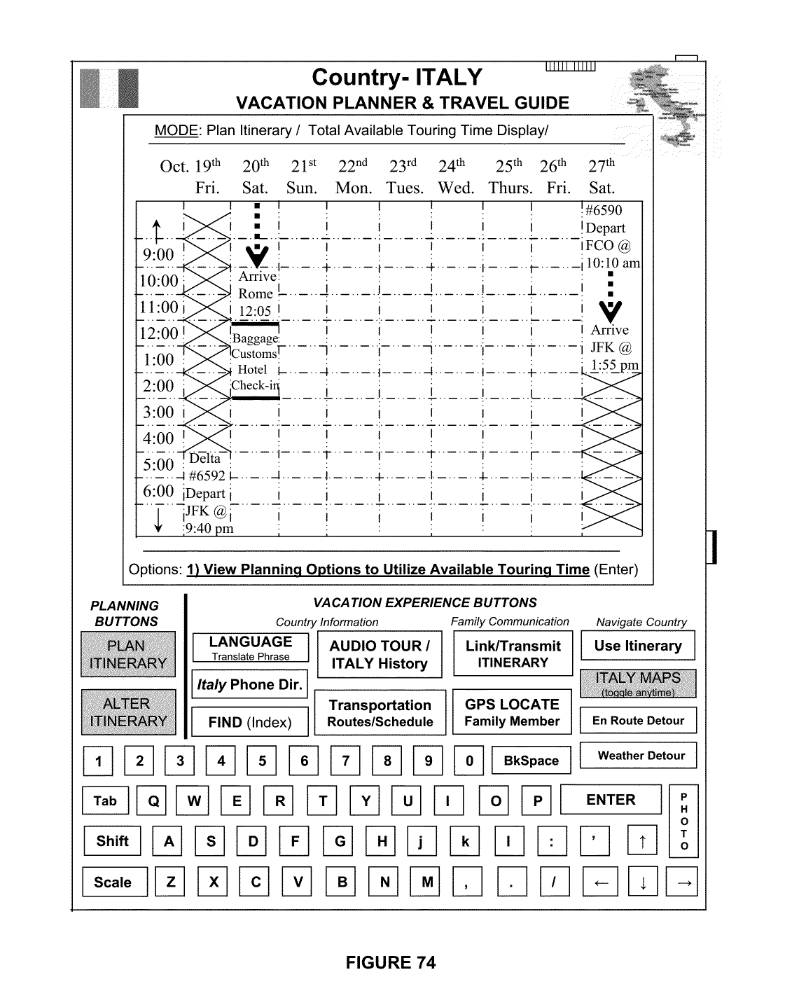

FIG. 74 shows an alterative display of the itinerary listing found within FIGS. 5A, 34 and 44, and may be a block-like presentation, in the form of an “hourly” calendar planner. The calendar planner need not necessarily be limited to displaying one-hour time blocks, and may also show half-hour blocks, or one-quarter-hour blocks, or a block representing any other incremental time period that may be useful to the traveler. The airline and lodging reservation information that may have been obtained online using the present software or that may have been keyed in manually, may be displayed in the appropriate time-slots (blocks of time) for both the outbound and inbound departures, as seen for “Friday” and “Saturday” in FIG. 74. Where multiple reservations are necessary and have been made for lodging, each may be represented with a notation within the time block of the day where it may be appropriate to check-in at such lodging. For the example in FIG. 74, there is only one lodging reservation. Although the name of the lodging does not appear in the time blocks for “Saturday” in FIG. 74, this may merely be a constraint of the size of the display screen and the total amount of information that may need to appear therein. The user may have the option to select a particular day to view the daily itinerary in full, including all relevant information for that day, which may otherwise be condensed by being abbreviated or omitted in the main itinerary displayed on the screen. It should also be noted that the software of the present invention may account, in the itinerary for the arrival day, for the possibility of a flight delay, for delays in passing through customs, and for traffic delays in reaching the hotel to check in to be relieved of the burden of transporting luggage. Thus, the blocks of available touring time on the arrival day (or first couple days) may preferably be utilized for the touring of sites of interest that have a lower priority, because of the potential for such delays, and because of the fatigue (jet-lag) that may be experienced by the traveler early in the trip, as discussed later in the specification.

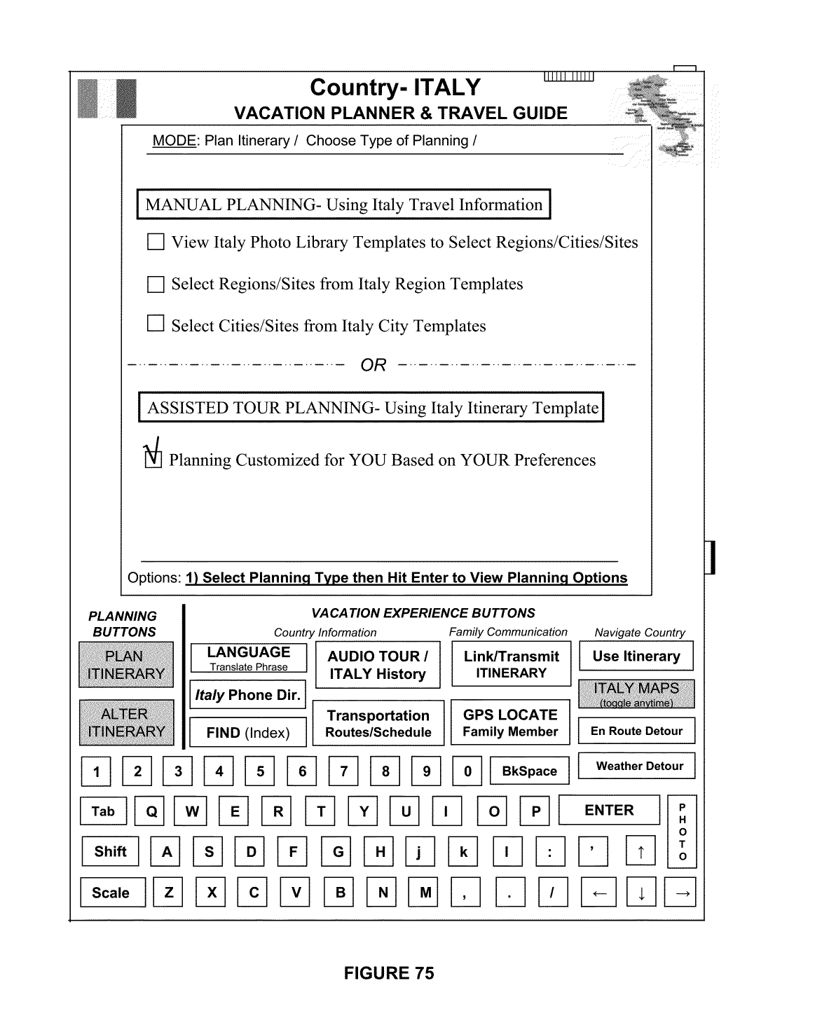

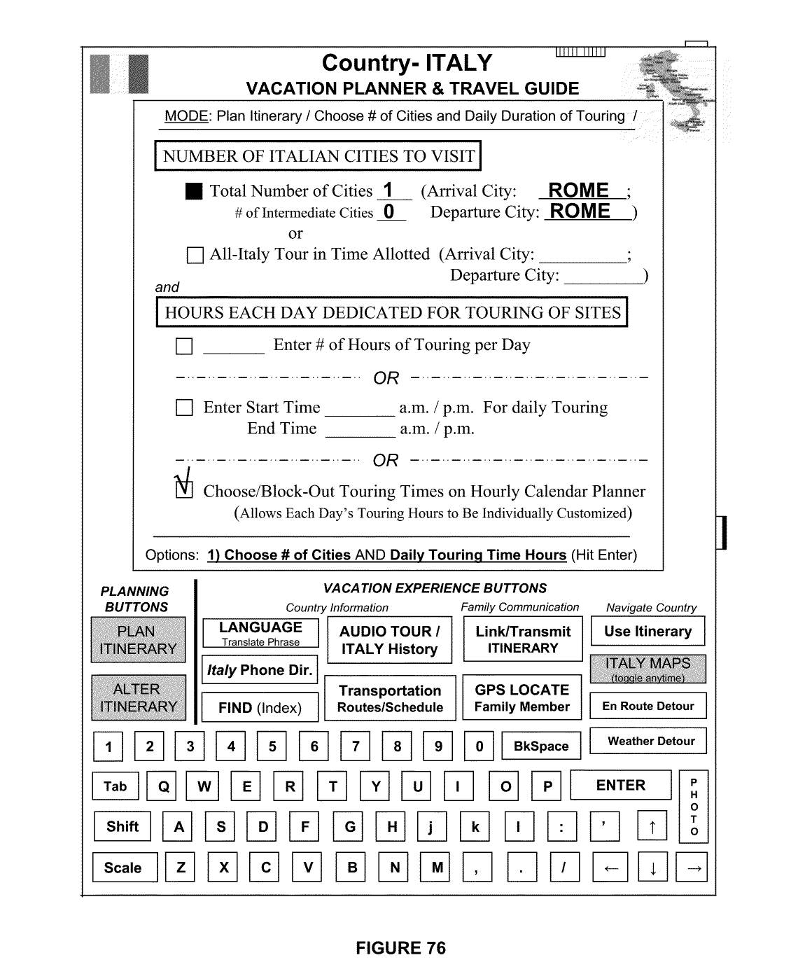

FIG. 75 shows an onscreen display that is simply another way to organize the templates described at the beginning of the specification, and may again offer the manual planning options and assisted tour planning options using templates, which were both shown in FIG. 2. With the manual planning options in FIG. 75, the user may begin planning by viewing a photo library in order to select regions and/or cities of the destination country that he/she may desire to visit, or may instead select regions or cities directly for inclusion in the itinerary, as shown previously in FIGS. 13 and 7, respectively. The bottom option in FIG. 75, for “Assisted Tour Planning,” may direct the user to the display screen of FIG. 76.

The top portion of FIG. 76 includes the same travel criteria that may be seen in option (c) of FIG. 3, except that in this example, there is no need to key in the number of days, because it is a default of the flight reservation information that was already entered. The arrival city and departure city of “ROME” may also appear therein as a default of the flight reservation, with the total number of cities defaulting to be “1.” Merely to be exemplary for a trip only to the city of Rome, the total number of cities has been left unchanged therein as “1.” However, had a traveler wished to see several other cities in Italy with the trip beginning and ending in Rome, a total number of cities desired for the itinerary may have been entered to replace the default of “1.” Also, had the traveler instead made and inputted an airline reservation to fly into and out from different cities, such as the Rome arrival and Milan departure for the itinerary of FIG. 29, the “Total Number of Cities” in FIG. 76 would have defaulted to “2,” which could thereafter be increased, by the travel planner selecting a number of intermediate cities to visit, as discussed earlier in the specification.

The option in FIG. 76 being just below the “Total Number of Cities,” is for an “All-Italy Tour in Time Allotted.” This “All Italy . . . ” tour template may be an overall geographical template, with the top level being a destination template (an All-Italy template) that may be subdivided into regional templates (Northern/Central/Southern, or Tuscany/Umbria/Veneto/ . . . ) or into metropolitan templates (RomeNenice/Florence/ . . . ), any of which may be selected and weighted, as discussed hereinafter. In contrast to the geographical templates, durational templates may also be selected, as discussed hereinabove with regard to the total time in-country in days or days and hours, or with a start date/time and end date/time. The inputting of the flight reservation information in the above example and the selection of a total number of cities, and the selection thereafter of particular cities may draw upon and be a combination of both geographical and duration templates. Subject-matter templates (site types/event types) may also be preferably selected during the planning herein, and planning by the current invention will typically utilize two or all three of the template types—geographical, durational, and subject-matter.

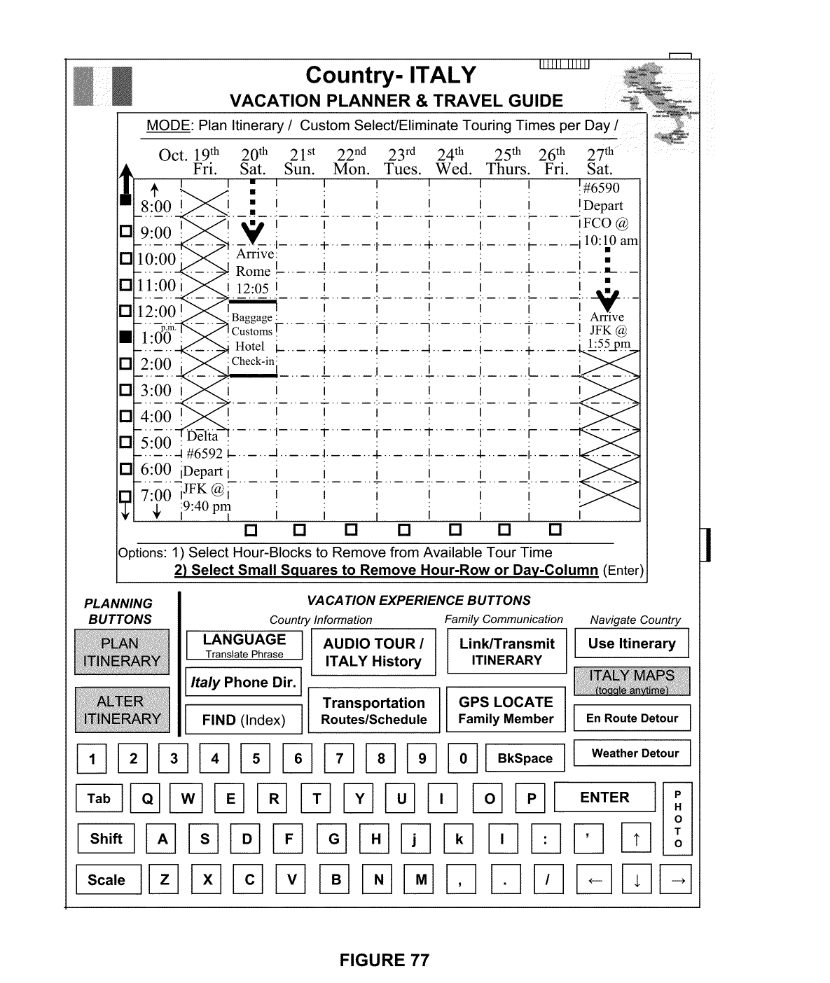

FIG. 76 also shows additional options displayed on the screen to choose the duration of daily touring for each day at the destination that is preferred by the particular traveler. The traveler may simply opt to specify the “# of Hours of Touring per Day,” which may leave the final selection of those specific touring hours during each day at the destination, to be chosen by the software, and may be thereby selected to be the best hours for touring, based on site hours of operation, etc. In addition, the travel planner may instead utilize the option of entering a particular “Start Time” and “End Time” for touring each day, to better agree with the traveler's normal daily routine (e.g., an early riser, versus one who sleeps in late and stays out late). Lastly, the third option therein that is shown with a check mark, permits the travel planner to be able to customize hours for touring each day by being permitted to “Choose/Block-Out Touring Times on an Hourly Calendar Planner,” which is illustrated initially in FIG. 77.

The hourly calendar planner in FIG. 77 shows the airline reservation information of the display screen for the article of FIG. 74, with the time periods before and after the flights being blocked out by an “X,” but additionally shows some of the available options for customizing the daily touring hours, to more advantageously be tailored according to the traveler's individual patterns of activity and inactivity. As stated in the “options” block in FIG. 77, the travel planner may simply select hour blocks to remove them from the available touring time periods. For example, if the travel planner prefers to always eat lunch between 1:00 and 2:00 every day, he/she may individually select those hour blocks to block them out (Note—alternatively, a restaurant template may be used to fill that hour block with a site at which the travel planner may choose to eat each day). To speed up the selection process for blocking out time, small rectangular markers may appear vertically staggered to be adjacent to each hour block, and may also appear horizontally below the column forming each day's hour blocks. So to block out the 1:00 to 2:00 time period for each day, the travel planner may simply select the rectangular marker to the left of that row, which is shown blackened in FIG. 77.

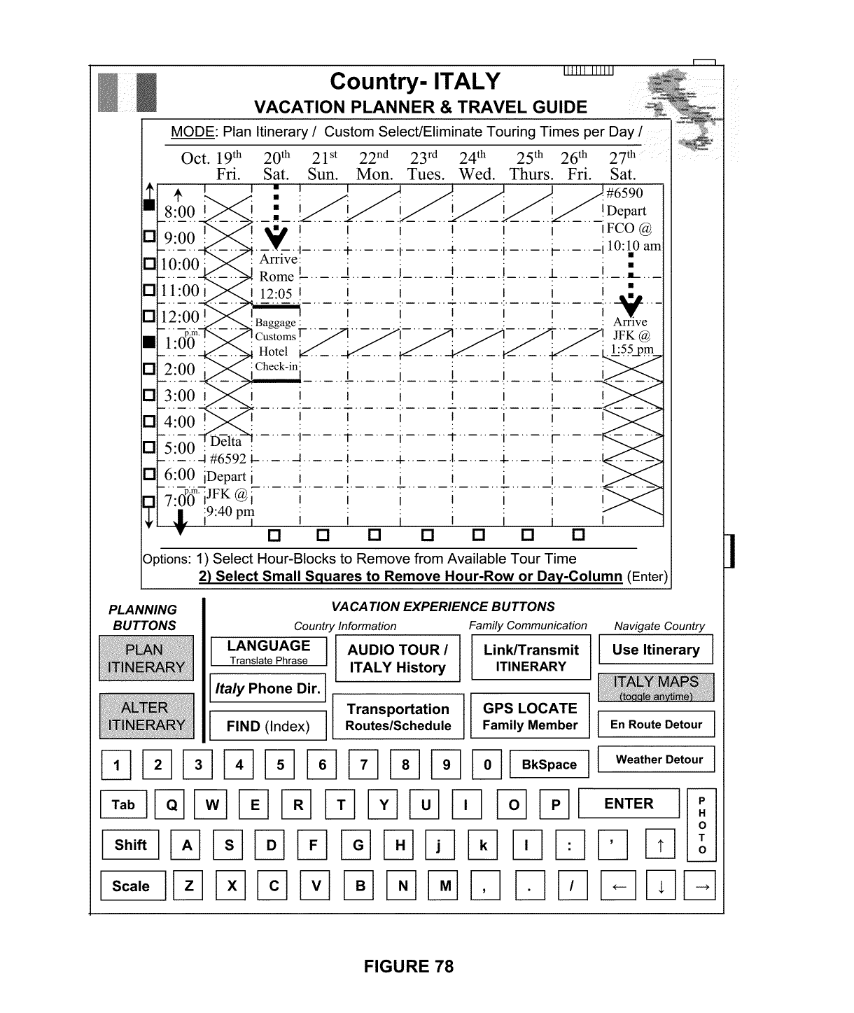

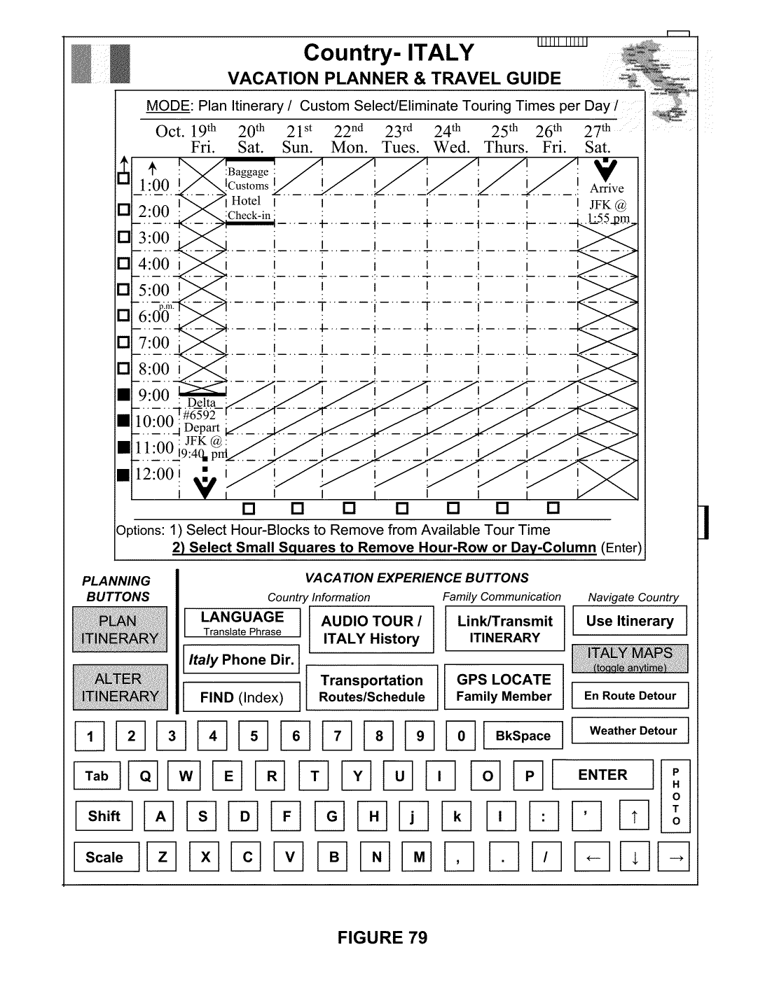

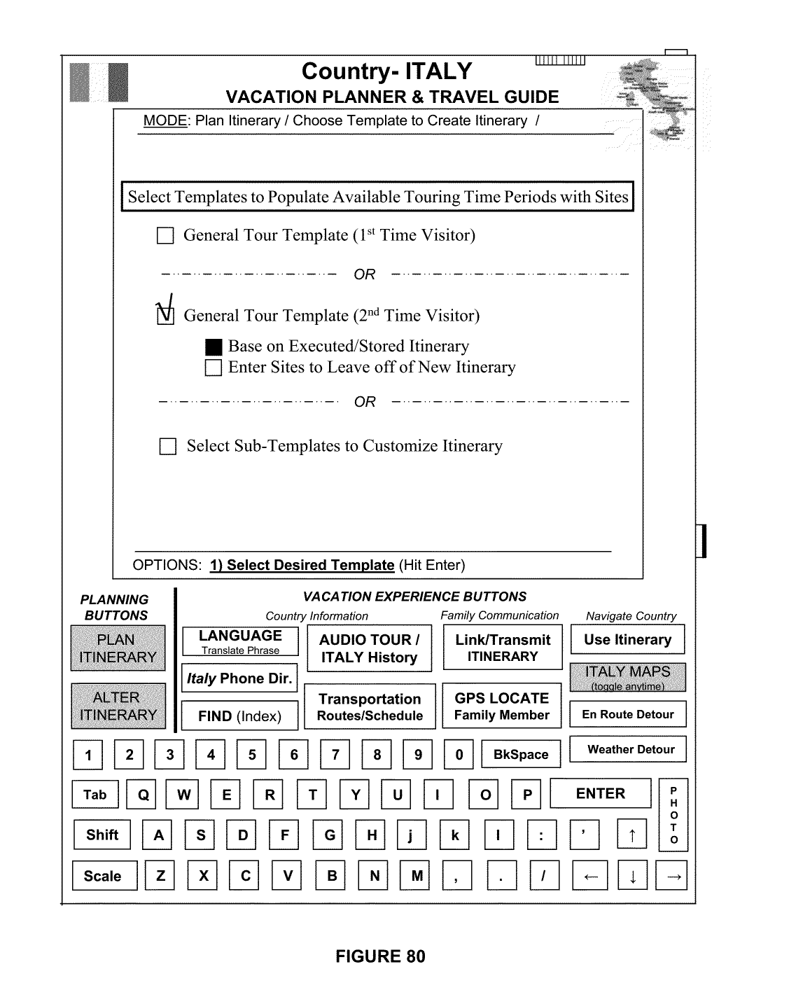

Also, to block out all of the early morning hours, the travel planner may select the rectangular marker next to “8:00,” and may also select the corresponding upwardly pointing arrow, which will block out all of the early hours preceding the “8:00” hour block. The blocked out hours may be illustrated using, for example, a forward slash, as seen in FIG. 78. FIG. 78 also shows the travel planner having selected the downwardly pointing arrow, below the lowest visible hour listing, the “7:00 p.m.” block, which may cause the display screen to scroll downward, to appear as seen in FIG. 79, to expose those hour blocks. The travel planner may individually customize availability of those hours, now that they are visible, or the travel planner may simply select the rectangular markers to block out all of the late evening hours each day (“9:00” to “12:00”) to remove them from the periods of available touring time, as shown in FIG. 79. Once the travel planner is satisfied with the hours that will be available for touring, the enter key may be depressed to proceed to the next planning step, which is illustrated in FIG. 80. The options in FIG. 80 permit the traveler to select templates, from which sites may be selectively extracted to populate those available periods of touring time, and/or to directly select specific sites of interest.

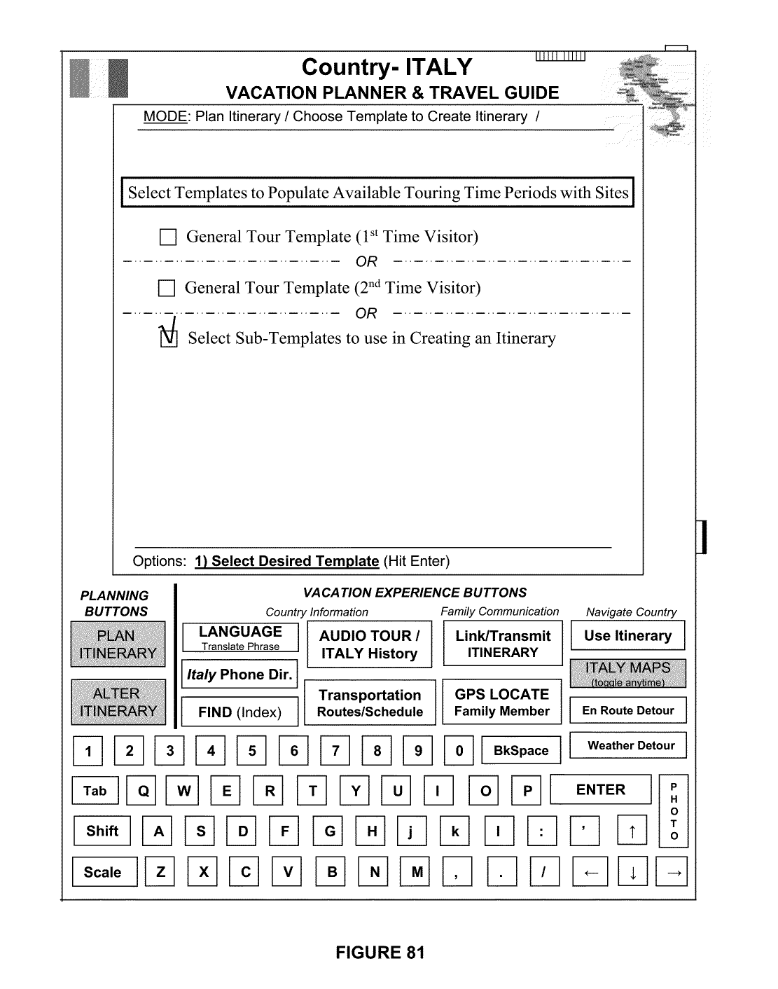

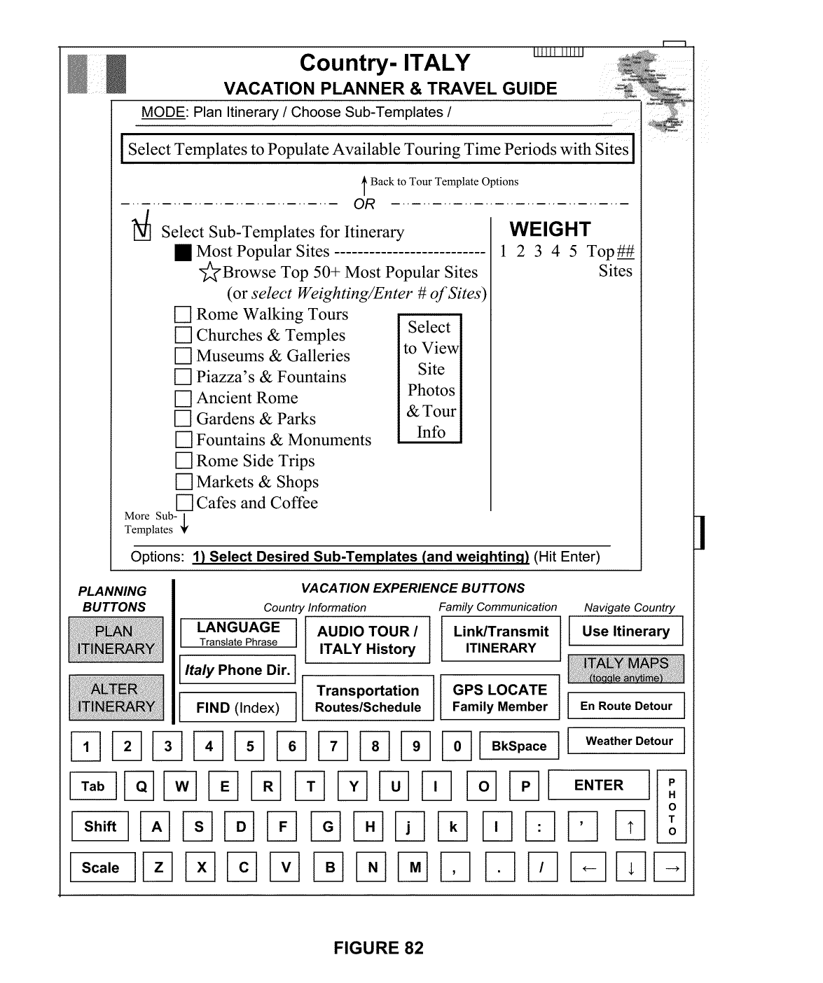

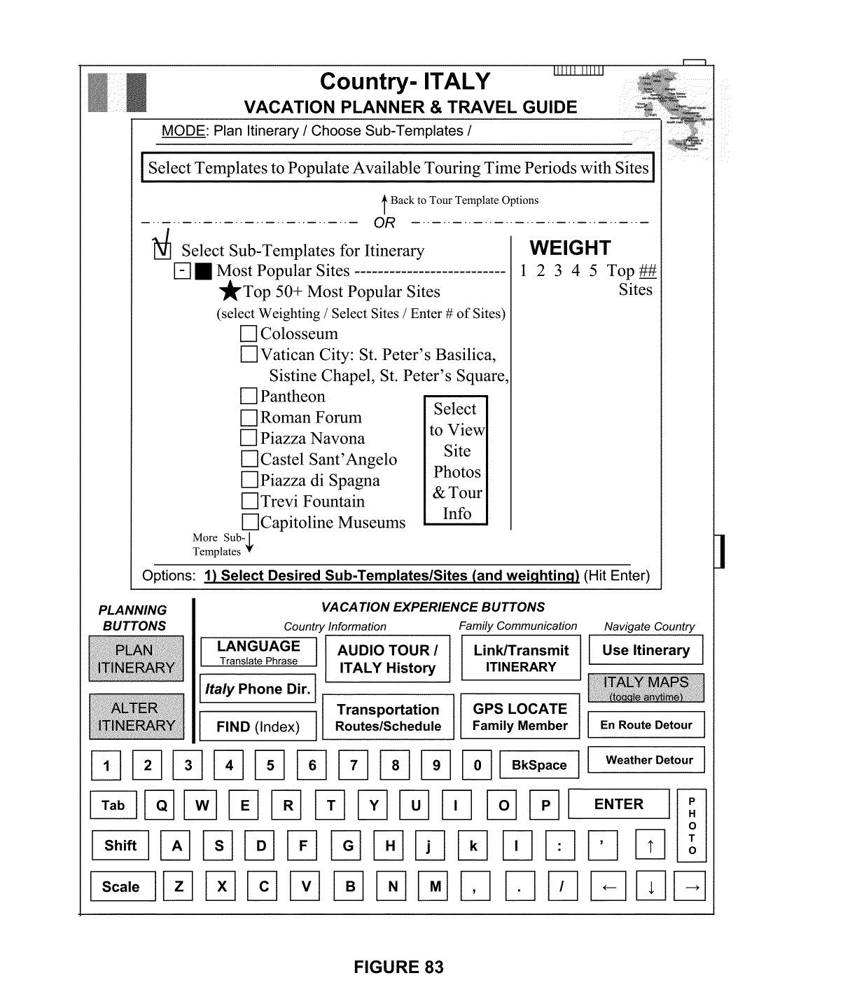

The first of the three options in FIG. 80 permit the travel planner to choose a general tour template, which may be tailored for the traveler who has little or no knowledge of the destination/country, and may be a first time visitor. Selection of the second option, which is directed towards a repeat visitor, may result in two subsidiary options being presented, where the new itinerary may be based upon a previously executed/stored itinerary, or where the user may simply select specific sites to leave off the new itinerary. FIG. 81 shows selection by the travel planner of the third option, “Select Sub-Templates to Create Itinerary,” which may result in the display of a partial list of templates or sub-templates that may be selected for their use in the itinerary currently being developed, as illustrated in FIG. 82, and which was previously illustrated in FIGS. 2 and 37. FIG. 82 shows selection by the travel planner, by the blackened box, of the “Most Popular Sites” template, which results in the display of several other options. The planner may select the star symbol in order to “Browse Top 50+Most Popular Sites,” which is shown in FIG. 83 by the listing, in order of popularity/significance, of those sites.

Another option found in FIG. 82 is a block that the user may “Select to View Site Photos & Tour Info.,” which may cause the display of site-specific information that may be needed by the planner to decide if he/she has an interest in that template, and/or wishes to specifically select certain sites therein to definitely be included in the itinerary, which is illustrated hereinafter. If the travel planner first wishes to view some of those sites within the “Most Popular Sites” template, he/she may select the star symbol next to the template name, and, as seen within FIG. 83, it may thereafter be blackened (filled-in), and the template title may be followed by the display of the list of the sites therein (e.g., Colosseum, Vatican City, Pantheon . . . ). Each listed site may also have a corresponding box outline that may permit individual selection of sites therein—selection of the top sites (top 5, or top 7, or top 12 sites, . . . ), or the selection of any particular sites of interest to be included in the itinerary, not necessarily being inclusive of the earlier sites within the listing (e.g., only selecting the Pantheon (#3), Piazza Navona (#5), and Trevi Fountain (#8)).

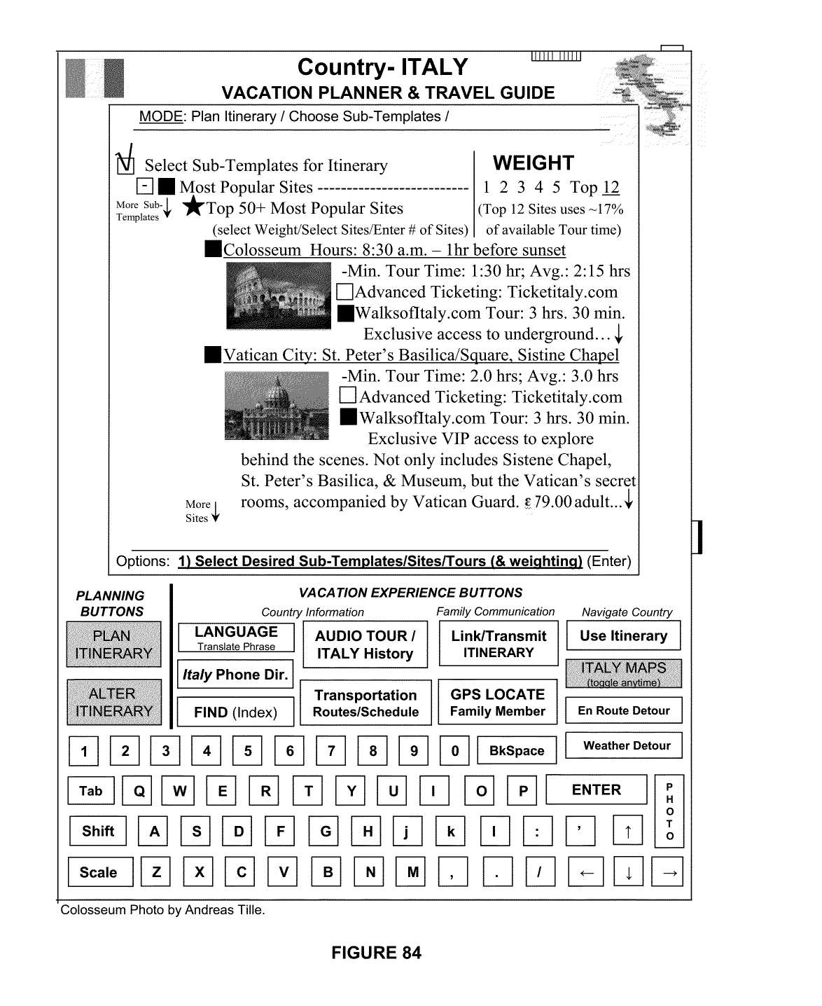

If the travel planner decides to toggle the block in FIG. 83 to “Select to View Site Photos & Tour Info.”, the system may cause the display of information that may be useful to the planner in deciding whether or not to select specific sites, as illustrated in FIG. 84. In addition to listing information about the site itself (e.g., origin/history . . . ), the hours that the site may be open to the public may also be listed, along with suggested amounts of time that may be needed to see the site. Also, advance ticketing for access to the site may be available from certain ticket outlets/companies, which may be listed therein (e.g., Ticketltaly.com), and many sites may also have specialty tours associated with them that may be provided by private tour companies, such as the three hour and thirty minute tour of the Colosseum offered by WalksofItaly.com. The travel planner may simply select the block next to the “Colosseum” listing to guarantee its inclusion in the travel itinerary, with the block thereafter being blackened to show it has been selected. In addition, the travel planner may select the website for the specialty tour company, and thereafter the software may open an internet window for the planner to purchase those tour tickets. If the travel planner decides to wait to actually purchase the tickets until a later date, possible just prior to departing to, or just after arriving at, the destination country, to assure safe travel and good weather, the specialty tour selected by the travel planner may simply be noted in the final itinerary listing that is developed, with a reminder therein that availability may not be guaranteed by that tour company, and that the traveler still needs to purchase those tickets.

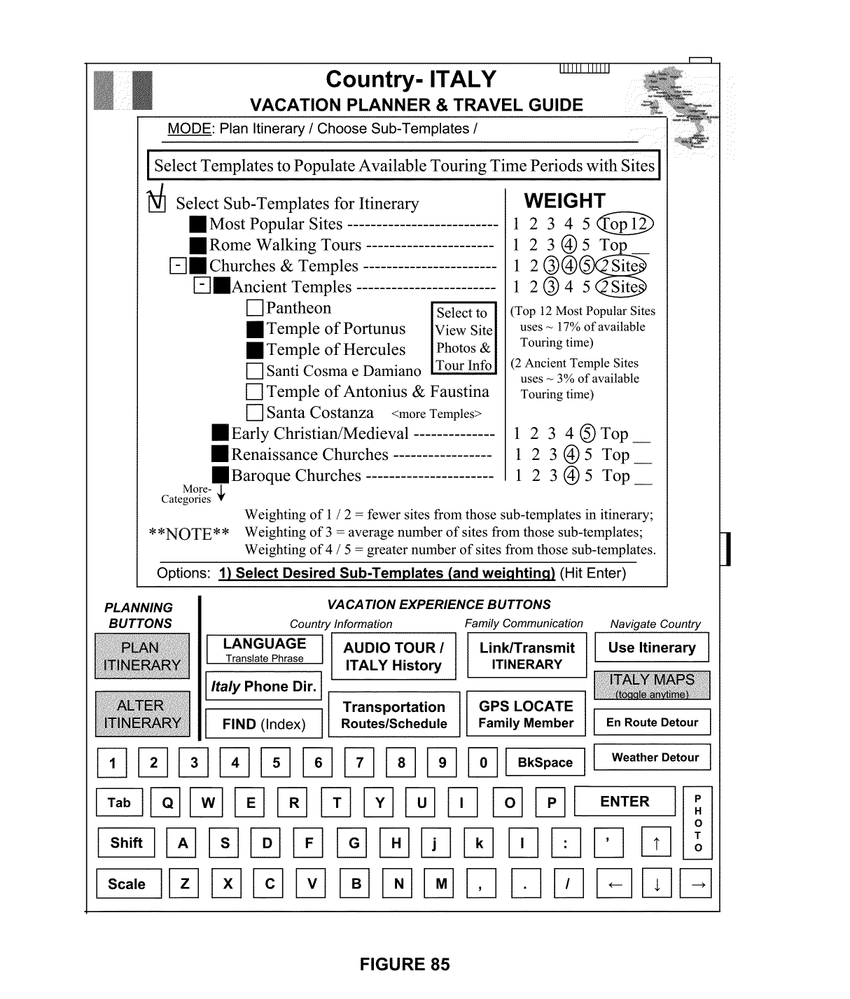

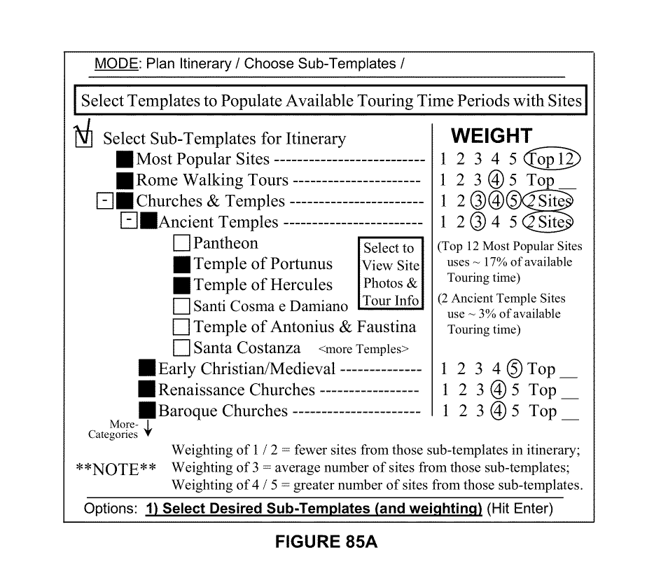

The travel planner may go through the listing of sites within the “Most Popular Sites” template and choose all the sites therein that are of interest to him/her. In the example in FIG. 84, the user has selected 12 sites from the template for inclusion in the itinerary, which happen to be the first 12 sites listed therein—the “top 12.” The software may indicate the number of sites chosen, under the “WEIGHT” descriptor, and may also inform the travel planner of the percentage of the available touring time that the number of sites chosen may roughly utilize (e.g., 17% for this example), as seen in FIGS. 84 and 85.

FIG. 85 also serves to illustrate the effect of the relative weight factor that may be selected by the user, upon the selected templates from which the software is to draw sites from, to populate the traveler's custom itinerary. In FIG. 85, the travel planner has selected the “Rome Walking Tours” template, and also assigned it a weight factor of 4. (Note: the relative weight factor is shown therein as being a number from 1 to 5, but other ranges of values could also be used instead, where advantageous, such as a range of 1 to 3 where the number of days in the itinerary is very short, and a range of 1 to 10 where the number of days in the itinerary is longer; also, although shown as a whole number, the relative weight factor could involve the use of fractions of decimal numbers, such as, for example, a factor of TA, or a factor of 1.5).

As the travel planner continues to select additional templates and assigns corresponding relative weight values, this provides a principle basis for the quantity of sites that will be used from one selected template, relative to the quantity of sites that will be used from another selected template. For example, if the user had selected the “Churches & Temples” template (and no specific sites therein) and assigned it a relative weight of “1,” this would indicate the relative significance to that traveler of the ordered list of sites therein as compared to the sites in the other weighted templates, and so the software would seek to roughly utilize four times as many sites (or four times as much time utilizing sites) from the “Rome Walking Tours” template, having been assigned a weight of “4,” as the sites from the “Churches & Temples” template, having theoretically been assigned a relative weight of “1.” The ratio of the number of sites in the final completed itinerary may not be exactly 4:1, due to the confluence of other factors discussed in detail hereinafter, but it serves as a foundation for the itinerary planning because it reflects the traveler's current relative interest in tour sites at the destination. One such other factor is the fact that sites may appear in more than one template. For example, the Pantheon was built as a temple to all of the gods of ancient Rome, and was later converted into a Roman Catholic Church, but it is also one of the most popular visitor sites in Italy, and hence appears in both templates. (Note—where only geographical templates may have been selected—e.g., selection of the regions of Tuscany, Umbria, and Veneto—and have been assigned a relative weight factor, the software may plan the itinerary based on only such input, and may default to allocation into the available periods of tour time, of the most popular sites in those regions).

FIG. 85 also illustrates another feature of the present invention whereby the user may select specific sites from a sub-template for inclusion in the itinerary, and may also concurrently indicate a relative weight factor for that entire sub-template. In FIG. 85, the travel planner has selected two of the top three sites in the “Ancient Temples” sub-template, as they may have been recommended and may therefore have a great interest for the person, but the person may possibly wish to see more ancient temples not yet familiar to him/her, and may thus also assign a weight factor to that entire sub-template, in order for the program to consider additional sites therefrom, if the available touring time so permits. Therefore, as seen in FIG. 85, the travel planner has also assigned a relative weight factor of “3” to the “Ancient Temples” sub-template.

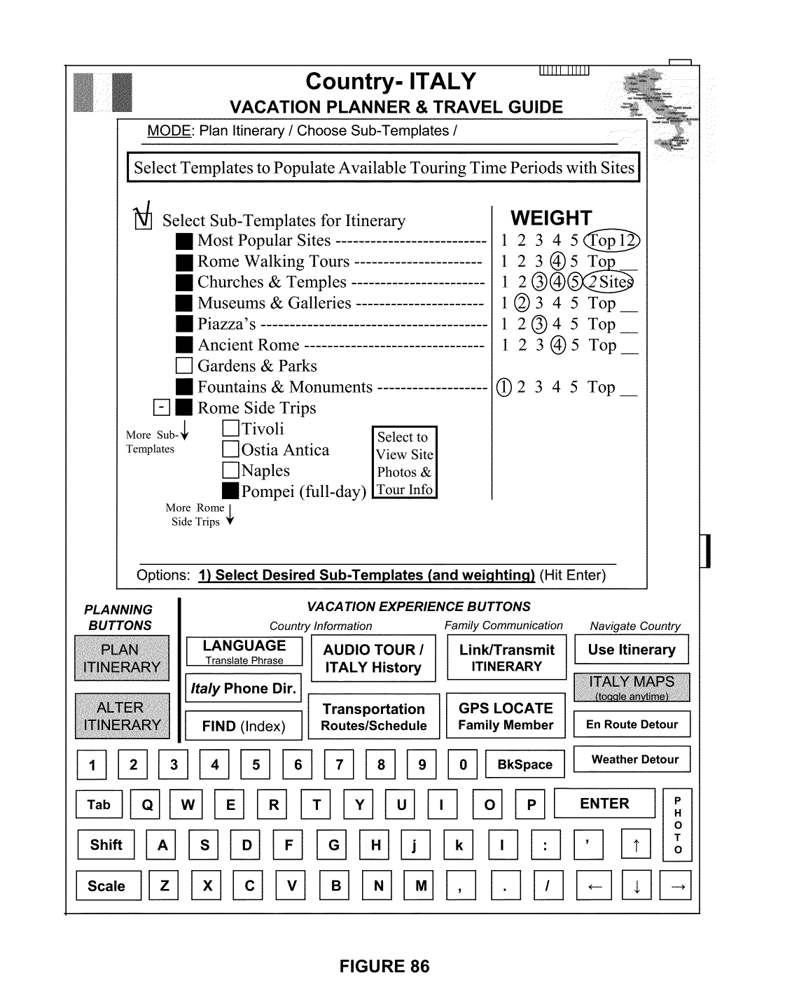

The system may verify those selections from the “Ancient Temples” sub-template for the travel planner, by encircling the assigned weight factor in the “Weight” column, and by the numerical indication of the specifically chosen sites with the “2 Sites” indicator also being encircled therein. The travel planner may also have selected the “Early Christian/Medieval,” the “Renaissance Churches,” and the “Baroque Churches” sub-templates, and have assigned a relative weight factor of 5, 4, and 4, respectively, for those sub-templates. The main template-“Churches & Temples”—may indicate that sites and/or weights have been assigned for various sub-templates, by showing all of those encircled choices, which may be helpful to the travel planner after the sub-templates are no longer being displayed (see FIG. 86), the display of which may be controlled by the user selecting the box with the minus sign (“−”) next to the template/sub-template name.

FIG. 85 also illustrates another feature of the present invention whereby when the user may have an interest, for a particular trip, in only the sites contained within a single itinerary template or sub-template, perhaps the “Ancient Temples” sub-template, he/she may specifically select all of the sites of interest therein and apply a weight factor to them, for the software to create the itinerary sequence solely therefrom.

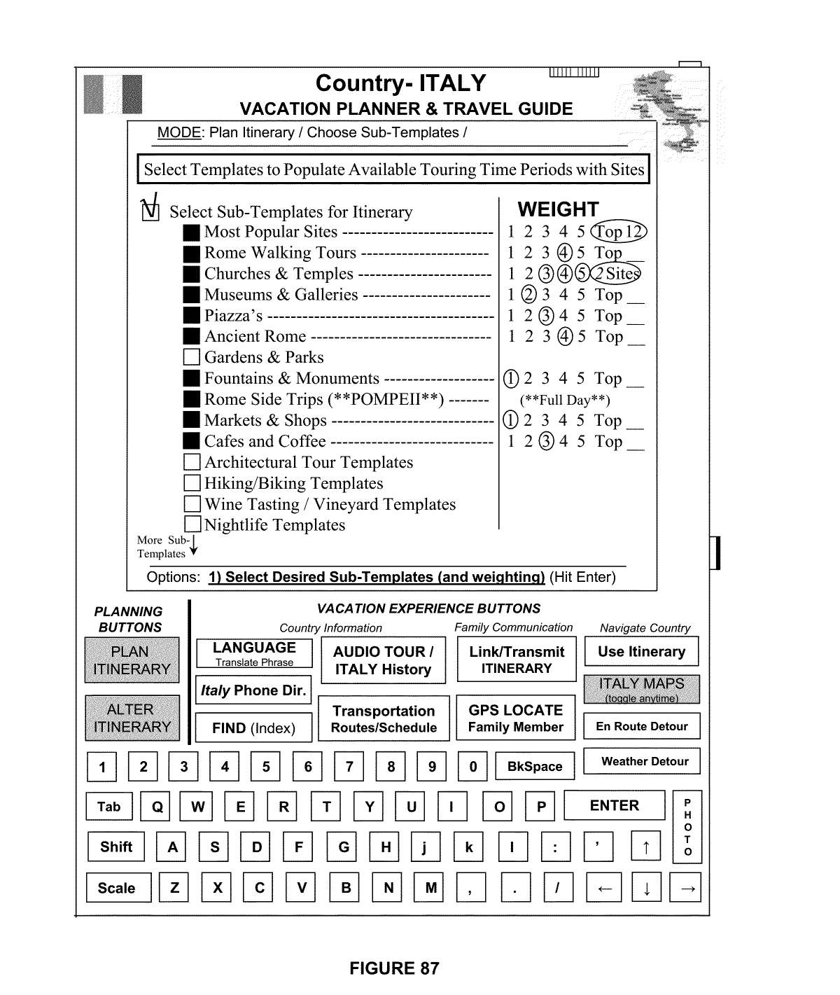

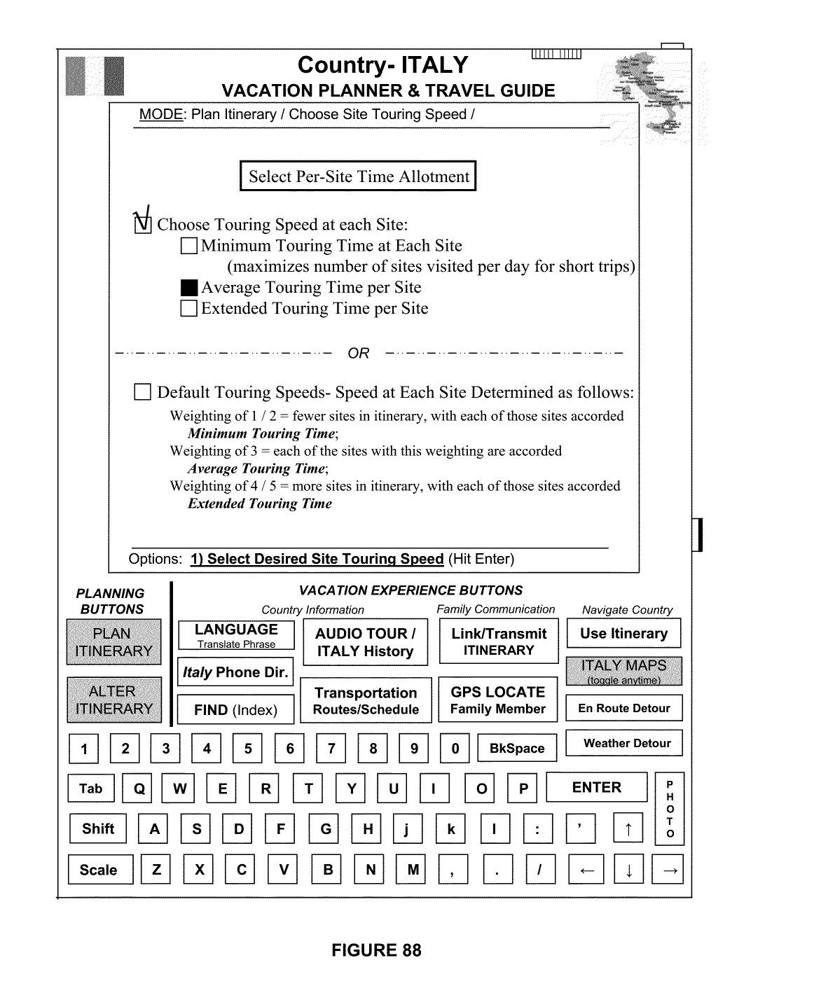

FIG. 86 is a view of the partial template/sub-template listing within the display screen, but also shows the travel planner having selected the “Museums & Galleries” sub-template, the “Piazza's” sub-template, the “Ancient Rome” sub-template, the “Fountains and Monuments” sub-template, and the “Rome Side-Trips” sub-template, and having assigned corresponding weight factors, as well as having selected “Pompeii” from the “Rome Side-Trips” sub-template. The Pompeii trip from the “Rome Side Trips” template, because of the travel time necessary, requires allocation of an entire day of the itinerary, and is thus shown in the listing in FIG. 87 without a weight factor, because its inclusion won't be weighted relative to other sites from selected templates that will eventually populate the remainder of the complete itinerary. However, the “Pompeii” sub-template may itself have other sub-templates or sites listed therein, which may be selected and assigned a weight in order to choose the sites listed therein for the planning of that single day, which will necessarily take up one of the six full days in the itinerary in the present example. Once the travel planner has selected and weighted all of the templates/sub-templates that are desired for constructing the itinerary, he/she may depress the enter button to proceed to the next planning step, which is shown in FIG. 88.

FIG. 88 provides further options for the travel planner using the software of the present invention to tailor the total number of sites selected for the final itinerary, by being given options to “Choose Touring Speed at each Site,” which is the user's customary touring speed (amount of time that should be allotted to each of the sites that will be allocated from the sub-templates into the periods of available touring time). The first of two principle options therein permits the traveler to opt for a minimum touring time to be allocated for touring at each site, or an average time, or an extended time for touring at each site. Some travelers may prefer to take a cursory walk through and around a site, to get a sense of it, and to maybe take a couple photographs, thereby using a “Minimum Touring Time at each Site.” Similarly, some travelers may be on a business trip at the destination, and decide to extend their stay for a short period of time to try to see some sites, and may thus be somewhat limited in the total time allotted for touring, but nonetheless wish to see a lot in the short amount of time, and thus may need move quickly from site to site, thereby also seeking to use a “Minimum Touring Time at each Site.”

Yet, other travelers may be on a lengthy vacation, or may just be the type of person that prefers to linger, to examine every nook or corner or object at a site, to read about its history while therein, and possibly to take an extended private tour of the site, and would therefore need to allocate an “Extended Touring Time per Site,” even if it meant seeing fewer sites throughout the entire trip. Of course, many travelers may fall in-between those two scenarios, and may wish to spend an “Average Touring Time per Site,” possibly long enough to take some photographs, to look around at the major points of interest, and possibly long enough to use one of the moderate-length audio tours of the present invention.

The second one of two principle option in FIG. 88 provides an alternative to accepting a blanket per-site time category/allotment for each of the sites used to populate the available tour time periods of the itinerary. The “Default Touring Speeds . . . ” option permits the travel planner to accept a default touring speed that may more advantageously correspond to the relative weight factors that he/she had selected for particular templates. This may be more closely in line with the traveler's preferences, because the default will seek to allot more time for the sites that the traveler has identified as having a greater interest in (higher relative weight factor), and less time for those sites the traveler may only be mildly curious to see (lower weight factor). So in using this option, where a travel planner had assigned a weight factor of “5” or “4,” the sites from those templates may generally be accorded an extended amount of time, and where the planner had assigned a weight factor of “1” of “2,” the sites from those templates may generally be accorded a minimum amount of time. Sites from a template that had been assigned a weight factor of “3” may be assigned an average amount of touring time.

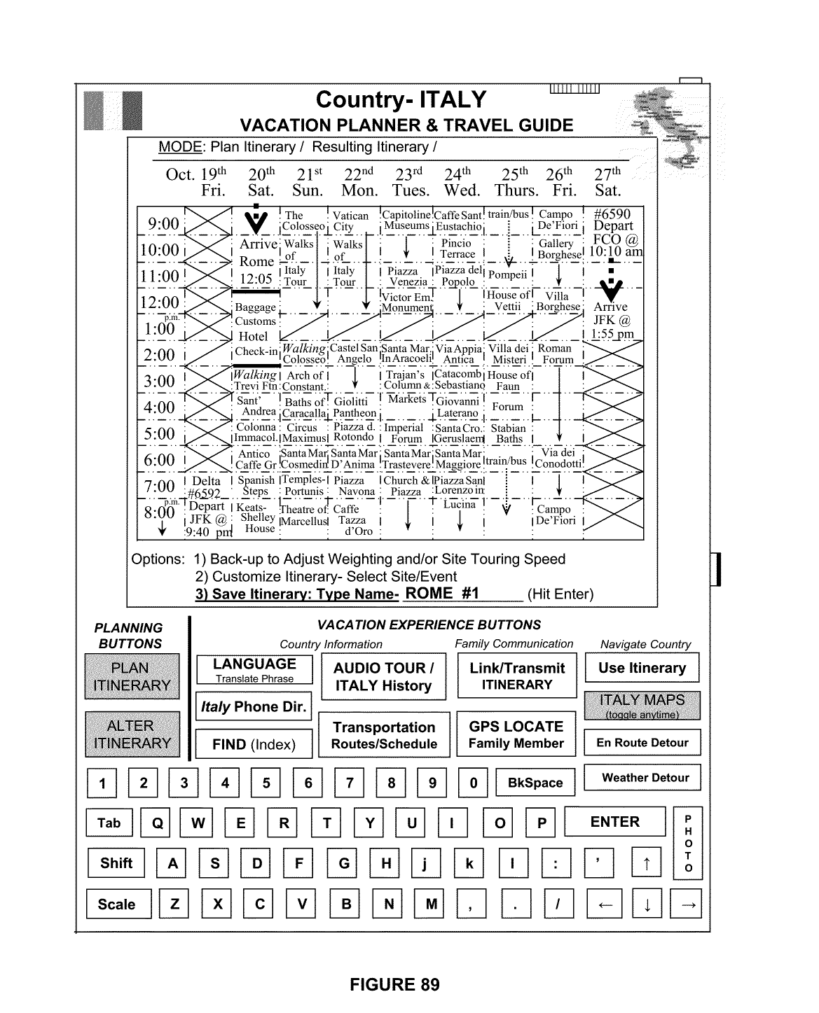

Once the travel planner has selected the desired option for the touring speed at the sites to be allocated, and depressed the enter button, the software of the present invention may perform the work of sorting through all of the potential sites of interest to the user and of allocating those sites into the available blocks of touring time according to the user's preferences (e.g., based on any specifically selected sites, on the selected templates, on the assigned weight factors, etc.), and according to a hierarchy of rules to improve the user's ability to better execute the competed itinerary at the destination. FIG. 89 illustrates an example of a complete itinerary produced in accordance with the selections made, to maximize utilization of the traveler's time at the destination.

As seen in FIG. 89, the complete itinerary that was produced may be saved, as shown by option 3 therein, using the name “Rome #1.” The travel planner, after reviewing the itinerary may also decide to customize it by adding, deleting, or replacing sites therein, or by requesting other changes in accordance with enhanced itinerary modification features discussed hereinafter.

The hierarchy of rules used to allocate sites from the templates/sub-templates into the available touring time periods may be directed to considering various different priorities. Of course, a high priority would be the travel planner having specifically selected particular sites and having selected a specialty tour for one or more sites. These sites would definitely be included in the completed travel itinerary, and would be accorded a higher priority placement within the one or more periods of desired touring time. Although each period of time identified by the travel planner as being available for touring at the destination is valuable, within those blocks of available time, shown by FIG. 78, certain blocks are more important than others, and would thus receive those higher priority sites. For example, because of the potential that the traveler may experience a delayed inbound flight, a customs delay, a traffic delay in getting to the intended lodging location, and possibly a delay at the lodging location to actually get checked-in, the available touring time periods on the arrival day, even after having added a safety time buffer, may still be attributed as a lower priority placement time period for higher weighted sites. Also, the second day at the destination, while having a slightly higher priority for placement of higher weighted sites than the arrival day, may still not be as high a priority for placement on the second day after arrival, because the traveler may still be experiencing jet lag, and may therefore not appreciate those sites as much as he/she would when more fully rested. Additionally, the last day at the destination may also be attributed as a lower priority placement time period for higher weighted sites because of the possibility of unexpected events that could cause the site to not be experienced fully or at all, such as a car accident on the way to the site, or the person becoming ill and not being up to touring/traveling, etc. If the site is scheduled earlier in the itinerary than the final day, there would always be the possibility for seeing it later in the trip. The length of the itinerary is also important, because the shorter the stay at the destination, the less significant this prioritization becomes. For a three-day stay at the destination, the highest priority day would likely be the second day, for the some of the above stated reasons, despite the possibility of jet lag. For a two-day stay at the destination, the significance of the priority becomes further diminished due to competing factors.

So placement of sites into the available touring time periods may depend upon the weight factor of the selected templates, the positioning of one or more available time blocks in the total duration of stay at the destination that may provide a sufficient amount of time for the site to be experience according to the traveler's selected per-site time requirement (minimum time per site, average time per site, or extended time per site), as well as the order in which the site appears in the list in the template (see e.g., Table 2: Rome Churches & Temples Sub-templates, where sites appearing closer to the top of the list are more preferentially allocated into the available time blocks of the itinerary).

Other factors that may affect site placement within the one or more blocks of available touring time may be a close physical proximity between at least two of the sites to reduce site-to-site transit times, the hours of operation for each of the sites when they may be open to the public, the proximity of sites to the intended lodging location, and their overall geo-spatial position that may facilitate particular groupings of sites on particular days.

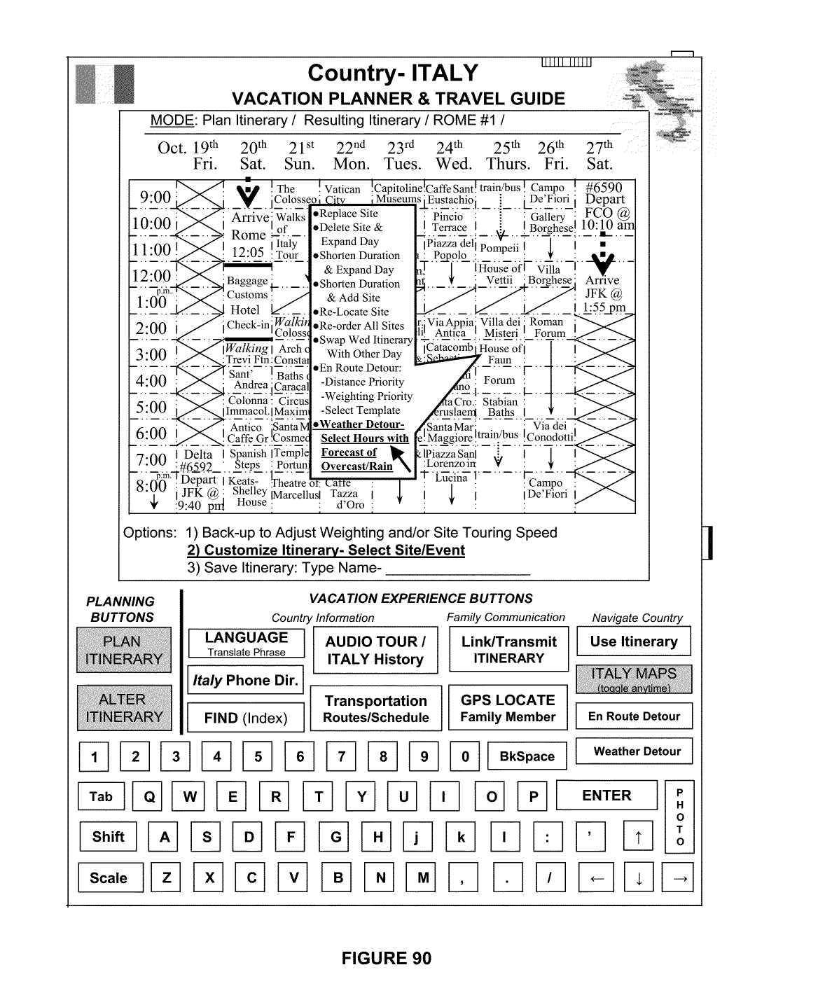

Another factor, for which the current invention offers a unique approach for supplying a personalized itinerary configured to maximize the traveler's experience according to his/her own preferences, concerns the forecast for, or actual arrival of, bad weather during one or more of the periods of available touring time. If at some point before the traveler has departed for the destination, he/she becomes aware of a forecast for bad weather for one or two days during the trip, the itinerary may be adjusted to nonetheless optimize the traveler's experiencing of tour sites. The traveler may input such information as a weather detour, using the “Weather Detour” button located on the right side of the Vacation Experience Buttons of FIG. 89. The traveler may also input such weather related information, as seen in FIG. 90, while at the destination, by accessing it as a menu option, which may help to initially target the affected hours more directly.

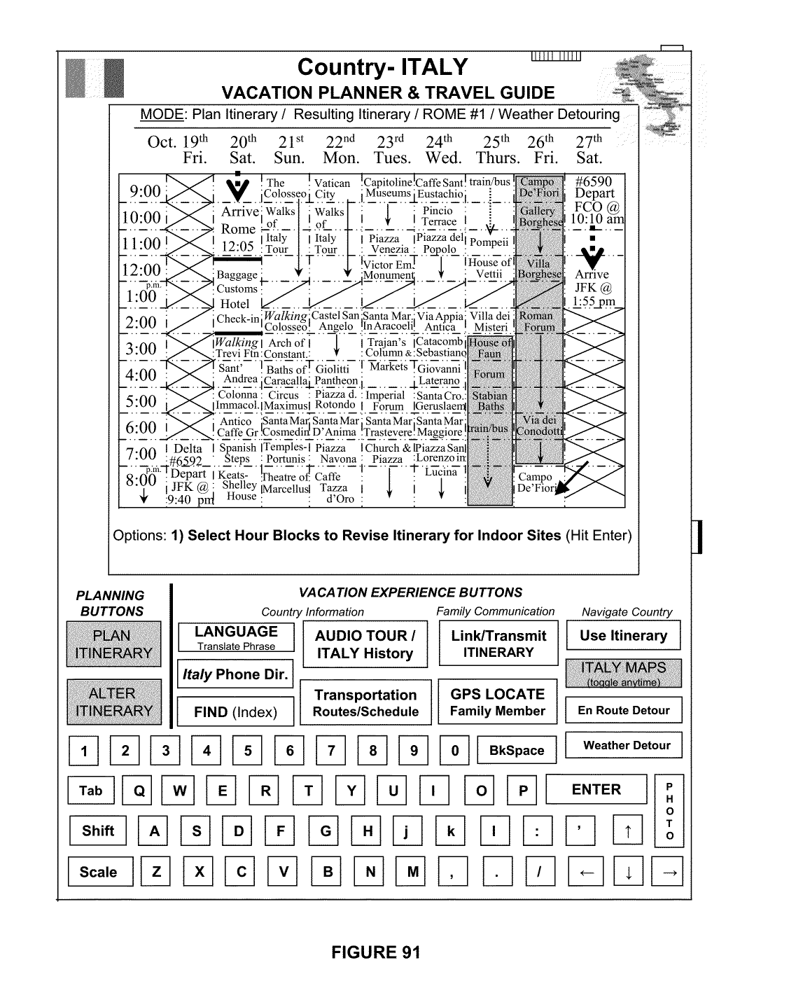

In FIG. 90, the traveler planner has selected the “3:00” block on “Thursday” of the display, which results in a menu window offering a number of ways to alter the itinerary. With the intent of inputting weather information to alter the itinerary, the user selects the “weather Detour” option therein, which may immediately cause that block of time to become highlighted, as seen in FIG. 91, indicating that overcast or rainy weather, which is not conducive to outdoor touring, can be expected at that time. The travel planner may be given the option to continue selecting blocks of time that may be similarly affected (Note, the vertically and horizontally staggered rectangular markers that appeared in FIG. 77 for use in blocking out touring time, may also be used here to identify the periods of bad weather). In FIG. 91, the user has selected all of the remaining time after 3:00 on Thursday, and all of the available touring time periods on Friday—being in the process of selecting the final “8:00” to “9:00” period—to be designated as forecast for foul weather. Once all of the touring time periods that are going to be affected by the weather have been selected, the user may hit the enter button, and the software may work to reform the itinerary according to the inputted weather detour information. If, for example, the user inputs the weather detour information on “Tuesday” while at the destination, then the reformation would be limited to the blocks of time thereafter, which will be assumed for this example.

The reformation, in addition to depending on the time periods identified as subject to bad weather that would impair enjoyment of any outdoor activities, may also be rearranged/reallocated in accordance with a degree to which each of the sites in the selected itinerary templates may be categorized as being an “outdoor” site or an “indoor” site. The sites in Table 2 are shown therein with a rating, in terms of a percentage to which they may fairly be considered as being either mostly indoor or mostly outdoor in nature. Most of the sites would have both a certain percentage for each, because certain sites like the Sistine Chapel with great works of art therein, may nonetheless have interesting exterior architecture that would be desirable to view and photograph. There are some exceptions to this duality of the indoor/outdoor rating, which may include, for example, the Temple of Portunus, which is available to the public 24 hours a day, but is only viewable from the exterior, and thus has a rating of “100% Outdoor.”

In seeking to perform the site rearrangement/reallocation for the weather detour, which could be done manually or could instead be more efficiently and quickly done using the program code herein, the system would seek to place sites having the highest indoor rating, into the weather-affected blocks of time, but while still being generally in accordance with the weighting scheme that had been selected by the travel planner for each of the templates.

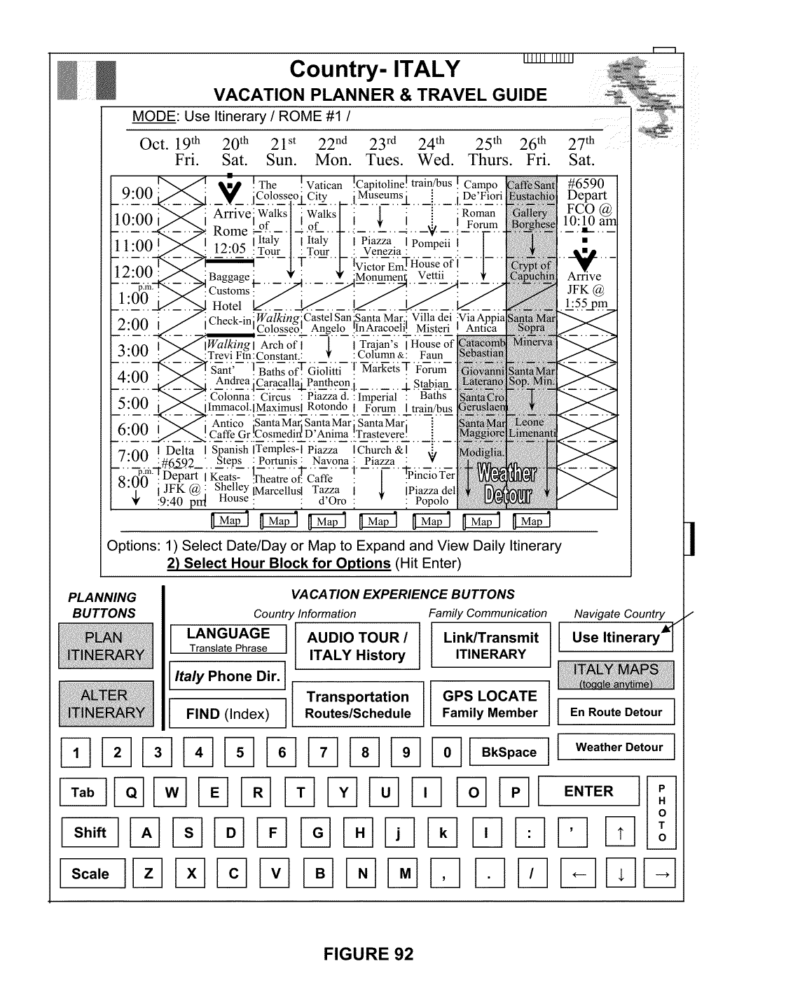

FIG. 92 shows the portion of the itinerary after Tuesday—Wednesday, Thursday, and Friday therein—with sites having been rearranged and other having been reallocated (sites removed and new sites added). The entire full-day trip to Pompeii has been moved from Thursday to Wednesday, and the Villa Borghese site has been replaced by the Crypt of the Capuchin Monks site. The weather-affected areas may still be shown by the shading seen in FIG. 92, and with the textual indicator “WEATHER DETOUR” shown therein as a further reminder. This may be especially useful where the weather detour was done very early, possibly prior to leaving for the destination, so that it may serve as a reminder, in case the weather changes for better or worse, for the travel planner to consider updating the itinerary to further improve/optimize the actual site-seeing experience according to the weather being predicted/experienced while at the destination.

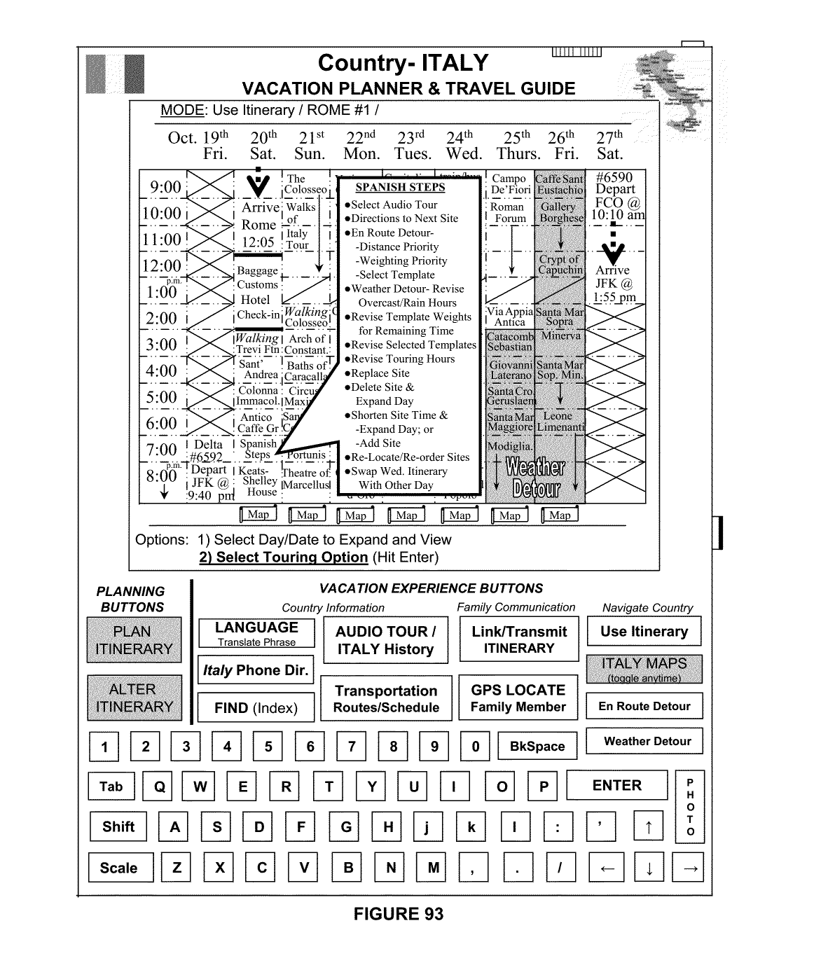

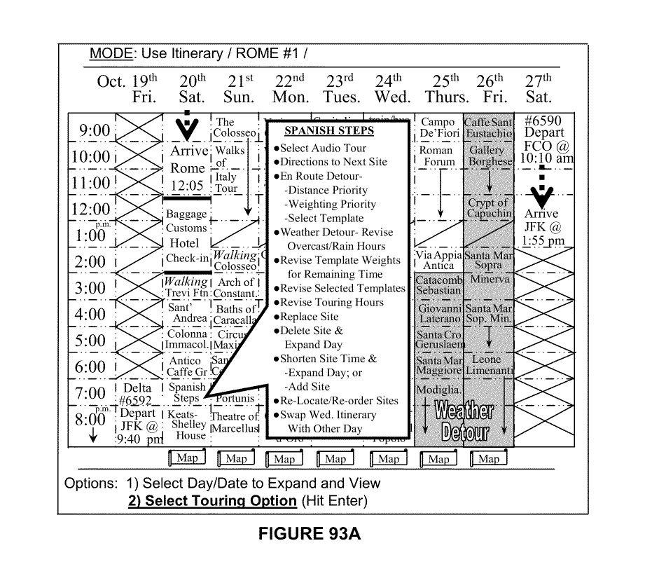

FIG. 93 shows the traveler using the itinerary at the destination, and selecting the time block for the site the “Spanish Steps” while thereat, to be able to select one of the touring options in the menu window, such as listening to one of the audio tours disclosed hereinabove, or to obtain directions to the next site in the hourly calendar planner, or to find another site as a detour while en route to the next scheduled site, etc. This en route detour, as shown in the menu listing in FIG. 93, may result in the listing of possible sites to visit on a detour, based upon a distance from a current location, or based on the weighted templates that the traveler had selected, or may be based on the present selection of a specific template by the traveler.

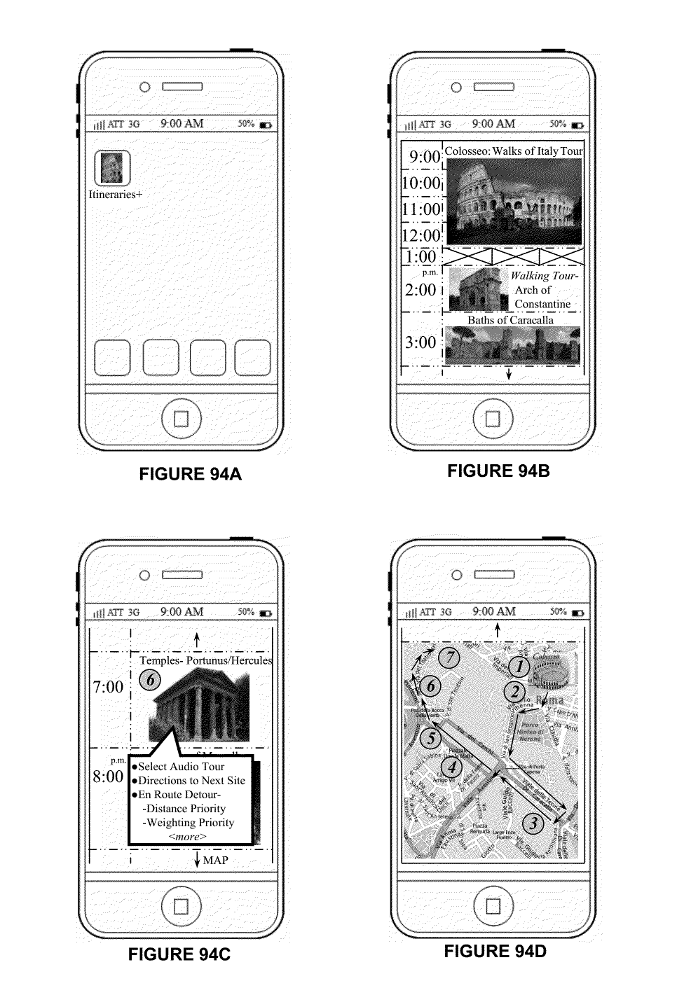

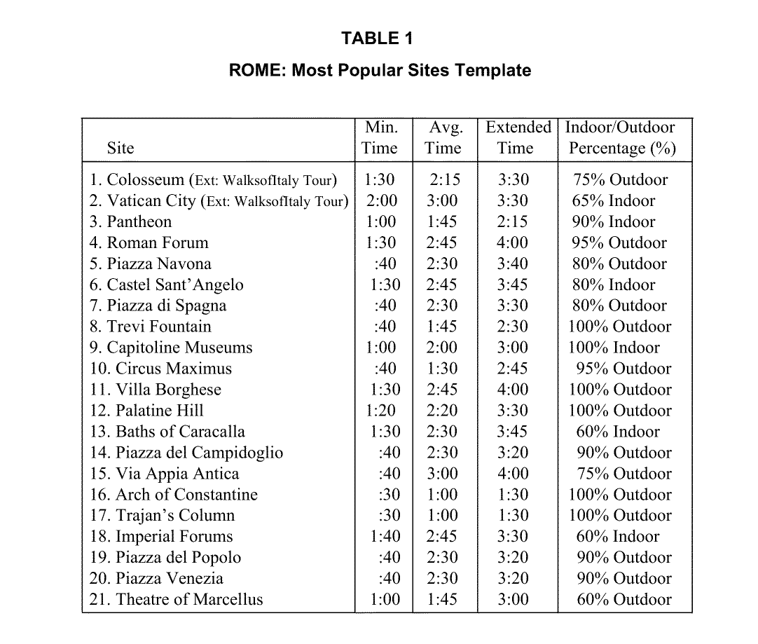

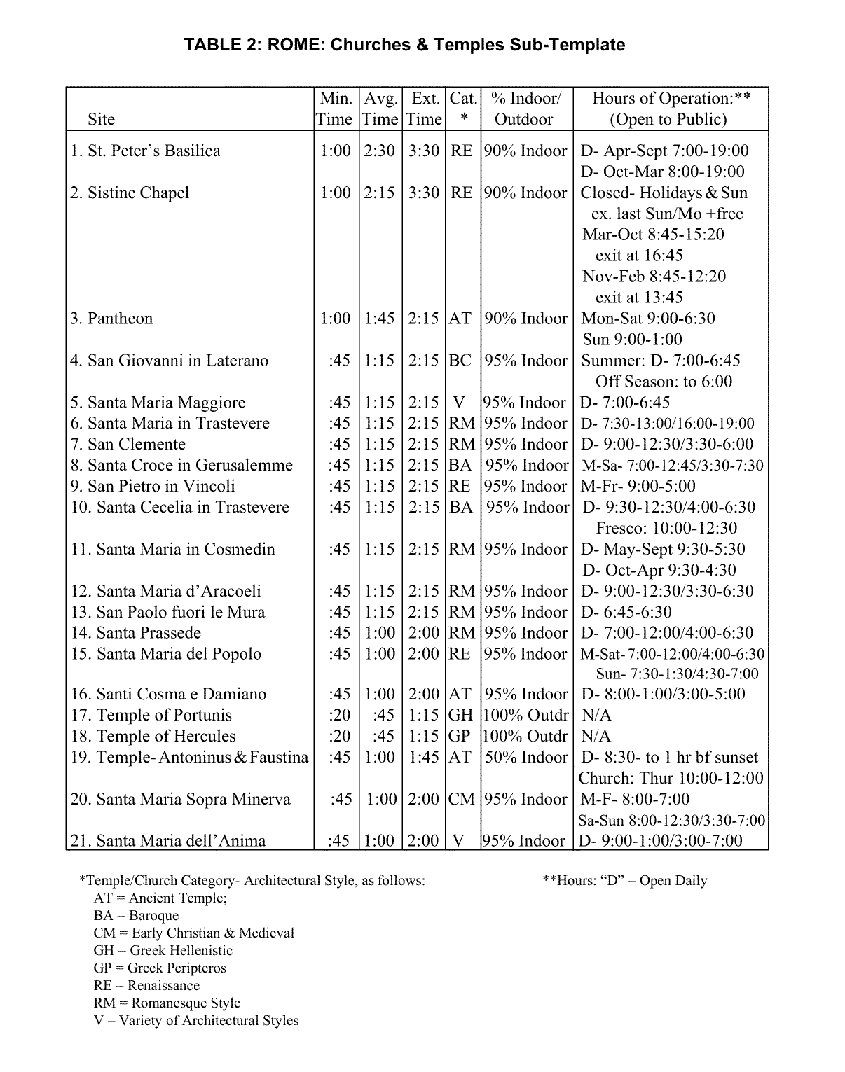

FIG. 94A illustrates the interoperability between the use of the software of the present invention on a desk-top PC, where it may more easily and enjoyably be viewed, particularly with respect to the images of the photo library, and its use on a smartphone, which may be the most convenient device to use while executing the itinerary at the destination. In FIG. 94A, the user is preparing to launch the requisite software application (APP) on the smartphone, designated thereon by the icon identified as “Itineraries+.” The software may be configured so that the itineraries developed by the user at home on a desktop computer, may be sent (e.g., via e-mail) to the user's smartphone, to be utilized thereon as discussed hereinabove.

FIG. 94B shows the smart phone of FIG. 94A, with the traveler using the “ROME #1” itinerary that was developed on a home desk-top P.C., and with the user having selected the beginning of the touring day on Sunday, October 21^{st}. FIG. 94C shows the traveler still using the “ROME #1” itinerary, but having scrolled down to the end of the touring day on Sunday, October 21^{st}, and requesting touring options for the current site—the Temple of Portunus and the Temple of Hercules. FIG. 94D shows the traveler still using the “ROME #1” itinerary, but having selected and utilizing the daily map option that corresponds to the day's itinerary, and shows each of the sites to be visited thereon.

FIG. 72 is a schematic view of an exemplary computer system running the software of the current invention. The travel planner/guide software in accordance with one embodiment of the present invention may run on a computer and/or server, so a description of such an accessorized exemplary computer system is hereinafter disclosed, even though a particular embodiment may not require all of the described components. Exemplary computer system 200 is shown schematically in FIG. 72, and which may comprise a mobile computing unit 201 interacting with external peripherals, such as: a separate external display screen 210, keyboard 211, pointing device 212, and GPS 213; and interacting with network resources, including use of the internet 230, and other computers, which may be computer 220, etc.

The computing unit 201 may include a data bus 202 for communicating information across and among various parts of computing unit 201, and a central processing unit, which may be a microprocessor (hereinafter “processor” or “CPU”) 203 coupled with bus 202, for processing information and performing other computational and control tasks. Computing unit 201 may also include a volatile storage 206, such as a random access memory (RAM) or other dynamic storage device, coupled to bus 202 for storing various information as well as instructions to be executed by processor 203. The RAM may be Dynamic Random Access Memory (DRAM), or Static RAM (SRAM), or any other similar type of RAM known in the art. The volatile storage 206 may also be used for storing temporary variables or other intermediate information during execution of instructions by processor 203. Computing unit 201 may further include a read only memory (ROM) or an erasable programmable memory (EPROM) 208 or other static storage device coupled to bus 202 for storing static information and instructions for processor 203, such as basic input-output system (BIOS), as well as various system configuration parameters. A persistent storage device or non-volatile memory 207, such as a magnetic disk, optical disk, or solid-state flash memory device may be provided and may be coupled to bus 202 for storing information and instructions.

Computing unit 201 may be coupled via bus 202 to an integral display screen 204, possibly a touch-screen display, for use in displaying information to a user. If desired, computing unit 201 may be coupled via bus 202 to the external display screen 210. An external input device 211 (e.g., a standard keyboard) may be coupled to bus 202 for communicating information and command selections to processor 203. A cursor control device 212, such as a mouse, a trackball, or cursor direction keys, may be used for communicating direction information and command selections to processor 203 and for controlling cursor movement on display 204 and/or 210.

Some of the techniques herein may be performed by computing unit 201 in response to processor 203 executing one or more sequences of one or more instructions contained in the volatile memory 206. Execution of the sequences of instructions contained in a memory may cause processor 202 to perform the process steps described herein. In alternative embodiments, specific hard-wired digital circuitry may be used in place of, or in combination with, software instructions to implement the invention.

The term “computer-readable medium” as used herein refers to any medium that participates in providing instructions to processor 202 for execution. The computer-readable medium is just one example of a machine-readable medium, which may carry instructions for implementing any of the methods and/or techniques described herein. Various forms of computer readable media may be involved in carrying one or more sequences of one or more instructions to processor 203 for execution, including non-volatile media (storage device 207), and volatile media (storage device 206), as well as other common forms of computer-readable media that include, for example, a floppy disk, a hard disk, magnetic tape, or any other magnetic medium, a CD-ROM, any other optical medium, a RAM, a PROM, an EPROM, a flash drive, and a memory card.

The computing unit 201 may also include a communication interface 205, such as network interface card coupled to the data bus 202. Communication interface 205 may provide a two-way data communication coupling to a network link that may be connected to a local network. For example, communication interface 205 may be an integrated services digital network (ISDN) card or a modem to provide a data communication connection to a corresponding type of telephone line, or it may be a local area network interface card (LAN NIC) to provide a data communication connection to a compatible LAN.

Communication interface 205 may also typically provide data communication to other network resources. For example, it may provide a connection over the internet 230 to the world-wide-web. Thus, the computing unit 201 can access resources located anywhere using the Internet 230. Also, the computing unit 201 may also be accessed by other computers (e.g. personal computer 220), generally with permission, and which may be located anywhere with access to the internet 230. Direct communication may also be achieved between computing unit 201 and computer 220.

The examples and descriptions provided merely illustrate a various embodiments of the present invention. Those skilled in the art and having the benefit of the present disclosure will appreciate that further embodiments may be implemented with various changes within the scope of the present invention. Other modifications, substitutions, omissions and changes may be made in the design, size, materials used or proportions, operating conditions, assembly sequence, or arrangement or positioning of elements and members of the preferred embodiment without departing from the spirit of this invention.

TABLE 1
ROME: Most Popular Sites Template

| | | Min. | Avg. | Extended | Indoor/Outdoor |
|---|---|---|---|---|---|
| Site | | Time | Time | Time | Percentage (%) |
| 1. | Colosseum | 1:30 | 2:15 | 3:30 | 75% Outdoor |
| | (Ext: WalksofItaly Tour) | | | | |
| 2. | Vatican City | 2:00 | 3:00 | 3:30 | 65% Indoor |
| | (Ext: WalksofItaly Tour) | | | | |
| 3. | Pantheon | 1:00 | 1:45 | 2:15 | 90% Indoor |
| 4. | Roman Forum | 1:30 | 2:45 | 4:00 | 95% Outdoor |
| 5. | Piazza Navona | :40 | 2:30 | 3:40 | 80% Outdoor |
| 6. | Castel Sant' Angelo | 1:30 | 2:45 | 3:45 | 80% Indoor |
| 7. | Piazza di Spagna | :40 | 2:30 | 3:30 | 80% Outdoor |
| 8. | Trevi Fountain | :40 | 1:45 | 2:30 | 100% Outdoor |
| 9. | Capitoline Museums | 1:00 | 2:00 | 3:00 | 100% Indoor |
| 10. | Circus Maximus | :40 | 1:30 | 2:45 | 95% Outdoor |
| 11. | Villa Borghese | 1:30 | 2:45 | 4:00 | 100% Outdoor |
| 12. | Palatine Hill | 1:20 | 2:20 | 3:30 | 100% Outdoor |
| 13. | Baths of Caracalla | 1:30 | 2:30 | 3:45 | 60% Indoor |
| 14. | Piazza del Campidoglio | :40 | 2:30 | 3:20 | 90% Outdoor |
| 15. | Via Appia Antica | :40 | 3:00 | 4:00 | 75% Outdoor |
| 16. | Arch of Constantine | :30 | 1:00 | 1:30 | 100% Outdoor |
| 17. | Trajan's Column | :30 | 1:00 | 1:30 | 100% Outdoor |
| 18. | Imperial Forums | 1:40 | 2:45 | 3:30 | 60% Indoor |
| 19. | Piazza del Popolo | :40 | 2:30 | 3:20 | 90% Outdoor |
| 20. | Piazza Venezia | :40 | 2:30 | 3:20 | 90% Outdoor |
| 21. | Theatre of Marcellus | 1:00 | 1:45 | 3:00 | 60% Outdoor |

TABLE 2
ROME: Churches & Temples Sub-Template

| | | Min. | Avg. | Ext. | | % Indoor/ | Hours of Operation:** |
|---|---|---|---|---|---|---|---|
| Site | | Time | Time | Time | Cat. * | Outdoor | (Open to Public) |
| 1. | St. Peter's Basilica | 1:00 | 2:30 | 3:30 | RE | 90% Indoor | D- Apr-Sept 7:00-19:00 |
| | | | | | | | D- Oct-Mar 8:00-19:00 |
| 2. | Sistine Chapel | 1:00 | 2:15 | 3:30 | RE | 90% Indoor | Closed- Holidays & Sun |
| | | | | | | | ex. last Sun/Mo + free |
| | | | | | | | Mar-Oct 8:45-15:20 |
| | | | | | | | exit at 16:45 |
| | | | | | | | Nov-Feb 8:45-12:20 |
| | | | | | | | exit at 13:45 |
| 3. | Pantheon | 1:00 | 1:45 | 2:15 | AT | 90% Indoor | Mon-Sat 9:00-6:30 |
| | | | | | | | Sun 9:00-1:00 |
| 4. | San Giovanni in Laterano | :45 | 1:15 | 2:15 | BC | 95% Indoor | Summer: D- 7:00-6:45 |
| | | | | | | | Off Season: to 6:00 |
| 5. | Santa Maria Maggiore | :45 | 1:15 | 2:15 | V | 95% Indoor | D- 7:00-6:45 |
| 6. | Santa Maria in Trastevere | :45 | 1:15 | 2:15 | RM | 95% Indoor | D- 7:30-13:00/16:00-19:00 |
| 7. | San Clemente | :45 | 1:15 | 2:15 | RM | 95% Indoor | D- 9:00-12:30/3:30-6:00 |
| 8. | Santa Croce in Gerusalemme | :45 | 1:15 | 2:15 | BA | 95% Indoor | M-Sa- 7:00-12:45/3:30-7:30 |
| 9. | San Pietro in Vincoli | :45 | 1:15 | 2:15 | RE | 95% Indoor | M-Fr- 9:00-5:00 |
| 10. | Santa Cecelia in Trastevere | :45 | 1:15 | 2:15 | BA | 95% Indoor | D- 9:30-12:30/4:00-6:30 |
| | | | | | | | Fresco: 10:00-12:30 |
| 11. | Santa Maria in Cosmedin | :45 | 1:15 | 2:15 | RM | 95% Indoor | D- May-Sept 9:30-5:30 |
| | | | | | | | D- Oct-Apr 9:30-4:30 |
| 12. | Santa Maria d'Aracoeli | :45 | 1:15 | 2:15 | RM | 95% Indoor | D- 9:00-12:30/3:30-6:30 |
| 13. | San Paolo fuori le Mura | :45 | 1:15 | 2:15 | RM | 95% Indoor | D- 6:45-6:30 |
| 14. | Santa Prassede | :45 | 1:00 | 2:00 | RM | 95% Indoor | D- 7:00-12:00/4:00-6:30 |
| 15. | Santa Maria del Popolo | :45 | 1:00 | 2:00 | RE | 95% Indoor | M-Sat- 7:00-12:00/4:00-6:30 |
| | | | | | | | Sun- 7:30-1:30/4:30-7:00 |
| 16. | Santi Cosma e Damiano | :45 | 1:00 | 2:00 | AT | 95% Indoor | D- 8:00-1:00/3:00-5:00 |
| 17. | Temple of Portunis | :20 | :45 | 1:15 | GH | 100% Outdr | N/A |
| 18. | Temple of Hercules | :20 | :45 | 1:15 | GP | 100% Outdr | N/A |
| 19. | Temple-Antoninus & Faustina | :45 | 1:00 | 1:45 | AT | 50% Indoor | D- 8:30- to 1 hr bf sunset |
| | | | | | | | Church: Thur 10:00-12:00 |
| 20. | Santa Maria Sopra Minerva | :45 | 1:00 | 2:00 | CM | 95% Indoor | M-F- 8:00-7:00 |
| | | | | | | | Sa-Sun 8:00-12:30/3:30-7:00 |
| 21. | Santa Maria dell'Anima | :45 | 1:00 | 2:00 | V | 95% Indoor | D- 9:00-1:00/3:00-7:00 |

* Temple/Church Category- Architectural Style, as follows:
AT = Ancient Temple;
BA = Baroque
CM = Early Christian & Medieval
GH = Greek Hellenistic
GP = Greek Peripteros
RE = Renaissance
RM = Romanesque Style
V—Variety of Architectural Styles
**Hours: “D” = Open Daily

1. A computer program product for a method of planning a travel itinerary for use at a destination and for executing the planned travel itinerary at the destination, the computer program product comprising: a tangible computer readable storage medium having computer readable program code embodied thereon, the computer readable program code, when executed by a processor, configured for:
storing a database of travel information about the destination in said storage medium, said database of travel information comprising tour sites at the destination;
creating a respective indoor-outdoor rating for each said tour site by assessing the type and nature of each of said tour sites, including assessing exterior and interior architecture and articles contained therein, and storing said ratings in said storage medium, each said indoor-outdoor rating comprising a percentage of said respective tour site being preferentially, experienced as an indoor site or preferentially experienced as an outdoor site;
providing access to said database of travel information by displaying a planning screen configured for selecting of a first itinerary template, and selecting of one or more additional itinerary templates from a plurality of said additional itinerary templates, each said plurality of additional itinerary templates comprising a plurality of said tour sites listed therein and relating to a category of said additional template, said first itinerary template configured for entering of:
a number of days for said itinerary,
an arrival city and a departure city at the destination,
a start-time and an end-time for a number of desired touring hours for each said number of days, and
a tour intensity level for touring for each of said number of days at the destination;
providing a sequence of tour sites forming a complete travel itinerary for said number of days, using a portion of said tour sites listed in each said selected one or more additional itinerary templates, said complete travel itinerary comprising said sequence of tour sites being optimized to include as many said tour sites as possible in said touring hours, for each of said number of days;
wherein said complete travel itinerary is configured for selecting one or more blocks of time being affected by inclement weather, during said desired touring hours of said number of days;
reforming said complete travel itinerary for detouring from at least a portion of said sequence of tour sites, including at least during said one or more blocks of time effected by inclement weather, according to said respective indoor-outdoor rating; and
communicating with a GPS receiver for receiving directions to any of said tour sites of said reformed travel itinerary during executing of said reformed travel itinerary at the destination.

2. The computer program product according to claim 1, said computer readable program code further configured for selecting of said level of touring intensity for each day, from the group of touring intensity levels consisting of: allocating a minimum touring time per said tour site for each day of touring; allocating an average touring time per said tour site for each day of touring; and allocating an extended touring time per said tour site for each day of touring.

3. (canceled)

4. The computer program product according to claim 1, wherein said reforming of said sequence of tour sites of said complete travel itinerary comprises one or more of:
reordering two or more of said tour sites in said sequence of tour sites, for ordering of at least one said tour site in said sequence of sites with a highest said preferential indoor rating to correspond to said one or more blocks of time of inclement weather; and
replacing one or more of said tour sites in said sequence of tour sites with one or more different tour sites, from said selected one or more additional itinerary templates, each said replacement tour site respectively having said preferential indoor rating, and sequencing said one or more different tour sites within said sequence of tour sites to correspond to said one or more blocks of time of inclement weather.

5. The computer program product according to claim 4, wherein when said selecting one or more additional itinerary templates comprises selecting at least two said additional itinerary templates, said computer readable program code further configured for assigning of a relative weight factor for each of said selected at least two additional itinerary templates; said computer readable program code further configured for allocating a respective quantity of said tour sites, into said sequence of tour sites forming said complete travel itinerary, from each of said selected at least two additional itinerary templates to be substantially in proportion to said assigned weight factor, and to receive a priority placement in said sequence of tour sites according to said assigned relative weight factor.

6. The computer program product according to claim 5, wherein said replacing of one or more said tour sites for said detouring comprises selecting said different said tour sites with each having the same or a higher said relative weight factor; and wherein said relative weight factor comprises a factor between 1 and 5.

7. The computer program product according to claim 1, said computer readable program code further configured for entering, into said first itinerary template, of a hotel location, for optimizing said sequence of tour sites of said complete travel itinerary, based upon said hotel location as a starting location for each of said number of days for said touring at the destination.

8. The computer program product according to claim 7, said computer readable program code further configured for entering into said first itinerary template of: a date and time of an arrival flight, and a date and time of a departure flight, for further optimizing of said sequence of tour sites of said complete travel itinerary.

9. The computer program product according to claim 1, said computer readable program code further configured for permitting, but not requiring, customizing of said sequence of tour sites of said complete travel itinerary for forming a complete custom itinerary using selective access to said database of travel information, said customizing comprising one or more of: removing one or more of said tour sites of said sequence of tour sites; adding one or more other tour sites, by selecting from a list of said tour sites; and reordering two or more said tour sites in said sequence of tour sites; said computer readable program code further configured for retrievably storing said complete travel itinerary within said storage medium.

10. The computer program product according to claim 1,
wherein said computer readable program code is further configured for selecting, in said planning screen, of one or more of said tour sites in said plurality of additional itinerary templates, and assigning a relative weight factor to each of said one or more selected tour sites and to each of said selected one or more additional itinerary templates; and
wherein said computer readable program code is further configured for allocating the following into said sequence of tour sites forming said complete travel itinerary:
said selected one or more tour sites; and
a respective quantity of said tour sites in said selected one or more additional itinerary templates, being substantially in proportion to said assigned relative weight factor, and being optimized for including as many said tour sites as possible in said touring hours, for each of said number of days.

11. The computer program product according to claim 10, said computer readable program code further configured for causing said selected one or more tour sites and said allocated tour sites from said selected one or more additional itinerary templates, with a higher said relative weight factor, to receive a higher priority placement in said sequence of tour sites of said complete travel itinerary.

12. The computer program product according to claim 11, said computer readable program code further configured for said selecting of said tour intensity level to correspond to said assigned relative weight factor, wherein said tour sites with a higher relative weight factor are allocated more touring time and said tour sites with a lower relative weight factor are allocated less touring time.

13. The computer program product according to claim 1, said computer readable program code further configured for selecting of at least two said additional itinerary templates, said computer readable program code further configured for assigning of a relative weight factor for each of said at least two said additional itinerary templates, said computer readable program code further configured for allocating a respective quantity of said tour sites, into said sequence of tour sites forming said complete travel itinerary, from each said at least two additional itinerary templates, to be substantially in proportion to said assigned relative weight factor, and to receive priority placement in said sequence.

14. The computer program product according to claim 13, said computer readable program code further configured for providing a detour option screen configured to suggest alternative nearby tour sites relative to a current tour site of said sequence of tour sites of said complete travel itinerary, said suggested alternative tour sites being suggested in a list in a descending order beginning with:
alternative tour sites with the smallest distance from said current tour site, and with a higher said relative weight factor.

15. The computer program product according to claim 1, said computer readable program code further configured for selecting of a pre-recorded audio tour from an audio tour screen configured to provide two or more pre-recorded audio tours for each of said tour sites of said sequence of tour sites, said two or more pre-recorded audio tours being stored in said storage medium; and said two or more audio tours comprising tours of incrementally distinct lengths of time and incrementally distinct intellectual levels.

16. The computer program product according to claim 1, wherein said storage medium comprises a language database and said computer readable program code is further configured for entering of one or more words in a first language into a language screen, and translating said one or more words in said first language into a language used at the destination, using a hidden Markov modeling algorithm; wherein said computer readable program code is further configured for articulating said translated one or more words using a sound generator; and wherein said computer readable program code is further configured for using said hidden Markov modeling algorithm for translating a response in the language used at the destination, into the first language.

17. The computer program product according to claim 1, wherein said storage medium comprises a history database of the destination and a directory database of the destination, and said computer readable program code is further configured for providing:
a history screen configured for searching of said history database; and
a directory screen configured for searching of entries in said directory for information for one or more of: a person, a business, a government entity, a doctor, a dentist, a medical facility, a consulate, and an embassy.

18. (canceled)

19. The computer program product according to claim 1, said computer readable program code further configured for providing one or more of:
an itinerary screen, said itinerary screen configured for displaying said sequence of tour sites of said complete travel itinerary in a display being from of the group of displays consisting of: a chronological list, and an hourly calendar planner; said itinerary screen further configured for displaying a respective photograph adjacent to each of said tour sites;
a map screen configured for on-demand displaying of a scalable map for each of said number of touring days at the destination for identifying a location of each of said tour sites of said sequence of tour sites; and
a public transportation screen configured for providing on-demand displaying of a public transportation route map and route schedules.

20. The computer program product according to claim 1, said computer readable program code further configured for entering of said start-time and said end-time for touring each day by selecting one or more hours or portions of an hour in an hourly calendar planner.

21. The computer program product according to claim 1, said computer readable program code further configured for said entering, into said planning screen, of a number of cities for touring, in addition to said arrival city and said departure city.

22-34. (canceled)
